(19) United States
(12) Patent Application Publication
(10) Pub. No.: US 2009/0220789 A1
(43) Pub. Date: Sep. 3, 2009

(54) TAGGANTS AND METHODS AND SYSTEMS FOR FABRICATING SAME

(75) Inventors: Joseph M. DeSimone, Chapel Hill, NC (US); Ginger Denison Rothrock, Durham, NC (US); Benjamin W. Maynor, Durham, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: THE UNIVERSITY OF NORTH CAROLINA AT CHAPEL HILL, Chapel Hill, NC (US)

(21) Appl. No.: 12/162,264

(22) PCT Filed: Jan. 29, 2007
(86) PCT No.: PCT/US2007/002476

§ 371 Date: Jan. 14, 2009

Related U.S. Application Data
(60) Provisional application No. 60/762,802, filed on Jan. 27, 2006.
(60) Provisional application No. 60/798,858, filed on May 9, 2006.
(60) Provisional application No. 60/799,876, filed on May 12, 2006.
(60) Provisional application No. 60/833,736, filed on Jul. 27, 2006.

(51) Int. Cl. B32B 1/00; C08L 27/00

(52) U.S. Cl. 428/402; 528/401

(57) ABSTRACT

A micro or nanoparticle (206) can include or can be a taggant. The particle (206) has a shape corresponding to a mold and includes unique characteristics. The unique characteristics can be the shape of the particle, molecular content of the particle, or physical characteristics incorporated into or onto the particle. In use, the taggant can be incorporated into an article of manufacture and includes characteristics configured to identify the origin, authenticity, expiration, owner or the like of the article.

### CROSS REFERENCE TO RELATED APPLICATIONS

This application is based on and claims priority to U.S. Provisional Patent Application Ser. No. 60/762,802, filed Jan. 27, 2006; U.S. Provisional Patent Application Ser. No. 60/798,858, filed May 9, 2006; U.S. Provisional Patent Application Ser. No. 60/799,876, filed May 12, 2006; and U.S. Provisional Patent Application Ser. No. 60/833,736, filed Jul. 27, 2006; each of which is incorporated herein by reference in its entirety.

This application is also a continuation-in-part of U.S. patent application Ser. No. 10/583,570, filed Jun. 19, 2006, which is the national phase entry of PCT International Patent Application Serial No. PCT/US04/42706, filed Dec. 20, 2004, which is based on and claims priority to U.S. Provisional Patent Application Ser. No. 60/531,531, filed on Dec. 19, 2003, U.S. Provisional Patent Application Ser. No. 60/583,170, filed Jun. 25, 2004, and U.S. Provisional Patent Application Ser. No. 60/604,970, filed Aug. 27, 2004; a continuation-in-part of PCT International Patent Application Serial No. PCT/US06/23722, filed Jun. 19, 2006, which is based on and claims priority to U.S. Provisional Patent Application Ser. No. 60/691,607, filed on Jun. 17, 2005, U.S. Provisional Patent Application Ser. No. 60/714,961, filed Sep. 7, 2005, U.S. Provisional Patent Application Ser. No. 60/734,228, filed Nov. 7, 2005, U.S. Provisional Patent Application Ser. No. 60/762,802, filed Jan. 27, 2006, and U.S. Provisional Patent Application Ser. No. 60/799,876 filed May 12, 2006; a continuation-in-part of PCT International Patent Application Serial No. PCT/US06/34997, filed Sep. 7, 2006, which is based on and claims priority to U.S. Provisional Patent Application Ser. No. 60/714,961, filed on Sep. 7, 2005, U.S. Provisional Patent Application Ser. No. 60/734,228, filed Nov. 7, 2005, United States Provisional Patent Application Ser. No. 60/762,802, filed Jan. 27, 2006, and U.S. Provisional Patent Application Ser. No. 60/799,876, filed May 12, 2006; and a continuation-in-part of PCT International Patent Application Serial No. PCT/US06/43305 and U.S. patent application Ser. No. 11/594,023, both filed on Nov. 7, 2006, both of which are based on and claim priority to U.S. Provisional Patent Application Ser. No. 60/734,228, filed Nov. 7, 2005, U.S. Provisional Patent Application Ser. No. 60/762,802, filed Jan. 27, 2006, and U.S. Provisional Patent Application No. 60/799,876, filed May 12, 2006; each of which is incorporated herein by reference in its entirety.

### GOVERNMENT INTEREST

A portion of the disclosure contained herein was made with U.S. Government support from the Office of Naval Research Grant No. N00014210185 and the Science and Technology Center program of the National Science Foundation under Agreement No. CHE-9876674. The U.S. Government has certain rights to that portion of the disclosure.

### INCORPORATION BY REFERENCE

All documents referenced herein are hereby incorporated by reference as if set forth in their entirety herein.

### TECHNICAL FIELD

Generally, this invention relates to the field of taggants used in security and/or authentication systems. More specifically, taggants, taggant materials, and methods for making, using, and detecting taggant are disclosed that facilitate identification, anti-counterfeiting, authentication, and the like of manufactured goods.

### ABBREVIATIONS

° C.=degrees Celsius

cm=centimeter

DBTDA=dibutyltin diacetate

DMA=dimethylacrylate

DMPA=2,2-dimethoxy-2-phenylacetophenone

EIM=2-isocyanatoethyl methacrylate

FEP=fluorinated ethylene propylene

Freon 113=1,1,2-trichlorotrifluoroethane

g=grams

h=hours

Hz=hertz

IL=imprint lithography

kg=kilograms

kHz=kilohertz

kPa=kilopascal

MCP=microcontact printing

MEMS=micro-electro-mechanical system

MHz=megahertz

MIMIC=micro-molding in capillaries

mL=milliliters

mm=millimeters

mmol=millimoles

mN=milli-Newton

m.p.=melting point

mW=milliwatts

NCM=nano-contact molding

NIL=nanoimprint lithography

nm=nanometers

PDMS=polydimethylsiloxane

PEG poly(ethylene glycol)

PFPE=perfluoropolyether

PLA poly(lactic acid)

PP=polypropylene

Ppy=poly(pyrrole)

psi=pounds per square inch

PVDF=poly(vinylidene fluoride)

PTFE=polytetrafluoroethylene

SAMIM=solvent-assisted micro-molding

SEM=scanning electron microscopy

S-FIL=“step and flash” imprint lithography

Si=silicon

Tg=glass transition temperature

Tm=crystalline melting temperature

TMPTA=trimethylolpropane triacrylate

μm=micrometers

UV=ultraviolet

W=watts

### BACKGROUND

Security and authentication for products is a growing concern in modern society as product counterfeiting has become a worldwide issue. Some industries are more susceptible to counterfeiting concerns than others, particularly including the financial industries, the biotechnology industry, and the pharmaceutical industry.

Some efforts for preventing counterfeiting include various analytical methods used to detect components purposefully placed in products. Such analytical methods includes, thin layer chromatography, calorimetric assay, near infrared spectroscopy, and capillary electrophoresis. Other techniques include marking the product itself. Such methods have included applying bar code symbols to the packaging; mixture two or more photochromic compounds that have different absorption maxima in an activated state; including ink, paint, or fiber into the product; including luminescent compositions into the product; placing objects that are only visible by x-ray fluorescence analysis into a product; or the like. However, despite these recent developments pharmaceutical counterfeiting remains a health concern and needs improved articles and methods for product authentication.

### SUMMARY

According to some embodiments of the present invention, a taggant includes a particle having a predetermined shape, being less than about 50 microns in a broadest dimension, and including a unique characteristic. In other embodiments, the taggants include a plurality of particles, wherein the particles of the plurality of the particles are substantially uniform in geometric shape. In yet other embodiments, the taggants include a plurality of particles, wherein the particles of the plurality of particles have a plurality of predetermined shapes. In alternative embodiments, the particle taggant is less than about 40 microns in a broadest dimension, less than about 30 microns in a broadest dimension, less than about 20 microns in a broadest dimension, less than about 10 microns in a broadest dimension, less than about 1 micron in a broadest dimension, less than about 500 nanometers in a broadest dimension, less than about 250 nanometers in a broadest dimension, less than about 100 nanometers in a broadest dimension, less than about 80 nanometers in a broadest dimension, less than about 50 nanometers in a broadest dimension, less than about 25 nanometers in a broadest dimension, less than about 10 nanometers in a broadest dimension, less than about 5 nanometers in a broadest dimension, less than about 2 nanometers in a broadest dimension, less than about 0.5 nanometers in a broadest dimension, less than about 0.1 nanometers in a broadest dimension.

According to other embodiments, the unique characteristic of the taggant includes grooves on a surface of the particle. In some embodiments, the grooves are patterned such that the grooves include information. In other embodiments, the grooves are substantially a bar code.

In some embodiments, the unique characteristic of the taggant includes a geometric shape. According to some embodiments, the geometric shape is an overall shape of the particle or the geometric shape protrudes from the particle. In some embodiments, the taggant includes a plurality of geometric shapes and the plurality of geometric shapes can have a substantially similar geometric shape or varying geometric shapes. In some embodiments, the plurality of geometric shapes are arranged to form a pattern.

According to yet other embodiments, the unique characteristic includes an active or passive radio frequency identification or magnetic material. In some embodiments, the particle defines a recess and the recess can be configured and dimensioned to receive the unique characteristic. In some embodiments, the unique characteristic enters the recess by capillary action.

In certain embodiments, unique characteristic includes a composition, a chemical signature to the particle, or imparts a spectral signature to the particle.

According to certain embodiments, the taggant can include a particle having a predetermined shape, wherein the particle has a volume less than about 125,000 cubic micrometers and wherein the particle includes a unique characteristic. In another embodiment, the taggant can include a plurality of particles, wherein the particles of the plurality of the particles are substantially uniform in geometric shape. In other embodiments, the taggants can include a plurality of particles, wherein the particles of the plurality of particles have a plurality of predetermined shapes, and wherein each particle of the plurality of particles has a volume less than about 125,000 cubic micrometers.

According to alternative embodiments, the particle has a volume less than about 50,000 cubic micrometers, less than about 20,000 cubic micrometers, less than about 10,000 cubic micrometers, less than about 1,000 cubic micrometers, less than about 1 cubic micrometer, less than about 0.5 cubic micrometers, less than about 0.125 cubic micrometers, less than about 0.015 cubic micrometers, less than about 0.001 cubic micrometers, less than about 125,000 cubic nanometers, less than about 50,000 cubic nanometers, less than about 20,000 cubic nanometers, less than about 10,000 cubic nanometers, less than about 5,000 cubic nanometers, less than about 1,000 cubic nanometers, less than about 500 cubic nanometers, less than about 100 cubic nanometers, less than about 50 cubic nanometers, less than about 1 cubic nanometer.

In other embodiments, the present invention includes methods of making a taggant that include placing material into a cavity formed in a fluorinated base material wherein the cavity is less than about 50 microns in a broadest dimension, imparting an unique characteristic to the material, treating the material in the cavity to form a particle, and removing the particle from the cavity. In some embodiments, the fluorinated base material is perfluoropolyether and in some embodiments, the treating includes curing, evaporating, or solidifying.

According to other embodiments, a secure item includes an article and a taggant coupled with the article, wherein the taggant comprises a particle having a predetermined shape, the particle is less than about 50 microns in a broadest dimension, and the particle includes a unique characteristic. In some embodiments the secure item includes a pharmaceutical product.

According to yet other embodiments, a method of making a secure item, includes placing material into a cavity formed in a fluorinated base material, wherein the cavity is less than about 50 microns in a broadest dimension, imparting unique characteristic to the material, curing the material to make a particle, removing the particle from the cavity, and coupling the particle with an article.

In yet other embodiments, a system for securing an item includes, producing a taggant, wherein the taggant includes a particle having a predetermined shape, wherein the particle is less than about 50 microns in a broadest dimension, and wherein the particle includes an unique characteristic. The system also includes incorporating the taggant with an item to be secured, analyzing the item to detect the unique characteristic, and comparing the unique characteristic with an expected characteristic.

### BRIEF DESCRIPTION OF THE DRAWINGS

Reference is made to the accompanying drawings in which are shown illustrative embodiments of the presently disclosed subject matter, from which its novel features and advantages will be apparent.

FIGS. 1A-1D are a schematic representation of an embodiment of the presently disclosed method for preparing a patterned template;

FIGS. 2A-2F are a schematic representation of the presently disclosed method for forming one or more micro- and/or nanoscale particles;

FIGS. 3A-3F are a schematic representation of the presently disclosed method for preparing one or more spherical particles;

FIGS. 4A-4D are a schematic representation of the presently disclosed method for fabricating charged polymeric particles. FIG. 4A represents the electrostatic charging of the molded particle during polymerization or crystallization; FIG. 4B represents a charged nano-disc;

FIG. 4C represents typical random juxtapositioning of uncharged nano-discs; and FIG. 4D represents the spontaneous aggregation of charged nano-discs into chain-like structures;

FIGS. 5A-5C are a schematic illustration of multilayer particles that can be formed using the presently disclosed soft lithography method;

FIGS. 6A-6C are a schematic representation of the presently disclosed method for making three-dimensional nanostructures using a soft lithography technique;

FIGS. 7A-7F are a schematic representation of an embodiment of the presently disclosed method for preparing a multi-dimensional complex structure;

FIGS. 8A-8E are a schematic representation of the presently disclosed imprint lithography process resulting in a “scum layer”;

FIGS. 9A-9E are a schematic representation of the presently disclosed imprint lithography method, which eliminates the “scum layer” by using a functionalized, non-wetting patterned template and a non-wetting substrate;

FIGS. 10A-10E are a schematic representation of the presently disclosed solvent-assisted micro-molding (SAMIM) method for forming a pattern on a substrate;

FIG. 11 is a scanning electron micrograph of a silicon master including 3-μm arrow-shaped patterns;

FIG. 12 is a scanning electron micrograph of a silicon master including 500 nm conical patterns that are <50 nm at the tip;

FIG. 13 is a scanning electron micrograph of a silicon master including 200 nm trapezoidal patterns;

FIG. 14 is a scanning electron micrograph of 200-nm isolated trapezoidal particles of poly(ethylene glycol) (PEG) diacrylate;

FIG. 15 is a scanning electron micrograph of 500-nm isolated conical particles of PEG diacrylate;

FIG. 16 is a scanning electron micrograph of 3-μm isolated arrow-shaped particles of PEG diacrylate;

FIG. 17 is a scanning electron micrograph of 200-nm×750-nm×250-nm rectangular shaped particles of PEG diacrylate;

FIG. 18 is a scanning electron micrograph of 200-nm isolated trapezoidal particles of trimethylolpropane triacrylate (TMPTA);

FIG. 19 is a scanning electron micrograph of 500-nm isolated conical particles of TMPTA;

FIG. 20 is a scanning electron micrograph of 500-nm isolated conical particles of TMPTA, which have been printed using an embodiment of the presently described non-wetting imprint lithography method and harvested mechanically using a doctor blade;

FIG. 21 is a scanning electron micrograph of 200-nm isolated trapezoidal particles of poly(lactic acid) (PLA);

FIG. 22 is a scanning electron micrograph of 200-nm isolated trapezoidal particles of poly(lactic acid) (PLA), which have been printed using an embodiment of the presently described non-wetting imprint lithography method and harvested mechanically using a doctor blade;

FIG. 23 is a scanning electron micrograph of 3-μm isolated arrow-shaped particles of PLA;

FIG. 24 is a scanning electron micrograph of 500-nm isolated conical-shaped particles of PLA;

FIG. 25 is a scanning electron micrograph of 200-nm isolated trapezoidal particles of poly(pyrrole) (Ppy);

FIG. 26 is a scanning electron micrograph of 3-μm arrow-shaped Ppy particles;

FIG. 27 is a scanning electron micrograph of 500-nm conical shaped Ppy particles;

FIGS. 28A-28C are fluorescence confocal micrographs of 200-nm isolated trapezoidal particles of PEG diacrylate that contain fluorescently tagged DNA. FIG. 28A is a fluorescent confocal micrograph of 200 nm trapezoidal PEG nanoparticles which contain 24-mer DNA strands that are tagged with CY-3. FIG. 28B is optical micrograph of the 200-nm isolated trapezoidal particles of PEG diacrylate that contain fluorescently tagged DNA. FIG. 28C is the overlay of the images provided in FIGS. 28A and 28B, showing that every particle contains DNA;

FIG. 29 is a scanning electron micrograph of fabrication of 200-nm PEG-diacrylate nanoparticles using “double stamping”;

FIG. 30 is an atomic force micrograph image of 140-nm lines of TMPTA separated by distance of 70 nm that were fabricated using a PFPE mold;

FIGS. 31A and 31B are a scanning electron micrograph of mold fabrication from electron-beam lithographically generated masters. FIG. 31A is a scanning electron micrograph of silicon/silicon oxide masters of 3 micron arrows. FIG. 31B is a scanning electron micrograph of silicon/silicon oxide masters of 200-nm×800-nm bars;

FIGS. 32A and 32B are an optical micrographic image of mold fabrication from photoresist masters. FIG. 32A is a SU-8 master. FIG. 32B is a PFPE-DMA mold templated from a photolithographic master;

FIGS. 33A and 33B are an atomic force micrograph of mold fabrication from Tobacco Mosaic Virus templates. FIG. 33A is a master. FIG. 33B is a PFPE-DMA mold templated from a virus master;

FIGS. 34A and 34B are an atomic force micrograph of mold fabrication from block copolymer micelle masters. FIG. 34A is a polystyrene-polyisoprene block copolymer micelle. FIG. 34B is a PFPE-DMA mold templated from a micelle master;

FIGS. 35A and 35B are an atomic force micrograph of mold fabrication from brush polymer masters. FIG. 35A is a brush polymer master. FIG. 35B is a PFPE-DMA mold templated from a brush polymer master;

FIGS. 36A-36D are schematic representations of one embodiment of a method for functionalizing particles of the present subject matter;

FIGS. 37A-37F are schematic representations of one embodiment of a method of the presently disclosed subject matter for harvesting particles from an article;

FIGS. 38A-38G are schematic representations of one embodiment of a method of the presently disclosed subject matter for harvesting particles from an article;

FIGS. 39A-39F are schematic representations of one embodiment of one process of the presently disclosed subject matter for imprint lithography wherein 3-dimensional features are patterned;

FIGS. 40A-40D schematic representations of one embodiment of one process of the presently disclosed subject matter for harvesting particles from an article;

FIGS. 41A-41E show a sequence of forming small particles through evaporation according to an embodiment of the present subject matter;

FIG. 42 shows doxorubicin containing particles after removal from a template according to an embodiment of the presently disclosed subject matter;

FIG. 43 shows a structure patterned with nano-cylindrical shapes according to an embodiment of the present subject matter;

FIGS. 44A-44C show a sequence of molecular imprinting according to an embodiment of the present subject matter;

FIG. 45 shows a labeled particle associated with a cell according to an embodiment of the present subject matter;

FIG. 46 shows a labeled particle associated with a cell according to an embodiment of the present subject matter;

FIG. 47 shows particles fabricated through an open molding technique according to some embodiments of the present invention;

FIG. 48 shows a process for coating a seed and seeds coated from the process according to some embodiments of the present invention;

FIG. 49 shows a taggant having identifying characteristics according to an embodiment of the present invention;

FIGS. 50A and 50B show optical images at different magnification of boomerang shaped particles in the mold, according to an embodiment of the present invention;

FIG. 51A shows an optical microscopy image of PEG-fluorescein particles on a PEG film surface, according to an embodiment of the present invention;

FIG. 51B is an optical microscopy image of PEG particles in an array on the poly(cyanoacrylate) film, according to an embodiment of the present invention;

FIG. 52A shows boomerang PEG particles in uncured PEG resin, according to an embodiment of the present invention;

FIGS. 52B and 52C are optical microscopy images of an edge and center of PEG film containing both rectangular triacrylate and boomerang PEG particles, according to an embodiment of the present invention;

FIGS. 53A-53D show 200 nm trapezoidal particles fabricated from various matrix materials, according to an embodiment of the present invention;

FIGS. 54A-54F show a variety of PEG particles fabricated in different shapes and sizes, according to an embodiment of the present invention;

FIG. 55 is a graph depicting the uniformity in structure of particles fabricated according to methods and materials of embodiments of the present invention;

FIGS. 56A-56C show free-flowing particles, particles on a scum layer, and particles on a film according to an embodiment of the present invention; and

FIGS. 57A-57B show distinct particles having a sidewall pattern resulting from Bosch-type etch process used on the master, according to an embodiment of the present invention.

### DETAILED DESCRIPTION

The present subject matter will now be described more fully hereinafter with reference to the accompanying Figures and Examples, in which representative embodiments are shown. The present subject matter can, however, be embodied in different forms and should not be construed as limited to the embodiments set forth herein. Rather, these embodiments are provided to describe and enable one of skill in the art. Unless otherwise defined, all technical and scientific terms used herein have the same meaning as commonly understood by one of ordinary skill in the art to which the subject matter belongs. All publications, patent applications, patents, and other references mentioned herein are incorporated by reference in their entirety. Furthermore, throughout the specification and claims a given chemical formula or name shall encompass all optical and stereoisomers, as well as racemic mixtures where such isomers and mixtures exist.

The present subject matter generally describes articles that include micro or nano-cavities or molds from which taggant particles can be formed. The articles are fabricated from liquid polymer material, such as liquid fluoropolymers. Generally, the liquid polymer is contacted to a master template that includes micro or nano-sized features and the liquid polymer is cured while in contact therewith. After removal of the cured liquid polymer from the master template, the cured liquid polymer forms a patterned template that includes replicas of the micro or nano-sized features of the master template and the micro or nano-sized cavities in the cured liquid polymer can be used for high-resolution taggant fabrication. In some embodiments, the taggants fabricated from the micro or nano-sized cavities are isolated free standing taggant particles. In some embodiments, the taggants fabricated from the micro or nano-sized cavities form arrays of taggants.

### I. Materials

Representative materials useful in fabricating the articles that include micro or nano-cavities from which taggants can be formed include elastomer-based materials. The elastomer-based materials include, but are not limited to, fluorinated elastomer-based materials, solvent resistant elastomer based materials, combinations thereof, and the like. As used herein, the term “solvent resistant” refers to a material, such as an elastomeric material that either does not swell or does not substantially swell nor dissolve or substantially dissolve in common hydrocarbon-based organic solvents or acidic or basic aqueous solutions. Representative fluorinated elastomer-based materials include but are not limited to fluoropolyether and perfluoropolyether (PFPE) based materials. For ease of discussion the remainder of this specification will primarily describe PFPE based materials, however, it should be appreciated that the articles and methods disclosed and enabled herein can be applied to or with other materials.

The materials of the present invention are typically liquid polymers at room temperature and can be made curable by addition of a thermal curable constituent, photo curable constituent, combination thereof, or the like. A representative scheme for the synthesis and photocuring of functional PFPEs is provided in Scheme 1.

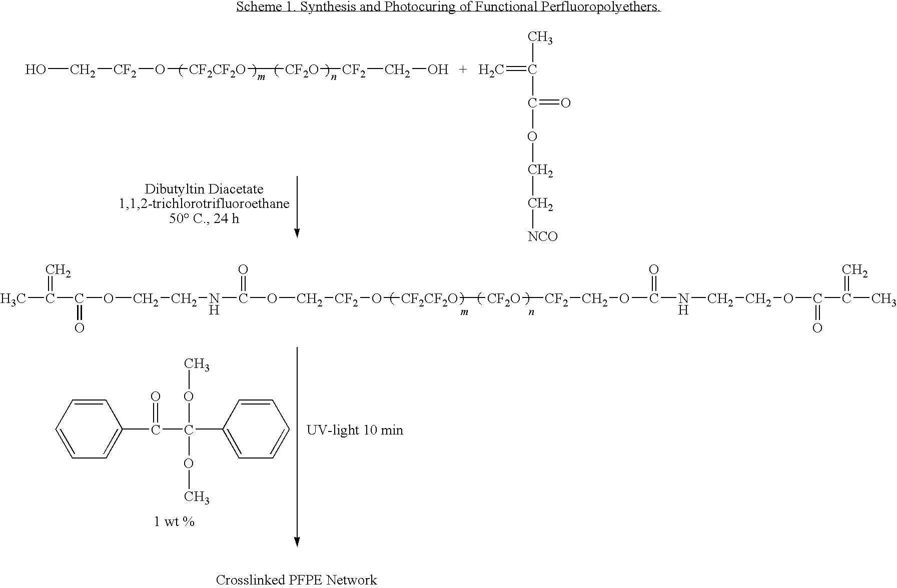

According to another embodiment, material of the present invention includes one or more of a photo-curable constituent, a thermal-curable constituent, mixtures thereof, and the like. In one embodiment, the material includes a photo-curable constituent and a thermal-curable constituent such that the material can undergo multiple cures. A material having the ability to undergo multiple cures is useful, for example, in forming articles of the present invention. For example, a liquid material having dual cure ability can include a material having a photo-curable and a thermal-curable constituent, two photo-curable constituents that cure at different wavelengths, two thermal-curable constituents that cure at different temperatures, or the like. In some embodiments, photo-curable and thermal-curable constituents can undergo a first cure through, for example, a photocuring process or a thermal curing process such that an article is first cured. Then the first photocured or thermal cured article can be subjected to a second cure to activate the curable component not activated in the first cure. In some embodiments, a first cured article can be adhered to a second cured article of the same material or any material similar thereto that will thermally cure or photocure and bind to the material of the first cured article. By positioning the first cured article and second cured article adjacent one another and subjecting the first and second cured articles to a thermalcuring or photocuring process, whichever component that was not activated on the first cure can be cured by a subsequent curing step. Thereafter, either the thermalcure constituents of the first cured article that was left un-activated by the photocuring process or the photocure constituents of the first cured article that were left un-activated by the first thermal curing, will be activated and bind the second article. Thereby, the first and second articles become adhered together. It will be appreciated by one of ordinary skill in the art that the order of curing processes is independent and a thermal-curing could occur first followed by a photocuring or a photocuring could occur first followed by a thermal curing.

According to yet another embodiment, multiple thermo-curable constituents can be included in the material such that the material can be subjected to multiple independent thermal-cures. For example, the multiple thermo-curable constituents can have different activation temperature ranges such that the material can undergo a first thermal-cure at a first temperature range and a second thermal-cure at a second temperature.

According to one embodiment the PFPE material has a surface energy below about 30 mN/m. According to another embodiment the surface energy of the PFPE is between about 10 mN/m and about 20 mN/m. According to another embodiment, the PFPE has a low surface energy of between about 12 mN/m and about 15 mN/m. In some embodiments, the surface energy is less than about 12 mN/m. The PFPE is non-toxic, UV transparent, and highly gas permeable; and cures into a tough, durable, highly fluorinated elastomer with excellent release properties and resistance to swelling. The properties of these materials can be tuned over a wide range through the judicious choice of additives, fillers, reactive co-monomers, and functionalization agents. Such properties that are desirable to modify, include, but are not limited to, modulus, tear strength, surface energy, permeability, functionality, mode of cure, solubility and swelling characteristics, and the like. The non-swelling nature and easy release properties of the presently disclosed PFPE materials allows for nanostructures to be fabricated from any material. Further, the presently disclosed subject matter can be expanded to large scale rollers or conveyor belt technology or rapid stamping that allow for the fabrication of nanostructures on an industrial scale.

In some embodiments, the patterned template includes a solvent resistant, low surface energy polymeric material derived from casting low viscosity liquid materials onto a master template and then curing the low viscosity liquid materials to generate a patterned template. In some embodiments, the patterned template includes a solvent resistant elastomeric material.

In some embodiments, at least one of the patterned template and substrate includes a material selected from the group including a perfluoropolyether material, a fluoroolefin material, an acrylate material, a silicone material, a styrenic material, a fluorinated thermoplastic elastomer (TPE), a triazine fluoropolymer, a perfluorocyclobutyl material, a fluorinated epoxy resin, and a fluorinated monomer or fluorinated oligomer that can be polymerized or crosslinked by a metathesis polymerization reaction.

In some embodiments, the perfluoropolyether material includes a backbone structure selected from the group including:

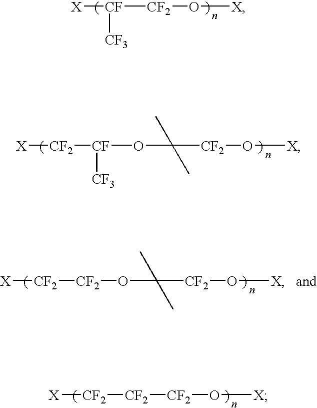

wherein X is present or absent, and when present includes an endcapping group.

In some embodiments, the fluoroolefin material is selected from the group including:

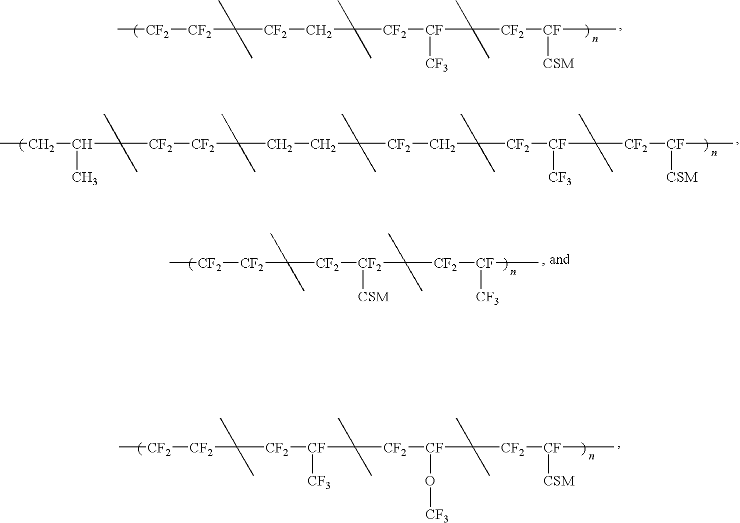

wherein CSM includes a cure site monomer.

In some embodiments, the fluoroolefin material is made from monomers which include tetrafluoroethylene, vinylidene fluoride, hexafluoropropylene, 2,2-bis(trifluoromethyl)-4,5-difluoro-1,3-dioxole, a functional fluoroolefin, functional acrylic monomer, and a functional methacrylic monomer.

In some embodiments, the silicone material includes a fluoroalkyl functionalized polydimethylsiloxane (PDMS) having the following structure:

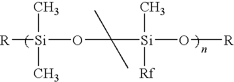

wherein:

R is selected from the group including an acrylate, a methacrylate, and a vinyl group; and

Rf includes a fluoroalkyl chain.

In some embodiments, the styrenic material includes a fluorinated styrene monomer selected from the group including:

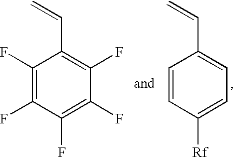

wherein Rf includes a fluoroalkyl chain.

In some embodiments, the acrylate material includes a fluorinated acrylate or a fluorinated methacrylate having the following structure:

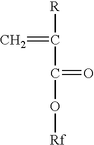

wherein:

R is selected from the group including H, alkyl, substituted alkyl, aryl, and substituted aryl; and

Rf includes a fluoroalkyl chain.

In some embodiments, the triazine fluoropolymer includes a fluorinated monomer. In some embodiments, the fluorinated monomer or fluorinated oligomer that can be polymerized or crosslinked by a metathesis polymerization reaction includes a functionalized olefin. In some embodiments, the functionalized olefin includes a functionalized cyclic olefin.

In some embodiments, at least one of the patterned template and the substrate has a surface energy lower than about 18 mN/m. In some embodiments, at least one of the patterned template and the substrate has a surface energy lower than about 15 mN/m. According to a further embodiment the patterned template and/or the substrate has a surface energy between about 10 mN/m and about 20 mN/m. According to another embodiment, the patterned template and/or the substrate has a low surface energy of between about 12 mN/m and about 15 mN/m. In another embodiment, the patterned template and/or the substrate has a surface energy of below about 12 mN/m.

From a property point of view, the exact properties of these molding materials can be adjusted by adjusting the composition of the ingredients used to make the materials. In particular the modulus can be adjusted from low (approximately 1 MPa) to multiple GPa.

According to an alternative embodiment, the PFPE material includes a urethane block as described and shown in the following structures:

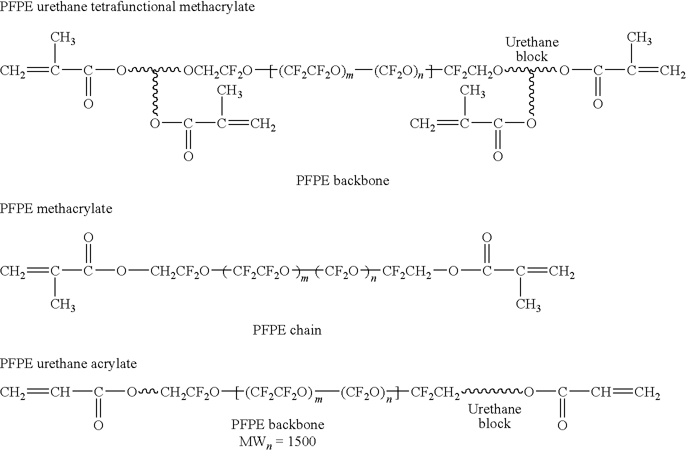

According to an embodiment of the presently disclosed subject matter, PFPE urethane tetrafunctional methacrylate materials, such as the above described material, can be used as the materials and methods of the presently disclosed subject matter or can be used in combination with other materials and methods described herein, as will be appreciated by one of ordinary skill in the art.

II. Formation of Isolated Micro- and/or Nanoparticles and Taggants

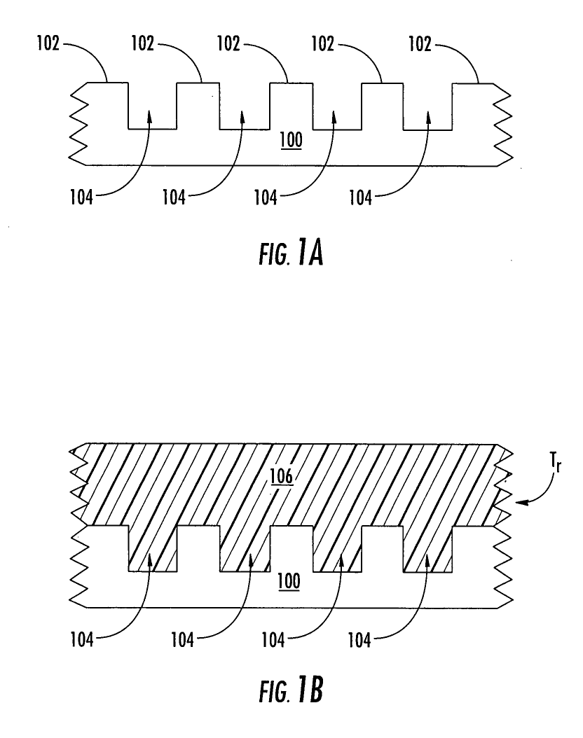

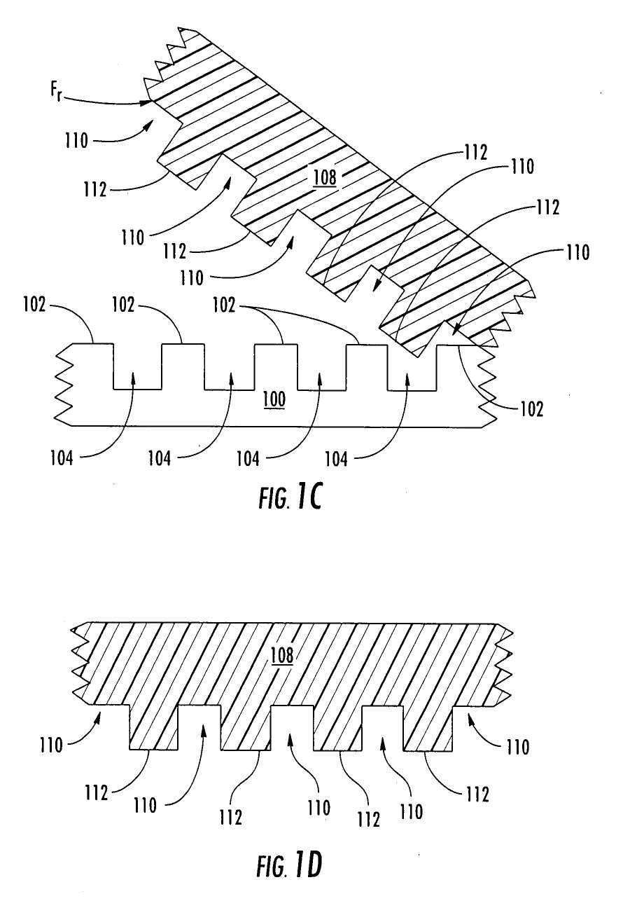

In some embodiments, the present subject matter provides articles and methods for making isolated micro- and/or nanoparticles that can be, for example, taggants. Turning now to FIG. 1A, patterned master 100 is provided. Patterned master 100 includes a plurality of non-recessed surface areas 102 and a plurality of recesses 104. In some embodiments, patterned master 100 includes an etched substrate, such as a silicon wafer, which is etched or otherwise fabricated into a desired pattern to form patterned master 100.

Referring now to FIG. 1B, a liquid material 106, for example, a liquid fluoropolymer composition, such as a PFPE-based precursor, is then poured onto patterned master 100. Liquid material 106 is treated by treating process Tᵣ, for example exposure to UV light, actinic radiation, or the like, thereby forming a treated liquid material 108 in the desired pattern.

Referring now to FIGS. 1C and 1D, a force Fᵣ is applied to treated liquid material 108 to remove it from patterned master 100. As shown in FIGS. 1C and 1D, treated liquid material 108 includes a plurality of recesses 110, which are mirror images of the plurality of non-recessed surface areas 102 of patterned master 100. Continuing with FIGS. 1C and 1D, treated liquid material 108 includes a plurality of first patterned surface areas 112, which are mirror images of the plurality of recesses 104 of patterned master 100. Accordingly, treated liquid material 108 can be used as a patterned template for the formation of isolated micro- and nanoparticles, which in turn can be used as taggants. For the purposes of FIGS. 1A-1D, 2A-2E, and 3A-3F, the numbering scheme for like structures is retained throughout, where possible.

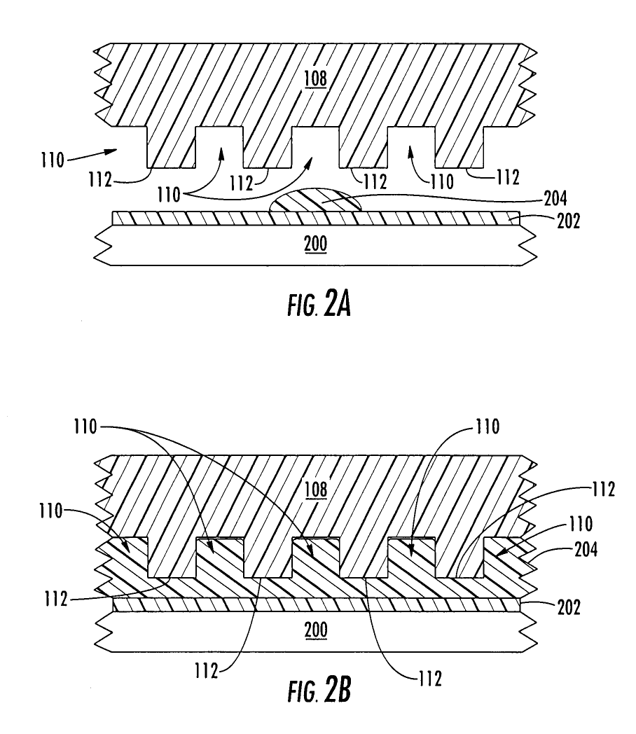

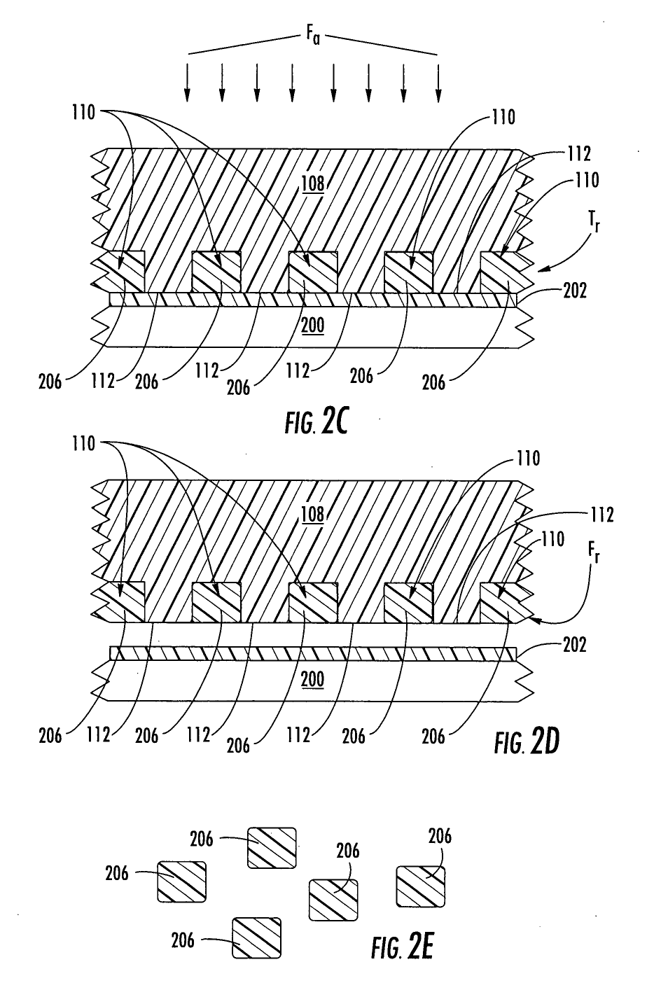

Referring now to FIG. 2A, in some embodiments, a substrate 200, for example, a silicon wafer, is treated or is coated with a non-wetting material 202. In some embodiments, non-wetting material 202 includes an elastomer (such a solvent resistant elastomer, including but not limited to a PFPE elastomer described herein) that can be cured to form a thin, non-wetting layer on the surface of substrate 200. Substrate 200 also can be made non-wetting by treating substrate 200 with non-wetting agent 202, for example a small molecule, such as an alkyl- or fluoroalkyl-silane, or other surface treatment. Continuing with FIG. 2A, a droplet 204 of a curable resin, a monomer, or a solution from which the desired particles will be formed is then placed on the coated substrate 200.

Referring now to FIG. 2A and FIG. 2B, patterned template 108 (as shown in FIG. 1D) is then contacted with droplet 204 of a particle precursor material so that droplet 204 fills the plurality of recessed areas 110 of patterned template 108. Referring now to FIGS. 2C and 2D, a force Fₐ can be applied to patterned template 108. In some embodiments, as force Fₐ is applied the affinity of patterned template 108 for non-wetting coating or surface treatment 202 on substrate 200 in combination with the non-wetting behavior of patterned template 108 and surface treated or coated substrate 200 causes droplet 204 to be excluded from all areas except for recessed areas 110. In other embodiments, excess droplet material 204 can be used such that the material in the recessed areas is interconnected. In yet other embodiments, the patterned template can be essentially free of non-wetting or low wetting material 202 such that when droplet 204 is contacted with the patterned template droplet material 204 wets the surface and a scum layer is formed that can interconnect the material in the recessed areas.

Continuing with FIGS. 2C and 2D, the particle precursor material filling recessed areas 110, e.g., a resin, monomer, solvent, combinations thereof, or the like, is then treated by a treating process Tᵣ, e.g., photocured, UV-light treated, actinic radiation treated, let evaporate, heated, centrifuged, or the like, to form a plurality of micro- and/or nanoparticles 206. In some embodiments, a material, including but not limited to a polymer, an organic compound, or an inorganic compound, can be dissolved in a solvent, patterned using patterned template 108, and the solvent can be released. Once the material filling recessed areas 110 is treated or hardened, patterned template 108 is removed from substrate 200. Micro- and/or nanoparticles 206 are confined to recessed areas 110 of patterned template 108. In some embodiments, micro- and/or nanoparticles 206 can be retained on substrate 200 in defined regions once patterned template 108 is removed.

Referring now to FIGS. 2D and 2E, micro- and/or nanoparticles 206 can be removed from patterned template 108 to provide freestanding particles or taggants by a variety of methods, which include but are not limited to: applying patterned template 108 to a surface that has an affinity for the particles 206; deforming patterned template 108, or using other mechanical methods, including sonication, in such a manner that the particles 206 are naturally released from patterned template 108; swelling patterned template 108 reversibly with supercritical carbon dioxide or another solvent that will extrude the particles 206; washing patterned template 108 with a solvent that has an affinity for the particles 206 and will wash them out of patterned template 108; applying patterned template 108 to a liquid that when hardened physically entraps particles 206; applying patterned template 108 to a material that when hardened has a chemical and/or physical interaction with particles 206; combinations thereof; and the like.

In some embodiments, the methods of producing and harvesting particles include a batch process or a continuous process. In some embodiments, the batch process is selected from one of a semi-batch process and a continuous batch process. Referring now to FIG. 2F, an embodiment of the presently disclosed subject matter wherein particles 206 are produced in a continuous process is schematically presented. An apparatus 199 is provided for carrying out the process. Indeed, while FIG. 2F schematically presents a continuous process for particles, apparatus 199 can be adapted for batch processes and for providing a pattern on a substrate continuously or in batch in accordance with the present subject matter.

FIG. 2F shows droplet 204 of liquid material applied to substrate 200′ via reservoir 203. Substrate 200′ can be coated or not coated with a non-wetting agent. Substrate 200′ and pattern template 108′ are placed in a spaced relationship with respect to each other and are also operably disposed with respect to each other to provide for the conveyance of droplet 204 between patterned template 108′ and substrate 200′. Conveyance is facilitated through the provision of pulleys 208, which are in operative communication with controller 201. By way of representative non-limiting examples, controller 201 can include a computing system, appropriate software, a power source, a radiation source, and/or other suitable devices for controlling the functions of apparatus 199. Thus, controller 201 provides for power for and other control of the operation of pulleys 208 to provide for the conveyance of droplet 204 between patterned template 108′ and substrate 200′. Particles 206 are formed and treated between substrate 200′ and patterned template 108′ by a treating process T_{R}, which is also controlled by controller 201. Particles 206 are collected in an inspecting device 210, which is also controlled by controller 201. Inspecting device 210 provides for one of inspecting, measuring, and both inspecting and measuring one or more characteristics of particles 206. Representative examples of inspecting devices 210 are disclosed elsewhere herein.

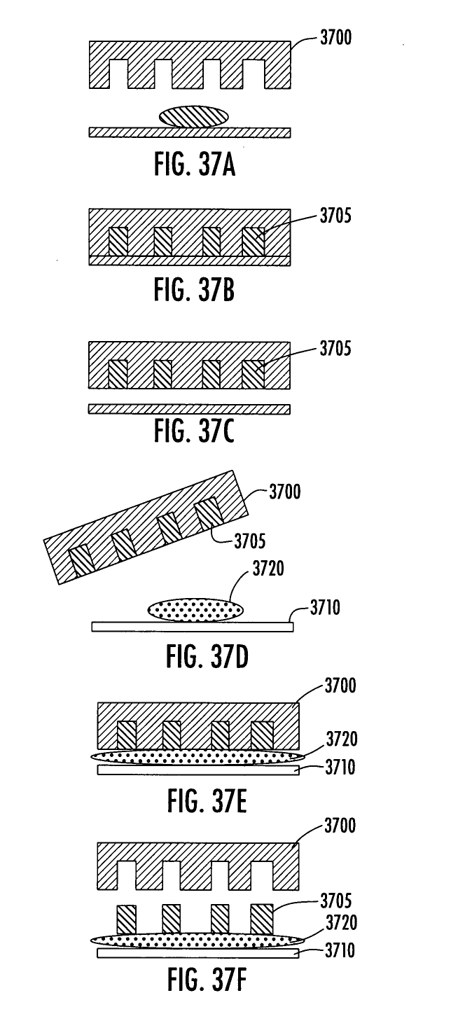

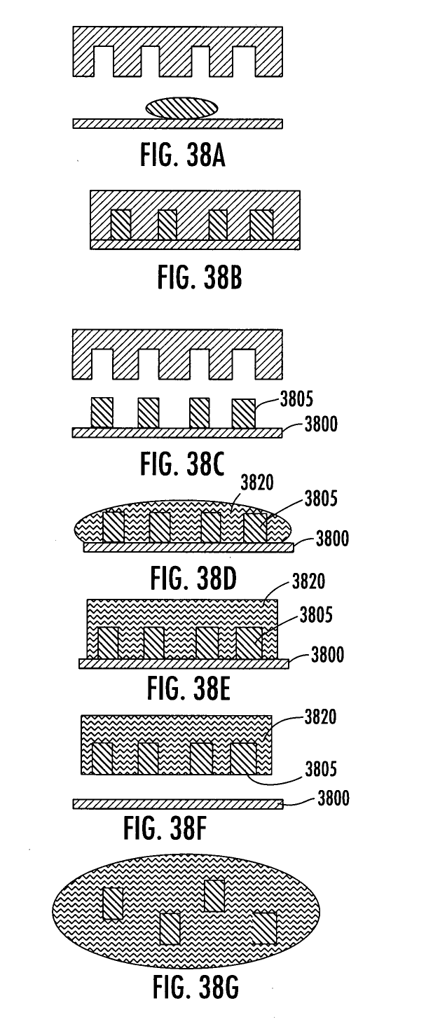

Further embodiments of particle harvesting methods described herein, are shown in FIGS. 37A-37F and FIGS. 38A-38G. In FIGS. 37A-37C and FIGS. 38A-38C particles which are produced in accordance with embodiments described herein remain in contact with an article 3700, 3800 having an affinity for particles 3705 and 3805 respectively. In one embodiment, article 3700 is a patterned template or mold as described herein. In one embodiment, article 3800 is a substrate as described herein.

Referring now to FIGS. 37D-37 F and FIGS. 38D-38G, material 3720, 3820 having an affinity for particles 3705, 3805 is put into contact with particles 3705, 3805 while particles 3705, 3805 remain in connection with articles 3700, 3800. In the embodiment of FIG. 37D, material 3720 is disposed on surface 3710. In the embodiment of FIG. 38D, material 3820 is applied directly to article 3800 having particles 3820. As illustrated in FIGS. 37E, 38D in some embodiments, article 3700, 3800 is put in engaging contact with material 3720, 3820. In one embodiment material 3720, 3820 is thereby dispersed to coat at least a portion of substantially all of particles 3705, 3805 while particles 3705, 3805 are attached to article 3700, 3800 (e.g., a patterned template). In one embodiment, illustrated in FIGS. 37F and 38F, articles 3700, 3800 are substantially disassociated with material 3720, 3820. In one embodiment, material 3720, 3820 has a higher affinity for particles 3705, 3805 than the affinity between article 3700, 3800 and particles 3705, 3805. In FIGS. 37F and 38F, the disassociation of article 3700, 3800 from material 3720, 3820 thereby releases particles 3705, 3805 from article 3700, 3800 leaving particles 3705, 3805 attached to material 3720, 3820.

In one embodiment material 3720, 3820 has an affinity for particles 3705 and 3805. For example, in some embodiments, material 3720, 3820 includes an adhesive or sticky surface when applied to article 3700, 3800. In other embodiments, material 3720, 3820 undergoes a transformation after it is brought into contact with article 3700, 3800. In some embodiments that transformation is an inherent characteristic of material 3705, 3805. In other embodiments, material 3705, 3805 is treated to induce the transformation. For example, in one embodiment material 3720, 3820 is an epoxy that hardens after it is brought into contact with article 3700, 3800. Thus when article 3700, 3800 is pealed away from the hardened epoxy, particles 3705, 3805 remain engaged with the epoxy and not article 3700, 3800. In other embodiments, material 3720, 3820 is water that is cooled to form ice. Thus, when article 3700, 3800 is stripped from the ice, particles 3705, 3805 remain in communication with the ice and not article 3700, 3800. In one embodiment, the particle-containing ice can be melted to create a liquid with a concentration of particles 3705, 3805. In some embodiments, material 3705, 3805 include, without limitation, one or more of a carbohydrate, an epoxy, a wax, polyvinyl alcohol, polyvinyl pyrrolidone, polybutyl acrylate, a polycyano acrylate and polymethyl methacrylate. In some embodiments, material 3720, 3820 includes, without limitation, one or more of liquids, solutions, powders, granulated materials, semi-solid materials, suspensions, combinations thereof, or the like.

In some embodiments, the plurality of recessed areas includes a plurality of cavities. In some embodiments, the plurality of cavities includes a plurality of structural features. In some embodiments, the plurality of structural features includes a dimension ranging of less than about 50 microns. In some embodiments, the plurality of structural features includes a dimension less than about 40 microns. In some embodiments, the plurality of structural features includes a dimension less than about 20 microns. In some embodiments, the plurality of structural features includes a dimension less than about 10 microns. In some embodiments, the plurality of structural features includes a dimension less than about 5 microns. In some embodiments, the plurality of structural features includes a dimension less than about 2 microns. In some embodiments, the plurality of structural features includes a dimension less than about 1 micron. In some embodiments, the plurality of structural features includes a dimension ranging from about 50 microns to about 1 nanometer in size. In some embodiments, the plurality of structural features includes a dimension ranging from about 10 microns to about 1 angstrom in size. In some embodiments, the plurality of structural features includes a dimension ranging from about 1 micron to about 1 nanometer in size. In some embodiments, the plurality of structural features includes a dimension ranging from about 500 nanometers to about 5 nanometers in size. In some embodiments, the plurality of structural features includes a dimension ranging from about 100 nanometers to about 0.1 nanometers in size. In some embodiments, the plurality of structural features includes a dimension ranging from about 75 nanometers to about 0.5 nanometers in size. In some embodiments, the plurality of structural features includes a dimension in both the horizontal and vertical plane.

According to yet another embodiment the particles are harvested on a fast dissolving substrate, sheet, or films. The film-forming agents can include, but are not limited to pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, combinations thereof, and the like. In some embodiments, pullulan is used as the primary filler. In still other embodiments, pullulan is included in amounts ranging from about 0.01 to about 99 wt %, preferably about 30 to about 80 wt %, more preferably from about 45 to about 70 wt %, and even more preferably from about 60 to about 65 wt % of the film.

In some embodiments of the methods for forming one or more isolated particles or taggants, the patterned template includes a solvent resistant, low surface energy polymeric material derived from casting low viscosity liquid materials onto a master template and then curing the low viscosity liquid materials to generate a patterned template. In some embodiments, the patterned template includes a solvent resistant elastomeric material.

In some embodiments, the substrate is selected from the group including a polymer material, an inorganic material, a silicon material, a quartz material, a glass material, and surface treated variants thereof. In some embodiments, the substrate includes a patterned area.

In some embodiments, the patterned template includes a patterned template formed by a replica molding process. In some embodiments, the replica molding process includes: providing a master template; contacting a liquid material with the master template; and curing the liquid material to form a patterned template.

In some embodiments, the master template includes, without limitation, one or more of a template formed from a lithography process, a naturally occurring template, combinations thereof, or the like. In some embodiments, the natural template is selected from one of a biological structure and a self-assembled structure. In some embodiments, the one of a biological structure and a self-assembled structure is selected from the group including a naturally occurring crystal, an enzyme, a virus, a protein, a micelle, and a tissue surface.

In some embodiments, the method includes modifying the patterned template surface by a surface modification step. In some embodiments, the surface modification step is selected from the group including a plasma treatment, a chemical treatment, and an adsorption process. In some embodiments, the adsorption process includes adsorbing molecules selected from the group including a polyelectrolyte, a poly(vinylalcohol), an alkylhalosilane, and a ligand.

In some embodiments, the method includes positioning the patterned template and the substrate in a spaced relationship to each other such that the patterned template surface and the substrate face each other in a predetermined alignment.

In some embodiments, an article is contacted with the layer of liquid material and a force is applied to the article to thereby remove the liquid material from the one of the patterned material and the substrate. In some embodiments, the article is selected from the group including a roller, a “squeegee” blade type device, a nonplanar polymeric pad, combinations thereof, or the like. In some embodiments, the liquid material is removed by some other mechanical apparatus.

In some embodiments, the contacting of the patterned template surface with the substrate forces essentially all of the disposed liquid material from between the patterned template surface and the substrate.

In some embodiments, the treating of the liquid material includes a process selected from the group including a thermal process, a phase change, an evaporative process, a photochemical process, and a chemical process.

In some embodiments, the mechanical force is applied by contacting one of a doctor blade and a brush with the one or more particles. In some embodiments, the mechanical force is applied by ultrasonics, megasonics, electrostatics, or magnetics means.

In some embodiments, the methods include harvesting or collecting the particles or taggants. In some embodiments, the harvesting or collecting of the particles includes a process selected from the group including scraping with a doctor blade, a brushing process, a dissolution process, an ultrasound process, a megasonics process, an electrostatic process, and a magnetic process. In some embodiments, the harvesting or collecting of the particles includes applying a material to at least a portion of a surface of the particle wherein the material has an affinity for the particles. In some embodiments, the material includes an adhesive or sticky surface. In some embodiments, the material includes, without limitation, one or more of a carbohydrate, an epoxy, a wax, polyvinyl alcohol, polyvinyl pyrrolidone, polybutyl acrylate, a polycyano acrylate, a polyacrylic acid and polymethyl methacrylate. In some embodiments, the harvesting or collecting of the particles includes cooling water to form ice (e.g., in contact with the particles). In some embodiments, the presently disclosed subject matter describes a particle or plurality of particles formed by the methods described herein. In some embodiments, the plurality of particles includes a plurality of monodisperse particles. In some embodiments, the particle or plurality of particles is selected from the group including a semiconductor device, a crystal, a drug delivery vector, a gene delivery vector, a disease detecting device, a disease locating device, a photovoltaic device, a porogen, a cosmetic, an electret, an additive, a catalyst, a sensor, a detoxifying agent, an abrasive, such as a CMP, a micro-electro-mechanical system (MEMS), a cellular scaffold, a taggant, a pharmaceutical agent, and a biomarker. In some embodiments, the particle or plurality of particles includes a freestanding structure.

Further, in some embodiments, the present subject matter describes methods of fabricating isolated liquid objects, the method including (a) contacting a liquid material with the surface of a first low surface energy material; (b) contacting the surface of a second low surface energy material with the liquid, wherein at least one of the surfaces of either the first or second low surface energy material is patterned; (c) coupling the surfaces of the first and the second low surface energy materials together; and (d) separating the two low surface energy materials to produce a replica pattern including liquid droplets.

In some embodiments, the liquid material includes poly(ethylene glycol)-diacrylate. In some embodiments, the low surface energy material includes perfluoropolyether-diacrylate. In some embodiments, a mechanical process is used to couple the surfaces of the first and the second low surface energy materials. In some embodiments, a chemical process is used to couple or seal the surfaces of the first and the second low surface energy materials. In some embodiments, a physical process is used to seal the surfaces of the first and the second low surface energy materials. In some embodiments, one of the surfaces of the low surface energy material is patterned. In some embodiments, one of the surfaces of the low surface energy material is not patterned.

In some embodiments, the methods further include using the replica pattern composed of liquid droplets to fabricate other objects. In some embodiments, the replica pattern of liquid droplets is formed on the surface of the low surface energy material that is not patterned. In some embodiments, the liquid droplets undergo direct or partial solidification. In some embodiments, the liquid droplets undergo a chemical transformation. In some embodiments, the solidification of the liquid droplets or chemical transformation of the liquid droplets produces freestanding objects, such as taggants. In some embodiments, the freestanding objects are harvested. In some embodiments, the freestanding objects are bonded in place. In some embodiments, the freestanding objects are directly solidified, partially solidified, or chemically transformed.

In some embodiments, the liquid droplets are directly solidified, partially solidified, or chemically transformed on or in the patterned template to produce objects embedded in the recesses of the patterned template. In some embodiments, the embedded objects are harvested. In some embodiments, the embedded objects are bonded in place. In some embodiments, the embedded objects are used in other fabrication processes, such as for security or authentication of other manufactured goods by using the objects as taggants.

In some embodiments, the replica pattern of liquid droplets is transferred to other surfaces. In some embodiments, the transfer takes place before the solidification or chemical transformation process. In some embodiments, the transfer takes place after the solidification or chemical transformation process. In some embodiments, the surface to which the replica pattern of liquid droplets is transferred is selected from the group including a non-low surface energy surface, a low surface energy surface, a functionalized surface, and a sacrificial surface. In some embodiments, the methods produce a pattern on a surface that is essentially free of one or more scum layers. In some embodiments, the methods are used to fabricate semiconductors and other electronic and photonic devices or arrays. In some embodiments, the methods are used to create freestanding objects. In some embodiments, the methods are used to create three-dimensional objects using multiple patterning steps. In some embodiments, the isolated or patterned object includes materials selected from the group including organic, inorganic, polymeric, and biological materials. In some embodiments, a surface adhesive agent is used to anchor the isolated structures on a surface.

In some embodiments, the liquid droplet arrays or solid arrays on patterned or non-patterned surfaces are used as regiospecific delivery devices or reaction vessels for additional chemical processing steps. In some embodiments, the additional chemical processing steps are selected from the group including printing of organic, inorganic, polymeric, biological, and catalytic systems onto surfaces; synthesis of organic, inorganic, polymeric, biological materials; and other applications in which localized delivery of materials to surfaces is desired. Applications of the presently disclosed subject matter include, but are not limited to, micro and nanoscale patterning or printing of materials. In some embodiments, the materials to be patterned or printed are selected from the group including surface-binding molecules, inorganic compounds, organic compounds, polymers, biological molecules, nanoparticles, viruses, biological arrays, and the like.

In some embodiments, the applications of the presently disclosed subject matter include, but are not limited to, the synthesis of polymer brushes, catalyst patterning for CVD carbon nanotube growth, cell scaffold fabrication, the application of patterned sacrificial layers, such as etch resists, and the combinatorial fabrication of organic, inorganic, polymeric, and biological arrays.

In some embodiments, non-wetting imprint lithography, and related techniques, are combined with methods to control the location and orientation of chemical components within an individual object. In some embodiments, such methods improve the performance of an object by rationally structuring the object so that it is optimized for a particular application. In some embodiments, the method includes incorporating biological targeting agents into particles for drug delivery, vaccination, and other applications. In some embodiments, the method includes designing the particles to include a specific biological recognition motif. In some embodiments, the biological recognition motif includes biotin/avidin and/or other proteins.

In some embodiments, the method includes tailoring the chemical composition of these materials and controlling the reaction conditions, whereby it is then possible to organize the biorecognition motifs so that the efficacy of the particle is optimized. In some embodiments, the particles are designed and synthesized so that recognition elements are located on the surface of the particle in such a way to be accessible to cellular binding sites, wherein the core of the particle is preserved to contain bioactive agents, such as therapeutic molecules. In some embodiments, a non-wetting imprint lithography method is used to fabricate the objects, wherein the objects are optimized for a particular application by incorporating functional motifs, such as biorecognition agents, into the object composition. In some embodiments, the method further includes controlling the microscale and nanoscale structure of the object by using methods selected from the group including self-assembly, stepwise fabrication procedures, reaction conditions, chemical composition, crosslinking, branching, hydrogen bonding, ionic interactions, covalent interactions, and the like. In some embodiments, the method further includes controlling the microscale and nanoscale structure of the object by incorporating chemically organized precursors into the object. In some embodiments, the chemically organized precursors are selected from the group including block copolymers and core-shell structures.

In sum, the presently disclosed subject matter describes a non-wetting replication technique that is scalable and offers a simple, direct route to such particles and taggants without the use of self-assembled, difficult to fabricate block copolymers and other systems.

II.A. Micro and Nano Particles and Taggants

According to some embodiments of the present subject matter, a particle is formed having a predetermined shape, size, formulation, density, composition, surface features, spectral analysis, or the like and can be less than about 50 μm in a given dimension (e.g. minimum, intermediate, or maximum dimension) and such particle can be used as a taggant. In some embodiments, the particle or taggant is less than about 40 μm in a broadest dimension. In some embodiments, the particle or taggant is less than about 30 μm in a broadest dimension. In some embodiments, the particle or taggant is less than about 20 μm in a broadest dimension. In some embodiments, the particle or taggant is less than about 5 μm in a broadest dimension. In some embodiments, the particle or taggant is less than about 1 μm in a broadest dimension. In some embodiments, the particle or taggant is less than about 900 nm in a broadest dimension. In some embodiments, the particle or taggant is less than about 800 nm in a broadest dimension. In some embodiments, the particle or taggant is less than about 700 nm in a broadest dimension. In some embodiments, the particle or taggant is less than about 600 nm in a broadest dimension. In some embodiments, the particle or taggant is less than about 500 nm in a broadest dimension. In some embodiments, the particle or taggant is less than about 400 nm in a broadest dimension. In some embodiments, the particle or taggant is less than about 300 nm in a broadest dimension. In some embodiments, the particle or taggant is less than about 200 nm in a broadest dimension. In some embodiments, the particle or taggant is less than about 100 nm in a broadest dimension. In some embodiments, the particle or taggant is less than about 80 nm in a broadest dimension. In some embodiments, the particle or taggant is less than about 75 nm in a broadest dimension. In some embodiments, the particle or taggant is less than about 70 nm in a broadest dimension. In some embodiments, the particle or taggant is less than about 65 nm in a broadest dimension. In some embodiments, the particle or taggant is less than about 60 nm in a broadest dimension. In some embodiments, the particle or taggant is less than about 55 nm in a broadest dimension. In some embodiments, the particle or taggant is less than about 50 nm in a broadest dimension. In some embodiments, the particle or taggant is less than about 45 nm in a broadest dimension. In some embodiments, the particle or taggant is less than about 40 nm in a broadest dimension. In some embodiments, the particle or taggant is less than about 35 nm in a broadest dimension. In some embodiments, the particle or taggant is less than about 30 nm in a broadest dimension. In some embodiments, the particle or taggant is less than about 25 nm in a broadest dimension. In some embodiments, the particle or taggant is less than about 20 nm in a broadest dimension. In some embodiments, the particle or taggant is less than about 15 nm in a broadest dimension. In some embodiments, the particle or taggant is less than about 10 nm in a broadest dimension. In some embodiments, the particle or taggant is less than about 7 nm in a broadest dimension. In some embodiments, the particle or taggant is less than about 5 nm in a broadest dimension. In some embodiments, the particle or taggant is less than about 2 nm in a broadest dimension. In some embodiments, the particle or taggant is less than about 0.5 nm in a broadest dimension. In some embodiments, the particle or taggant is less than about 0.1 nm in a broadest dimension. The particle can be of an organic material or an inorganic material and can be one uniform compound or component or a mixture of compounds or components.

In yet other embodiments, the particle or taggant can include a functional location such that the particle can be used as an analytical material. According to such embodiments, a particle includes a functional molecular imprint. The functional molecular imprint can include functional monomers arranged as a negative image of a template. The template, for example, can be but is not limited to, an enzyme, a protein, an antibiotic, an antigen, a nucleotide sequence, an amino acid, a drug, a biologic, nucleic acid, combinations thereof, or the like. In other embodiments, the particle itself, for example, can be, but is not limited to, an artificial functional molecule. In one embodiment, the artificial functional molecule is a functionalized particle that has been molded from a molecular imprint. As such, a molecular imprint is generated in accordance with methods and materials of the presently disclosed subject matter and then a particle is formed from the molecular imprint, in accordance with further methods and materials of the presently disclosed subject matter. Such an artificial functional molecule includes substantially similar steric and chemical properties of a molecular imprint template. In one embodiment, the functional monomers of the functionalized particle are arranged substantially as a negative image of functional groups of the molecular imprint.

According to further embodiments, the particles include patterned features that are about 2 nm in a dimension. In still further embodiments, the patterned features are between about 2 nm and about 200 nm. In some embodiments the patterned features can be grooves or bosch-type etch lines on an outer surface of the particle.

According to other embodiments, the particles produced by the methods and materials of the presently disclosed subject matter have a substantially the same size and/or shape and differ by less than 0.001 percent between particles. In other embodiments, the particles differ in size and/or shape from each other by less than about 0.005 percent. In other embodiments, the particles differ in size and/or shape from each other by less than about 0.01 percent. In other embodiments, the particles differ in size and/or shape from each other by less than about 0.05 percent. In other embodiments, the particles differ in size and/or shape from each other by less than about 0.1 percent. In other embodiments, the particles differ in size and/or shape from each other by less than about 0.5 percent. In other embodiments, the particles do not differ in size and/or shape from each other.

According to other embodiments, particles and taggants of many predetermined regular and irregular shape and size configurations can be made with the materials and methods of the presently disclosed subject matter. Examples of representative shapes that can be made using the materials and methods of the presently disclosed subject matter include, but are not limited to, non-spherical, spherical, viral shaped, bacteria shaped, cell shaped, rod shaped (e.g., where the rod is less than about 200 nm in diameter), chiral shaped, right triangle shaped, flat shaped (e.g., with a thickness of about 2 nm, disc shaped with a thickness of greater than about 2 nm, or the like), boomerang shaped, combinations thereof, and the like.

In some embodiments, the material from which the particles are formed includes, without limitation, one or more of a polymer, a liquid polymer, a solution, a monomer, a plurality of monomers, a polymerization initiator, a polymerization catalyst, an inorganic precursor, an organic material, a natural product, a metal precursor, a pharmaceutical agent, a tag, a magnetic material, a paramagnetic material, a ligand, a cell penetrating peptide, a porogen, a surfactant, a plurality of immiscible liquids, a solvent, a charged species, combinations thereof, or the like.

In some embodiments, the monomer includes butadienes, styrenes, propene, acrylates, methacrylates, vinyl ketones, vinyl esters, vinyl acetates, vinyl chlorides, vinyl fluorides, vinyl ethers, acrylonitrile, methacrylnitrile, acrylamide, methacrylamide allyl acetates, fumarates, maleates, ethylenes, propylenes, tetrafluoroethylene, ethers, isobutylene, fumaronitrile, vinyl alcohols, acrylic acids, amides, carbohydrates, esters, urethanes, siloxanes, formaldehyde, phenol, urea, melamine, isoprene, isocyanates, epoxides, bisphenol A, alcohols, chlorosilanes, dihalides, dienes, alkyl olefins, ketones, aldehydes, vinylidene chloride, anhydrides, saccharide, acetylenes, naphthalenes, pyridines, lactams, lactones, acetals, thiiranes, episulfide, peptides, derivatives thereof, and combinations thereof.

In yet other embodiments, the polymer includes polyamides, proteins, polyesters, polystyrene, polyethers, polyketones, polysulfones, polyurethanes, polysiloxanes, polysilanes, cellulose, amylose, polyacetals, polyethylene, glycols, poly(acrylate)s, poly(methacrylate)s, poly(vinyl alcohol), poly(vinylidene chloride), poly(vinyl acetate), poly(ethylene glycol), polystyrene, polyisoprene, polyisobutylenes, poly(vinyl chloride), poly(propylene), poly(lactic acid), polyisocyanates, polycarbonates, alkyds, phenolics, epoxy resins, polysulfides, polyimides, liquid crystal polymers, heterocyclic polymers, polypeptides, conducting polymers including polyacetylene, polyquinoline, polyaniline, polypyrrole, polythiophene, and poly(p-phenylene), dendimers, fluoropolymers, derivatives thereof, combinations thereof,

In still further embodiments, the material from which the particles are formed includes a non-wetting agent. According to another embodiment, the material is a liquid material in a single phase. In other embodiments, the liquid material includes a plurality of phases. In some embodiments, the liquid material includes, without limitation, one or more of multiple liquids, multiple immiscible liquids, surfactants, dispersions, emulsions, micro-emulsions, micelles, particulates, colloids, porogens, active ingredients, combinations thereof, or the like.

In some embodiments, additional components are included with the material of the particle to functionalize the particle. According to these embodiments the additional components can be encased within the isolated structures, partially encased within the isolated structures, on the exterior surface of the isolated structures, combinations thereof, or the like. Additional components can include, but are not limited to, drugs, biologics, more than one drug, more than one biologic, combinations thereof, and the like.

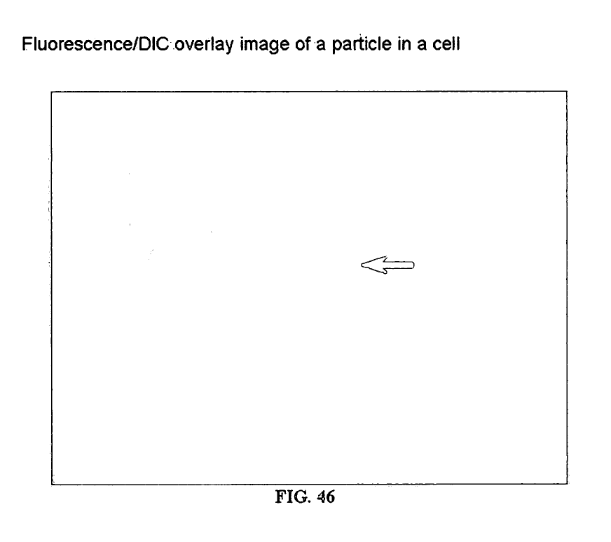

According to some embodiments, radiotracers and/or radiopharmaceuticals are included with the particles. Examples of radiotracers and/or radiopharmaceuticals that can be combined with the isolated structures of the presently disclosed subject matter include, but are not limited to, [¹⁵O]oxygen, [¹⁵O]carbon monoxide, [¹⁵O]carbon dioxide, [¹⁵O]water, [¹³N]ammonia, [¹⁸F]FDG, [¹⁸F]FMISO, [¹⁸F]MPPF, [¹⁸F]A85380, [¹⁸F]FLT, [¹¹C]SCH23390, [¹¹“C]flumazenil, [”¹¹C]PK11195, [¹¹C]PIB, [¹¹C]AG1478, [¹¹C]choline, [¹¹C]AG957, [¹⁸F]nitroisatin, [¹⁸F]mustard, combinations thereof, and the like. In some embodiments elemental isotopes are included with the particles. In some embodiments, the isotopes include ¹¹C, ¹³N, ¹⁵O, ¹⁸F, ³²P, ⁵¹Cr, ⁵⁷Co, ⁶⁷Ga, ⁸¹Kr, ⁸²Rb, ⁸⁹Sr, ⁹⁹Tc, ¹¹¹In, ¹²³I, ¹²⁵I, ¹³¹I, ¹³³Xe, ¹⁵³Sm, ²⁰¹Tl, or the like. According to a further embodiment, the isotope can include a combination of the above listed isotopes, and the like. Likewise, the particles can include a fluorescent label such that the particle can be identified. Examples of fluorescent labeled particles are shown in FIGS. 45 and 46. FIG. 45 shows a particle that has been fluorescently labeled and is associated with a cell membrane and the particle shown in FIG. 46 is within the cell.

According to further embodiments the particle can include or can be formed into and used as a tag or a taggant. A taggant that can be included in the particle or can be the particle includes, but is not limited to, a fluorescent, radiolabeled, magnetic, biologic, shape specific, size specific, combinations thereof, or the like.

In some embodiments, the particle includes a biodegradable polymer. In other embodiments, the polymer is modified to be a biodegradable polymer (e.g., a poly(ethylene glycol) that is functionalized with a disulfide group). In some embodiments, the biodegradable polymer includes, without limitation, one or more of a polyester, a polyanhydride, a polyamide, a phosphorous-based polymer, a poly(cyanoacrylate), a polyurethane, a polyorthoester, a polydihydropyran, a polyacetal, combinations thereof, or the like.

In some embodiments, the polyester includes, without limitation, one or more of polylactic acid, polyglycolic acid, poly(hydroxybutyrate), poly(ε-caprolactone), poly(β-malic acid), poly(dioxanones), combinations thereof, or the like. In some embodiments, the polyanhydride includes, without limitation, one or more of poly(sebacic acid), poly(adipic acid), poly(terpthalic acid), combinations thereof, or the like. In yet other embodiments, the polyamide includes, without limitation, one or more of poly(imino carbonates), polyaminoacids, combinations thereof, or the like.

According to some embodiments, the phosphorous-based polymer includes, without limitation, one or more of a polyphosphate, a polyphosphonate, a polyphosphazene, combinations thereof, or the like. Further, in some embodiments, the biodegradable polymer further includes a polymer that is responsive to a stimulus. In some embodiments, the stimulus includes, without limitation, one or more of pH, radiation, ionic strength, oxidation, reduction, temperature, an alternating magnetic field, an alternating electric field, combinations thereof, or the like. In some embodiments, the stimulus includes an alternating magnetic field.

According to yet other uses, the particle can be utilized as a physical tag. In such uses, a particle of a predetermined shape can be used as a taggant to identify products or the origin of a product. The particle as a taggant can be either identifiable to a particular shape or a particular chemical composition, in some embodiments.

II.B. Formation of Rounded Particles or Taggants Through “Liquid Reduction”

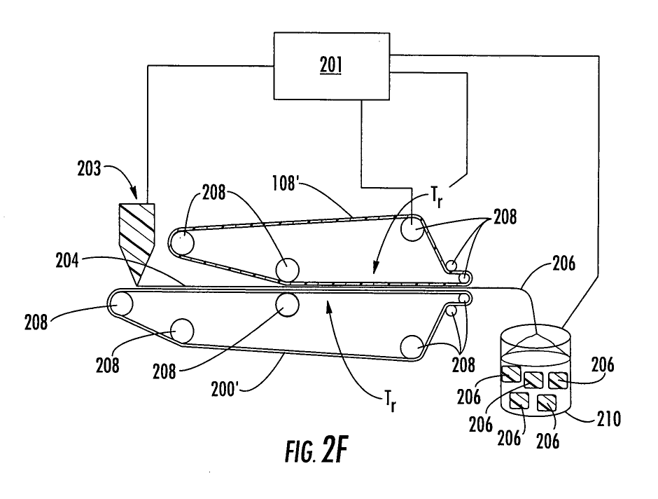

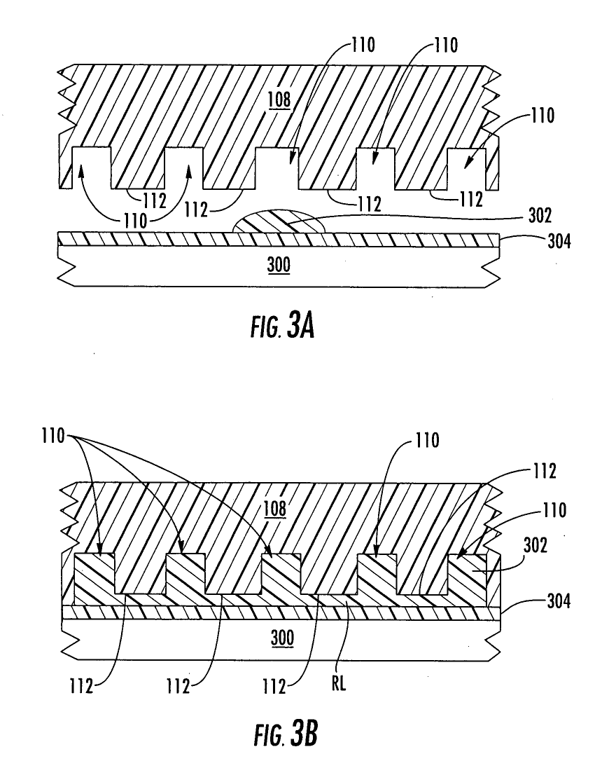

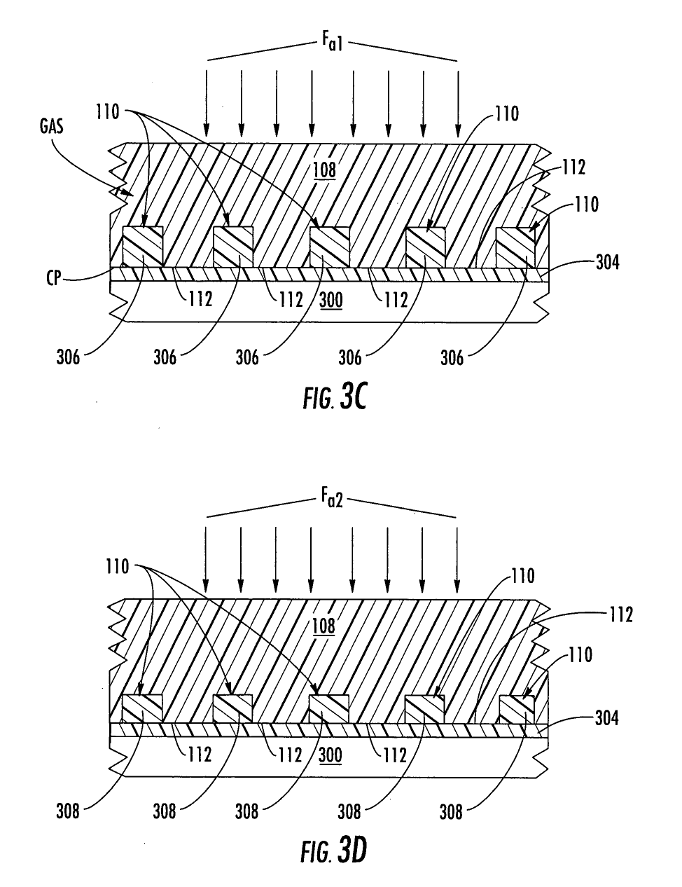

Referring now to FIGS. 3A through 3F, the presently disclosed subject matter provides a “liquid reduction” process for forming particles that have shapes that do not conform to the shape of the template, including but not limited to spherical and non-spherical, regular and non-regular micro- and nanoparticles. For example, a “cube-shaped” template can allow for spherical particles to be made, whereas a “Block arrow-shaped” template can allow for “lolli-pop” shaped particles or objects to be made wherein the introduction of a gas allows surface tension forces to reshape the resident liquid prior to treating it. While not wishing to be bound by any particular theory, the non-wetting characteristics that can be provided in some embodiments of the presently disclosed patterned template and/or treated or coated substrate allows for the generation of rounded, e.g., spherical, particles.

Referring now to FIG. 3A, droplet 302 of a liquid material is disposed on substrate 300, which in some embodiments is coated or treated with a non-wetting material 304. A patterned template 108, which includes a plurality of recessed areas 110 and patterned surface areas 112, also is provided.

Referring now to FIG. 3B, patterned template 108 is contacted with droplet 302. The liquid material including droplet 302 then enters recessed areas 110 of patterned template 108. In some embodiments, a residual, or “scum,” layer RL of the liquid material including droplet 302 remains between the patterned template 108 and substrate 300.

Referring now to FIG. 3C, a first force Fₐ₁ is applied to patterned template 108. A contact point CP is formed between the patterned template 108 and the substrate and displacing residual layer RL. Particles 306 are formed in the recessed areas 110 of patterned template 108.

Referring now to FIG. 3D, a second force Fₐ₂, wherein the force applied by Fₐ₂ is greater than the force applied by Fₐ₁, is then applied to patterned template 108, thereby forming smaller liquid particles 308 inside recessed areas 112 and forcing a portion of the liquid material including droplet 302 out of recessed areas 112.

Referring now to FIG. 3E, the second force Fₐ₂ is released, thereby returning the contact pressure to the original contact pressure applied by first force Fₐ₁. In some embodiments, patterned template 108 includes a gas permeable material, which allows a portion of space with recessed areas 112 to be filled with a gas, such as nitrogen, thereby forming a plurality of liquid spherical droplets 310. Once this liquid reduction is achieved, the plurality of liquid spherical droplets 310 are treated by a treating process Tᵣ.

Referring now to FIG. 3F, treated liquid spherical droplets 310 are released from patterned template 108 to provide a plurality of freestanding spherical particles 312.

II.C. Formation of Small Particles or Taggants Through Evaporation

Referring now to FIGS. 41A through 41E, an embodiment of the presently disclosed subject matter includes a process for forming particles through evaporation. In one embodiment, the process produces a particle having a shape that does not necessarily conform to the shape of the template. The shape can include, but is not limited to, any three dimensional shape. According to some embodiments, the particle forms a spherical or non-spherical and regular or non-regular shaped micro- and nanoparticle. While not wishing to be bound by any particular theory, an example of producing a spherical or substantially spherical particle includes using a patterned template and/or substrate of a non-wetting material or treating the surfaces of the patterned template and substrate particle forming recesses with a non-wetting agent such that the material from which the particle will be formed does not wet the surfaces of the recess. Because the material from which the particle will be formed cannot wet the surfaces of the patterned template and/or substrate the particle material has a greater affinity for itself than the surfaces of the recesses and thereby forms a rounded, curved, or substantially spherical shape.

A non-wetting substance can be defined through the concept of the contact angle (Θ), which can be used quantitatively to measure interaction between any liquid and solid surface. When the contact angle between a drop of liquid on the surface is 90<Θ<180, the surface is considered non-wetting. In general, fluorinated surfaces are non-wetting to aqueous and organic liquids. Fluorinated surfaces can include a fluoropolyether material, a fluoroolefin material, an acrylate material, a silicone material, a styrenic material, a fluorinated thermoplastic elastomer (TPE), a triazine fluoropolymer, a perfluorocyclobutyl material, a fluorinated epoxy resin, and/or a fluorinated monomer or fluorinated oligomer that can be polymerized or crosslinked by a metathesis polymerization reaction, surfaces created by treating a silicon or glass surface with a fluorinated silane, or coating a surface with a fluorinated polymer. Further, surfaces of materials that are typically wettable materials can be made non-wettable by surface treatments. Materials that can be made substantially non-wetting by surface treatments include, but are not limited to, a typical wettable polymer material, an inorganic material, a silicon material, a quartz material, a glass material, combinations thereof, and the like. Surface treatments to make these types of materials non-wetting include, for example, layering the wettable material with a surface layer of the above described non-wetting materials, and techniques of the like that will be appreciated by one of ordinary skill in the art.

Referring now to FIG. 41A, droplet 4102 of a liquid material of the presently disclosed subject matter that is to become the particle is disposed on non-wetting substrate 4100, which in some embodiments is a material or a surface coated or treated with a non-wetting material, as described herein above. A patterned template 4108, which includes a plurality of recessed areas 4110 and patterned surface areas 4112, also is provided.

Referring now to FIG. 41B, patterned template 4108 is contacted with droplet 4102. The liquid material including droplet 4102 then enters recessed areas 4110 of patterned template 4108. According to some embodiments, mechanical or physical manipulation of droplet 4102 and patterned template 4108 is provided to facilitate the droplet 4102 in substantially filling and conforming to recessed areas 4110. Such mechanical and/or physical manipulation can include, but is not limited to, vibration, rotation, centrifugation, pressure differences, a vacuum environment, combinations thereof, or the like. A contact point CP is formed between the patterned surface areas 4112 and the substrate 4100. Particles 4106 are formed in the recessed areas 4110 of patterned template 4108.

Referring now to FIG. 41C, an evaporative process, E, is performed, thereby reducing the volume of liquid particles 4106 inside recessed areas 4110. Examples of an evaporative process E that can be used with the present embodiments include forming patterned template 4108 from a gas permeable material, which allows volatile components of the material to become the particles to pass through the template, thereby reducing the volume of the material to become the particles in the recesses. According to another embodiment, an evaporative process E suitable for use with the presently disclosed subject matter includes providing a portion of the recessed areas 4110 filled with a gas, such as nitrogen, which thereby increases the evaporation rate of the material to become the particles. According to further embodiments, after the recesses are filled with material to become the particles, a space can be left between the patterned template and substrate such that evaporation is enhanced. In yet another embodiment, the combination of the patterned template, substrate, and material to become the particle can be heated or otherwise treated to enhance evaporation of the material to become the particle. Combinations of the above described evaporation processes are encompassed by the presently disclosed subject matter.

Referring now to FIG. 41D, once liquid reduction is achieved, the plurality of liquid droplets 4114 are treated by a treating process Tᵣ. Treating process Tᵣ can be photo curing, thermal curing, phase change, solvent evaporation, crystallization, oxidative/reductive processes, combinations thereof, or the like to solidify the material of droplet 4102.

Referring now to FIG. 41E, patterned template 4108 is separated from substrate 4100 according to methods and techniques described herein. After separation of patterned template 4108 from substrate 4100, treated liquid spherical droplets 4114 are released from patterned template 4108 to provide a plurality of freestanding spherical particles 4116. In some embodiments release of the particles 4116 is facilitated by a solvent, applying a substance to the particles with an affinity for the particles, subjecting the particles to gravitational forces, combinations thereof, and the like.

According to some embodiments the particles are less than about 200 nm in diameter. According to some embodiments the particles are between about 80 nm and 200 nm in diameter. According to some embodiments the particles are between about 100 nm and about 200 nm in diameter.

### III. Formation of Polymeric Nano- to Micro-Electrets

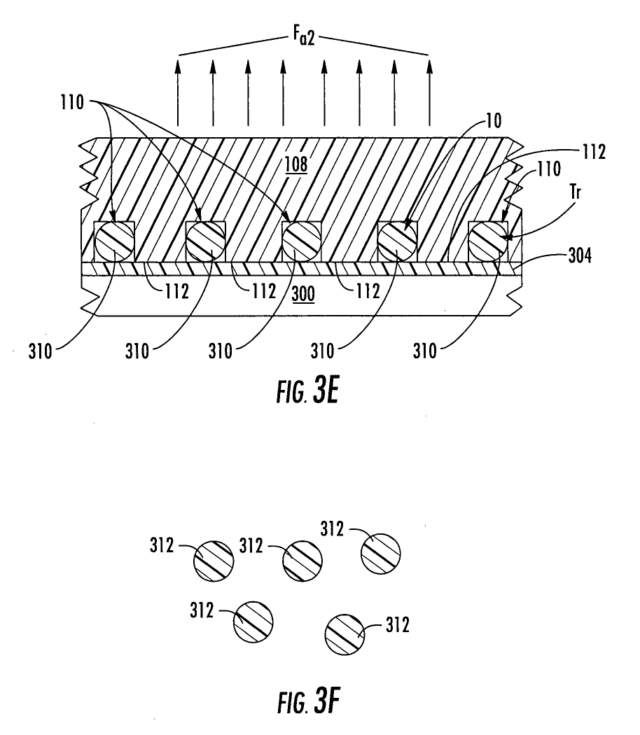

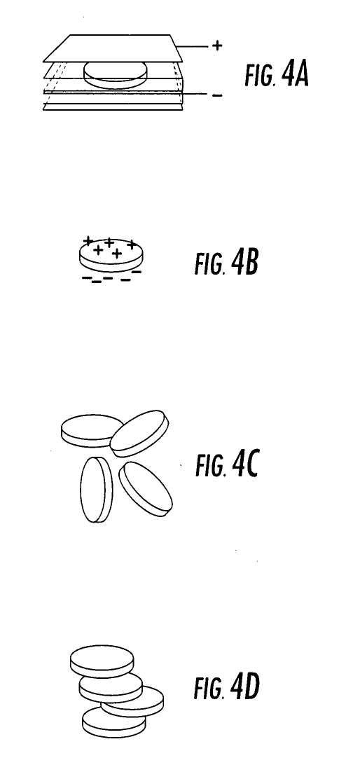

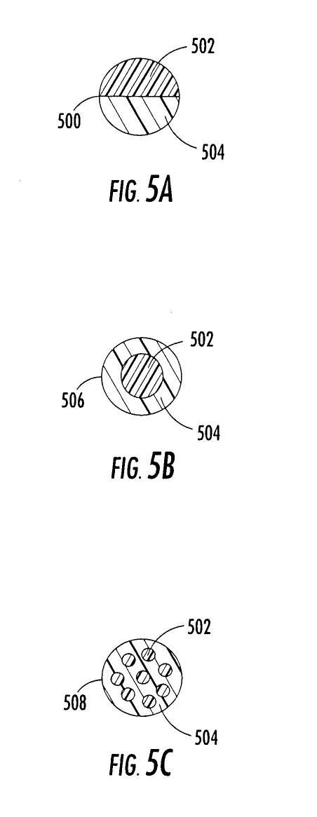

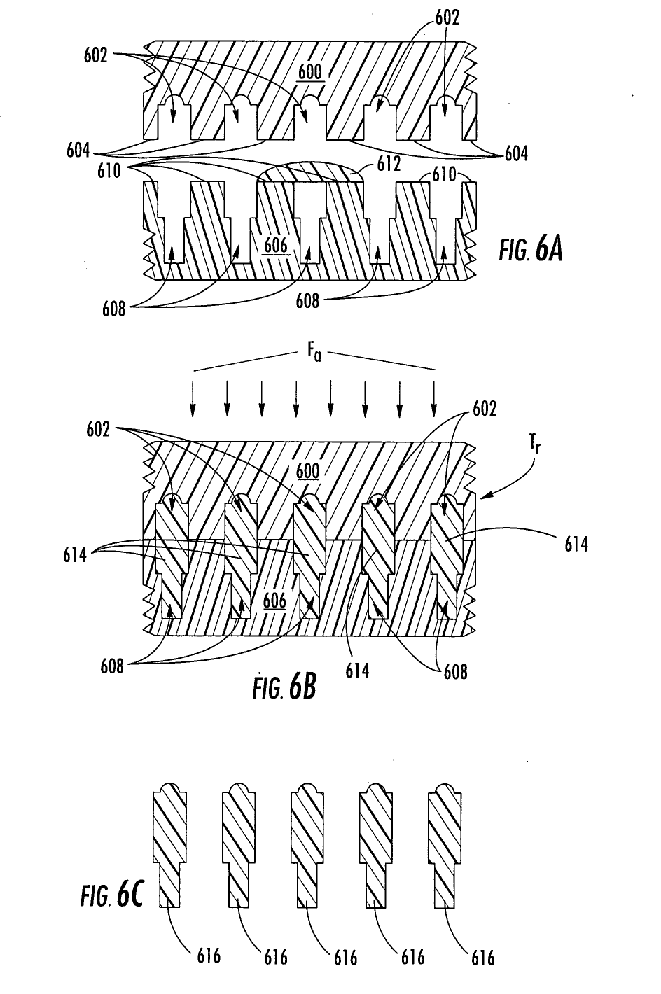

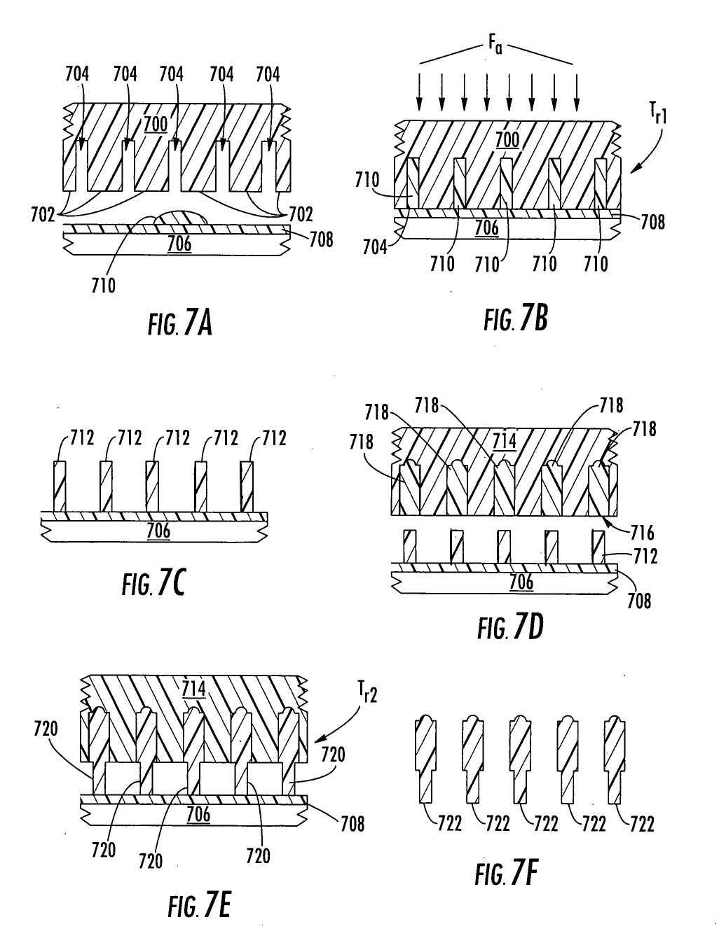

Referring now to FIGS. 4A and 4B, in some embodiments, the presently disclosed subject matter describes a method for preparing polymeric nano- to micro-electrets by applying an electric field during the polymerization and/or crystallization step during molding (FIG. 4A) to yield a charged polymeric particle (FIG. 4B). In some embodiments, the charged polymeric particles spontaneously aggregate into chain-like structures (FIG. 4D) instead of the random configurations shown in FIG. 4C.

In some embodiments, the charged polymeric particle includes a polymeric electret. In some embodiments, the polymeric electret includes a polymeric nano-electret. In some embodiments, the charged polymeric particles aggregate into chain-like structures. In some embodiments, the charged polymeric particles include an additive for an electro-rheological device. In some embodiments, the electro-rheological device is selected from the group including clutches and active dampening devices. In some embodiments, the charged polymeric particles include nano-piezoelectric devices. In some embodiments, the nano-piezoelectric devices are selected from the group including actuators, switches, and mechanical sensors.

### IV. Formation of Multilayer Structures as Taggants

In some embodiments, the presently disclosed subject matter provides a method for forming multilayer structures, including multilayer particles. In some embodiments, the multilayer structures, including multilayer particles, include nanoscale multilayer structures. In some embodiments, multilayer structures are formed by depositing multiple thin layers of immisible liquids and/or solutions onto a substrate and forming particles as described by any of the methods hereinabove. The immiscibility of the liquid can be based on any physical characteristic, including but not limited to density, polarity, and volatility. Examples of possible morphologies of the presently disclosed subject matter are illustrated in FIGS. 5A-5C and include, but are not limited to, multi-phase sandwich structures, core-shell particles, and internal emulsions, microemulsions and/or nano-sized emulsions.

Referring now to FIG. 5A, a multi-phase sandwich structure 500 of the presently disclosed subject matter is shown, which by way of example, includes a first liquid material 502 and a second liquid material 504.

Referring now to FIG. 5B, a core-shell particle 506 of the presently disclosed subject matter is shown, which by way of example, includes a first liquid material 502 and a second liquid material 504.

Referring now to FIG. 5C, an internal emulsion particle 508 of the presently disclosed subject matter is shown, which by way of example, includes a first liquid material 502 and a second liquid material 504.

More particularly, in some embodiments, the method includes disposing a plurality of immiscible liquids between the patterned template and substrate to form a multilayer structure, e.g., a multilayer nanostructure. In some embodiments, the multilayer structure includes a multilayer particle. In some embodiments, the multilayer structure includes a structure selected from the group including multi-phase sandwich structures, core-shell particles, internal emulsions, microemulsions, and nanosized emulsions.

### V. Functionalization of Particles and Taggants

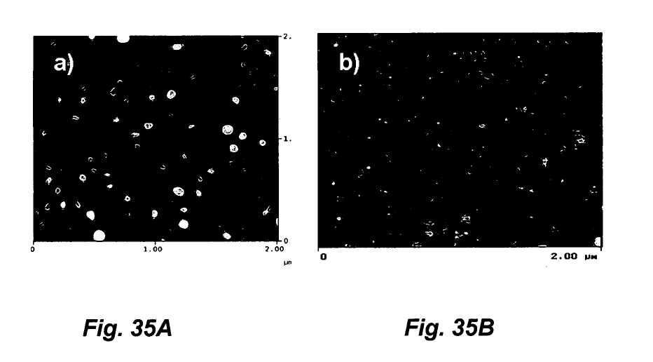

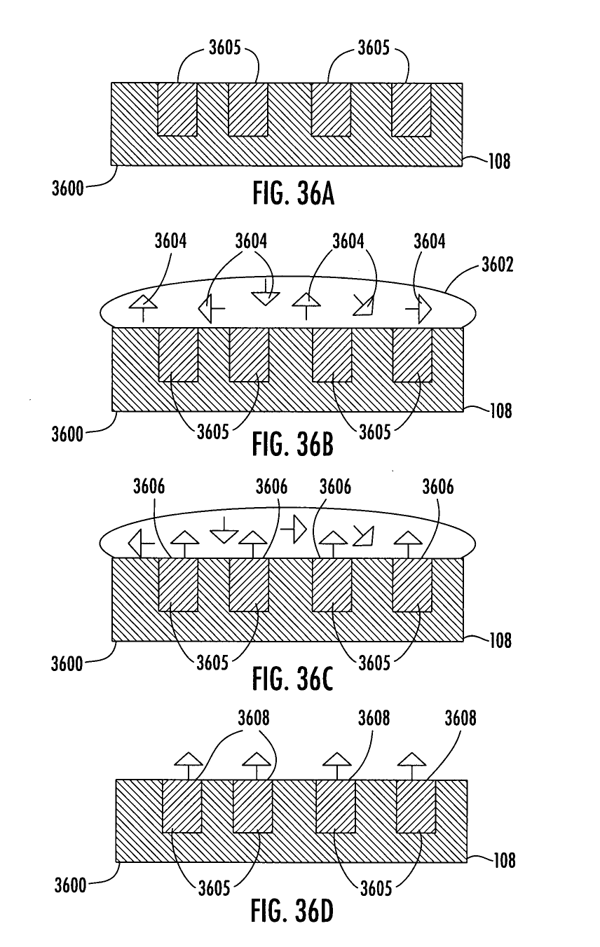

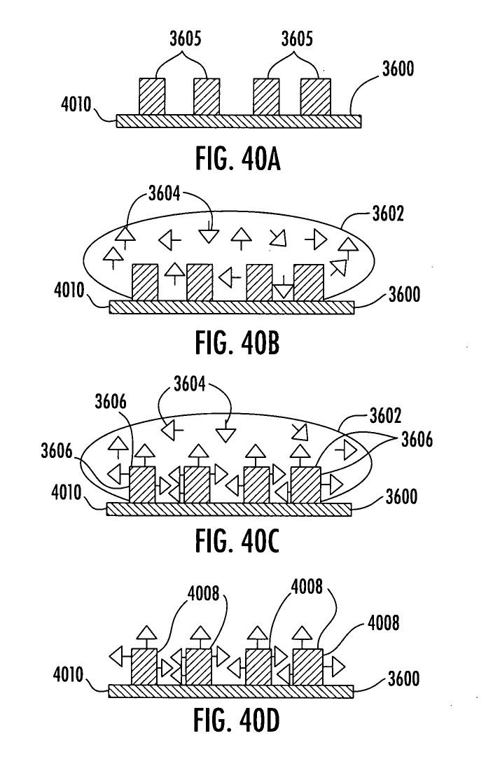

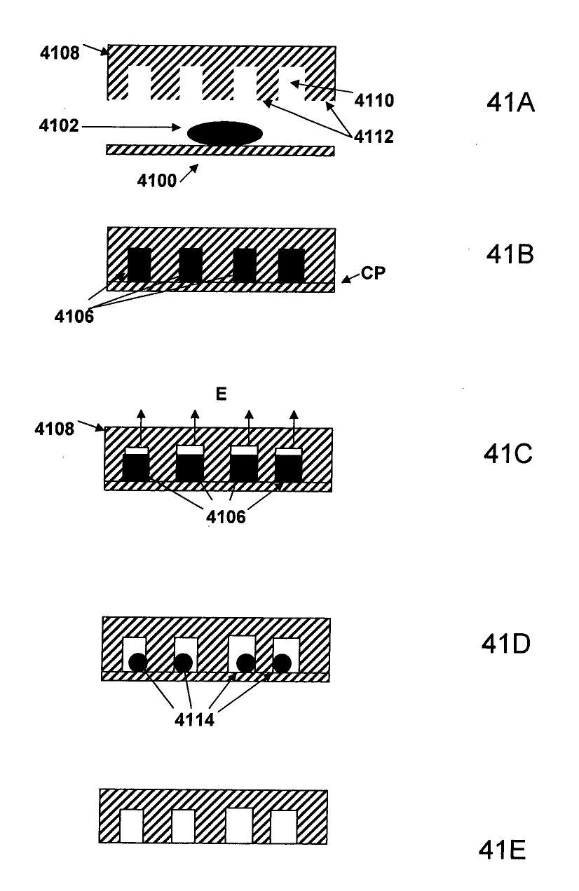

In some embodiments, the presently disclosed subject matter provides a method for functionalizing isolated micro- and/or nanoparticles. In one embodiment, the functionalization includes introducing chemical functional groups to a surface either physically or chemically. In some embodiments, the method of functionalization includes introducing at least one chemical functional group to at least a portion of microparticles and/or nanoparticles. In some embodiments, particles 3605 are at least partially functionalized while particles 3605 are in contact with an article 3600. In one embodiment, the particles 3605 to be functionalized are located within a mold or patterned template 108 (FIGS. 35A-36D). In some embodiments, particles 3605 to be functionalized are attached to a substrate (e.g., substrate 4010 of FIGS. 40A-40D). In some embodiments, at least a portion of the exterior of the particles 3605 can be chemically modified by performing the steps illustrated in FIGS. 36A-36D. In one embodiment, the particles 3605 to be functionalized are located within article 3600 as illustrated in FIGS. 36A and 40A. As illustrated in FIGS. 36A-36D and 40A-40D, some embodiments include contacting an article 3600 containing particles 3605 with a solution 3602 containing a modifying agent 3604.

In one embodiment, illustrated in FIGS. 36C and 40C, modifying agent 3604 attaches (e.g., chemically) to exposed particle surface 3606 by chemically reacting with or physically adsorbing to a linker group on particle surface 3606. In one embodiment, the linker group on particle 3606 is a chemical functional group that can attach to other species via chemical bond formation or physical affinity. In some embodiments, the linker group includes a functional group that includes, without limitation, sulfides, amines, carboxylic acids, acid chlorides, alcohols, alkenes, alkyl halides, isocyanates, compounds disclosed elsewhere herein, combinations thereof, or the like.

In one embodiment, illustrated in FIGS. 36D and 40D, excess solution is removed from article 3600 while particle 3605 remains in contact with article 3600. In some embodiments, excess solution is removed from the surface containing the particles. In some embodiments, excess solution is removed by rinsing with or soaking in a liquid, by applying an air stream, or by physically shaking or scraping the surface. In some embodiments, the modifying agent includes an agent selected from the group including dyes, fluorescent tags, radiolabeled tags, contrast agents, ligands, peptides, pharmaceutical agents, proteins, DNA, RNA, siRNA, compounds and materials disclosed elsewhere herein, combinations thereof, and the like.

In one embodiment, functionalized particles 3608, 4008 are harvested from article 3600 using, for example, methods described herein. In some embodiments, functionalizing and subsequently harvesting particles that reside on an article (e.g., a substrate, a mold or patterned template) have advantages over other methods (e.g., methods in which the particles must be functionalized while in solution). In one embodiment of the presently disclosed subject matter, fewer particles are lost in the process, giving a high product yield. In one embodiment of the presently disclosed subject matter, a more concentrated solution of the modifying agent can be applied in lower volumes. In one embodiment of the presently disclosed subject matter, where particles are functionalized while they remain associated with article 3600 functionalization does not need to occur in a dilute solution. In one embodiment, the use of more concentrated solution facilitates, for example, the use of lower volumes of modifying agent and/or lower times to functionalize. In one embodiment, particles in a tight, 2-dimensional array, but not touching, are susceptible to application of thin, concentrated solutions for faster functionalization. In some embodiments, lower volume/higher concentration modifying agent solutions are useful, for example, in connection with modifying agents that are difficult and expensive to make and handle (e.g., biological agents such as peptides, DNA, or RNA). In some embodiments, functionalizing particles that remain connected to article 3600 eliminates difficult and/or time-consuming steps to remove excess unreacted material (e.g., dialysis, extraction, filtration and column separation). In one embodiment of the presently disclosed subject matter, highly pure functionalized product can be produced at a reduced effort and cost.

### VI. Imprint Lithography

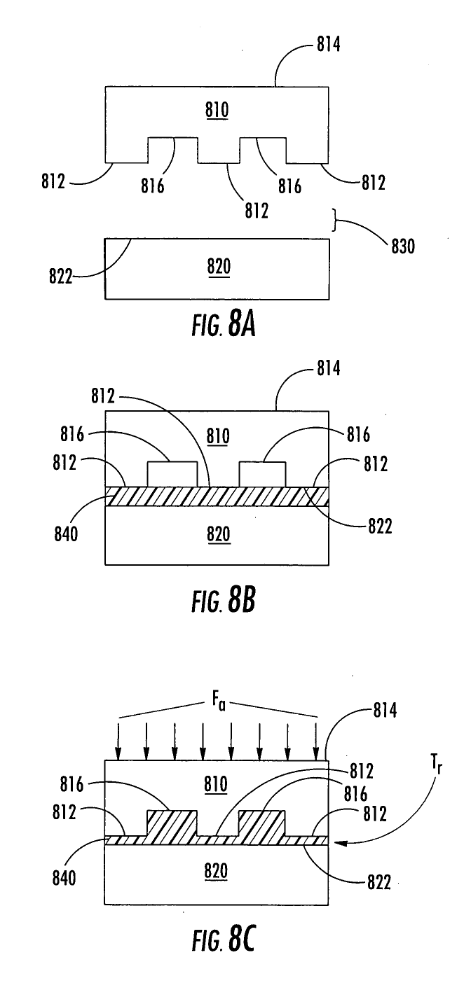

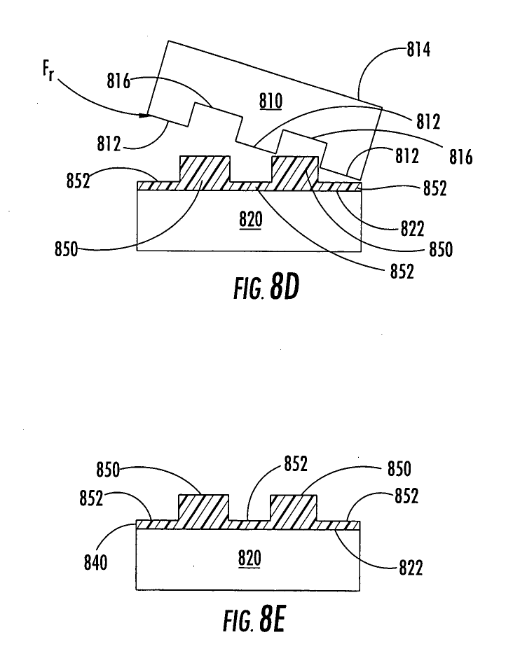

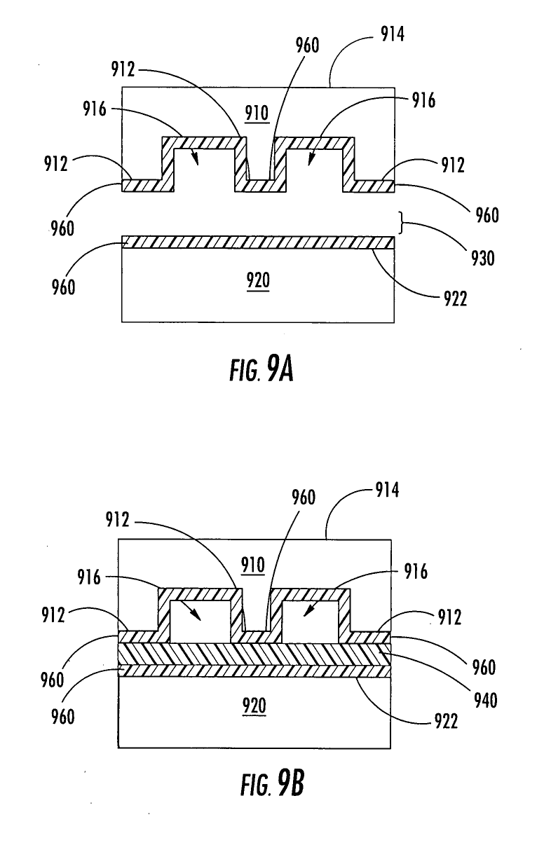

Referring now to FIGS. 8A-8D, a method for forming a pattern on a substrate is illustrated. In the embodiment illustrated in FIG. 8, an imprint lithography technique is used to form a pattern on a substrate.

Referring now to FIG. 8A, a patterned template 810 is provided. In some embodiments, patterned template 810 includes a solvent resistant, low surface energy polymeric material, derived from casting low viscosity liquid materials onto a master template and then curing the low viscosity liquid materials to generate a patterned template as defined hereinabove. Patterned template 810 further includes a first patterned template surface 812 and a second template surface 814. The first patterned template surface 812 further includes a plurality of recesses 816. The patterned template derived from a solvent resistant, low surface energy polymeric material could be mounted on another material to facilitate alignment of the patterned template or to facilitate continuous processing such as a conveyor belt. This might be particularly useful in the fabrication of precisely placed structures on a surface, such as in the fabrication of a complex devices or a semiconductor, electronic or photonic devices.

Referring again to FIG. 8A, a substrate 820 is provided. Substrate 820 includes a substrate surface 822. In some embodiments, substrate 820 is selected from the group including a polymer material, an inorganic material, a silicon material, a quartz material, a glass material, and surface treated variants thereof. In some embodiments, at least one of patterned template 810 and substrate 820 has a surface energy lower than 18 mN/m. In some embodiments, at least one of patterned template 810 and substrate 820 has a surface energy lower than 15 mN/m. According to a further embodiment the patterned template 810 and/or the substrate 820 has a surface energy between about 10 mN/m and about 20 mN/m. According to some embodiments, the patterned template 810 and/or the substrate 820 has a low surface energy of between about 12 mN/m and about 15 mN/m.

In some embodiments, as illustrated in FIG. 8A, patterned template 810 and substrate 820 are positioned in a spaced relationship to each other such that first patterned template surface 812 faces substrate surface 822 and a gap 830 is created between first patterned template surface 812 and substrate surface 822. This is an example of a predetermined relationship.

Referring now to FIG. 8B, a volume of liquid material 840 is disposed in gap 830 between first patterned template surface 812 and substrate surface 822. In some embodiments, the volume of liquid material 840 is disposed directed on a non-wetting agent (not shown), which is disposed on first patterned template surface 812.

Referring now to FIG. 8C, in some embodiments, first patterned template 812 is contacted with the volume of liquid material 840. A force Fₐ is applied to second template surface 814 thereby forcing the volume of liquid material 840 into the plurality of recesses 816. In some embodiments, as illustrated in FIG. 8C, a portion of the volume of liquid material 840 remains between first patterned template surface 812 and substrate surface 820 after force Fₐ is applied.

Referring again to FIG. 8C, in some embodiments, the volume of liquid material 840 is treated by a treating process Tᵣ while force Fₐ is being applied to form a treated liquid material 842. In some embodiments, treating process Tᵣ includes a process selected from the group including a thermal process, a photochemical process, and a chemical process.

Referring now to FIG. 8D, a force Fᵣ is applied to patterned template 810 to remove patterned template 810 from treated liquid material 842 to reveal a pattern 850 on substrate 820 as shown in FIG. 8E. In some embodiments, a residual, or “scum,” layer 852 of treated liquid material 842 remains on substrate 820.

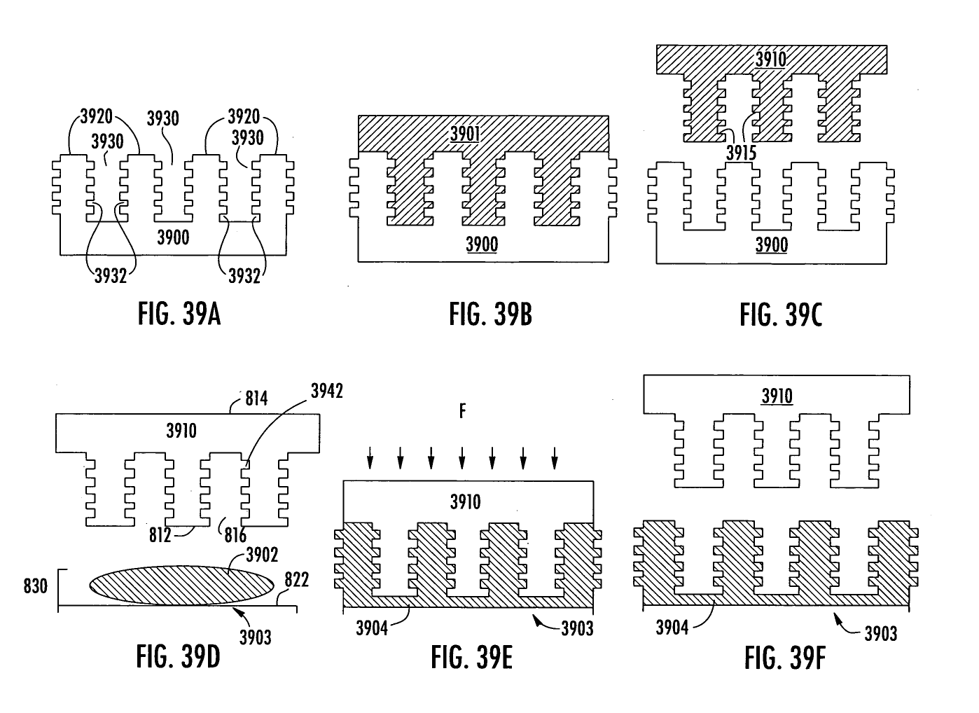

Referring now to FIGS. 39A-39F, one embodiment of a method for forming a complex pattern on a substrate is illustrated. Referring now to FIG. 39A, a patterned master 3900 is provided. Patterned master 3900 includes a plurality of non-recessed surface 3920 areas and a plurality of recesses 3930. In some embodiments, recesses 3930 include one or more sub-recesses 3932. In some embodiments, recesses 3930 include a multiplicity of sub-recesses 3932 or structural features. In some embodiments, patterned master 3900 includes an etched substrate, such as a silicon wafer, which is etched in the desired pattern to form patterned master 3900.

Referring now to FIG. 39B, a flowable material 3901, for example, a liquid fluoropolymer composition, such as a PFPE-based precursor, is poured onto patterned master 3900. In some embodiments, flowable material 3901 is treated by a treating process, for example exposure to UV light, thereby forming a treated material mold 3910 in the desired pattern.

In one embodiment, illustrated in FIG. 39C, mold 3910 is removed from patterned master 3900. In one embodiment, treated material mold 3910 is a cross-linked polymer. In one embodiment, treated material mold 3910 is an elastomer. In one embodiment, a force is applied to one or more of mold 3910 or patterned master 3900 to separate mold 3910 from patterned master 3900. FIG. 39C illustrates one embodiment of mold 3910 and patterned master 3900 wherein mold 3910 includes a plurality of recesses and sub-recesses which are mirror images of the plurality of non-recessed surface areas of patterned master 3900. In one embodiment of mold 3910 the plurality of non-recessed areas elastically deform to facilitate removal of mold 3910 from master 3900. Mold 3910, in one embodiment, is a useful patterned template for soft lithography and imprint lithography applications.

Referring now to FIG. 39D, a mold 3910 is provided. In some embodiments, mold 3910 includes a solvent resistant, low surface energy polymeric material, derived from casting low viscosity liquid materials onto a master template and then curing the low viscosity liquid materials to generate a patterned template as defined hereinabove. Mold 3910 further includes a first patterned template surface 812 and a second template surface 814. The first patterned template surface 812 further includes a plurality of recesses 816 and subrecesses 3932. In one embodiment, multiple layers of subrecesses 3932 form sub-sub-recesses and so on. In some embodiments, mold 3910 is derived from a solvent resistant, low surface energy polymeric material and is mounted on another material to facilitate alignment of the mold or to facilitate continuous processing, such as a continuous process using a conveyor belt. In one embodiment, such continuous processing is useful in the fabrication of precisely placed structures on a surface, such as in the fabrication of a complex device or a semiconductor, electronic or photonic device.

In some embodiments, the plurality of sub-recesses 3932 or structural features has a dimension ranging from about 10 microns to about 1 nanometer in size. In some embodiments, the plurality of structural features has a dimension ranging from about 10 microns to about 1 micron in size. In some embodiments, the plurality of structural features has a dimension ranging from about 1 micron to about 100 nm in size. In some embodiments, the plurality of structural features has a dimension ranging from about 100 nm to about 1 nm in size. In some embodiments, the plurality of structural features has a dimension in both the horizontal and vertical plane.

Referring again to FIG. 39D, a substrate 3903 is provided. In some embodiments, substrate 3903 includes, without limitation, one or more of a polymer material, an inorganic material, a silicon material, a quartz material, a glass material, and surface treated variants thereof. In some embodiments, at least one of mold 3910 and substrate 3903 has a surface energy lower than 18 mN/m. In some embodiments, at least one of mold 3910 and substrate 3903 has a surface energy lower than 15 mN/m. According to a further embodiment the mold 3910 and/or the substrate 3903 has a surface energy between about 10 mN/m and about 20 mN/m. According to some embodiments, the mold 3910 and/or the substrate 3903 has a low surface energy of between about 12 mN/m and about 15 mN/m. According to some embodiments, the mold 3910 and/or the substrate 3903 has a low surface energy of less than about 12 mN/m.

In some embodiments, as illustrated in FIG. 39D, mold 3910 and substrate 3903 are positioned in a spaced relationship to each other such that first patterned template surface 812 faces substrate surface 822 and a gap 830 is created between first patterned template surface 812 and the substrate surface 822. This is merely one example of a predetermined relationship.

Referring again to FIG. 39D, a volume of liquid material 3902 is disposed in the gap between first patterned template surface 812 and substrate surface 822. In some embodiments, the volume of liquid material 3902 is disposed directly on a non-wetting agent (not shown), which is disposed on first patterned template surface 812.

Referring now to FIG. 39E, in some embodiments, mold 3910 is contacted with the volume of liquid material 3902 (not shown in FIG. 39E). A force F is applied to the mold 3910 thereby forcing the volume of liquid material 3902 into the plurality of recesses 816 and sub-recesses. In some embodiments, such as was illustrated in FIG. 8C, a portion of the volume of liquid material 3902 remains between mold 3910 and substrate 3903 surface after force F is applied.

Referring again to FIG. 39E, in some embodiments, the volume of liquid material 3902 is treated by a treating process while force F is being applied to form a product 3904. In some embodiments, the treating process includes, without limitation, one or more of a photochemical process, a chemical process, combinations thereof, or the like.

Referring now to FIG. 39F, mold 3910 is removed from product 3904 to reveal a patterned product on substrate 3903 as shown in FIG. 39F. In some embodiments, a residual, or “scum,” layer (not shown) of treated liquid material remains on substrate 3903.

In some embodiments, the liquid material from which the particles will be formed is selected from the group including a polymer, a solution, a monomer, a plurality of monomers, a polymerization initiator, a polymerization catalyst, an inorganic precursor, an organic material, a natural product, a metal precursor, a pharmaceutical agent, a tag, a magnetic material, a paramagnetic material, a superparamagnetic material, a ligand, a cell penetrating peptide, a porogen, a surfactant, a plurality of immiscible liquids, a solvent, a pharmaceutical agent with a binder, and a charged species. In some embodiments, the pharmaceutical agent is selected from the group including a drug, a peptide, RNAi, and DNA. In some embodiments, the tag is selected from the group including a fluorescence tag, a radiolabeled tag, and a contrast agent. In some embodiments, the ligand includes a cell targeting peptide.

Representative superparamagnetic or paramagnetic materials include but are not limited to Fe₂O₃, Fe₃O₄, FePt, Co, MnFe₂O₄, CoFe₂O₄, CuFe₂O₄, NiFe₂O₄ and ZnS doped with Mn for magneto-optical applications, CdSe for optical applications, and borates for boron neutron capture treatment.

In some embodiments, the liquid material is selected from one of a resist polymer and a low-k dielectric. In some embodiments, the liquid material includes a non-wetting agent.

In some embodiments, the contacting of the first template surface with the substrate eliminates essentially all of the disposed volume of liquid material.

In some embodiments, the treating of the liquid includes, without limitation, one or more of a thermal process, a photochemical process, a chemical process, an evaporative process, a phase change, an oxidative process, a reductive process, combinations thereof, or the like.

In some embodiments, the method includes a batch process. In some embodiments, the batch process is selected from one of a semi-batch process and a continuous batch process.

In some embodiments, the presently disclosed subject matter describes a patterned substrate formed by the presently disclosed methods.

### VII. Imprint Lithography Free of a Residual “Scum Layer”

A characteristic of imprint lithography that has restrained its full potential is the formation of a “scum layer” once the liquid material, e.g., a resin, is patterned. The “scum layer” includes residual liquid material that remains between the stamp and the substrate. In some embodiments, the presently disclosed subject matter provides a process for generating patterns essentially free of a scum layer.

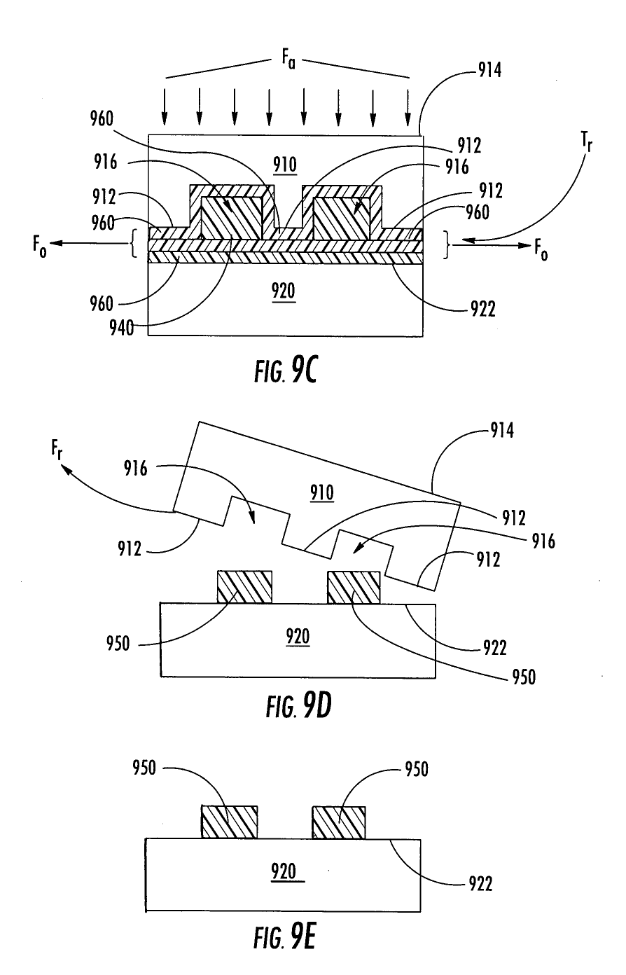

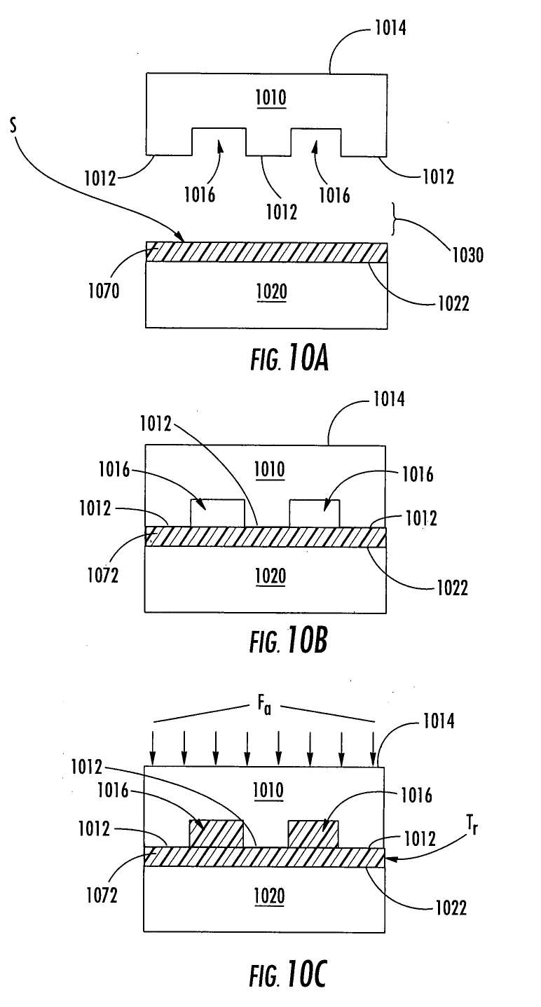

Referring now to FIGS. 9A-9E, in some embodiments, a method for forming a pattern on a substrate is provided, wherein the pattern is essentially free of a scum layer. Referring now to FIG. 9A, a patterned template 910 is provided. Patterned template 910 further includes a first patterned template surface 912 and a second template surface 914. The first patterned template surface 912 further includes a plurality of recesses 916. In some embodiments, a non-wetting agent 960 is disposed on the first patterned template surface 912.

Referring again to FIG. 9A, a substrate 920 is provided. Substrate 920 includes a substrate surface 922. In some embodiments, a non-wetting agent 960 is disposed on substrate surface 920.

In some embodiments, as illustrated in FIG. 9A, patterned template 910 and substrate 920 are positioned in a spaced relationship to each other such that first patterned template surface 912 faces substrate surface 922 and a gap 930 is created between first patterned template surface 912 and substrate surface 922.

Referring now to FIG. 9B, a volume of liquid material 940 is disposed in the gap 930 between first patterned template surface 912 and substrate surface 922. In some embodiments, the volume of liquid material 940 is disposed directly on first patterned template surface 912. In some embodiments, the volume of liquid material 940 is disposed directly on non-wetting agent 960, which is disposed on first patterned template surface 912. In some embodiments, the volume of liquid material 940 is disposed directly on substrate surface 920. In some embodiments, the volume of liquid material 940 is disposed directly on non-wetting agent 960, which is disposed on substrate surface 920.

Referring now to FIG. 9C, in some embodiments, first patterned template surface 912 is contacted with the volume of liquid material 940. A force Fₐ is applied to second template surface 914 thereby forcing the volume of liquid material 940 into the plurality of recesses 916. In contrast with the embodiment illustrated in FIG. 8, a portion of the volume of liquid material 940 is forced out of gap 930 by force Fₒ when force Fₐ is applied.

Referring again to FIG. 9C, in some embodiments, the volume of liquid material 940 is treated by a treating process Tᵣ while force Fₐ is being applied to form a treated liquid material 942.

Referring now to FIG. 9D, a force Fᵣ is applied to patterned template 910 to remove patterned template 910 from treated liquid material 942 to reveal a pattern 950 on substrate 920 as shown in FIG. 9E. In this embodiment, substrate 920 is essentially free of a residual, or “scum,” layer of treated liquid material 942.

In some embodiments, at least one of the template surface and substrate includes a functionalized surface element. In some embodiments, the functionalized surface element is functionalized with a non-wetting material. In some embodiments, the non-wetting material includes functional groups that bind to the liquid material. In some embodiments, the non-wetting material is a trichloro silane, a trialkoxy silane, a trichloro silane including non-wetting and reactive functional groups, a trialkoxy silane including non-wetting and reactive functional groups, and/or mixtures thereof.

In some embodiments, the point of contact between the two surface elements is free of liquid material. In some embodiments, the point of contact between the two surface elements includes residual liquid material. In some embodiments, the height of the residual liquid material is less than 30% of the height of the structure. In some embodiments, the height of the residual liquid material is less than 20% of the height of the structure. In some embodiments, the height of the residual liquid material is less than 10% of the height of the structure. In some embodiments, the height of the residual liquid material is less than 5% of the height of the structure. In some embodiments, the volume of liquid material is less than the volume of the patterned template. In some embodiments, substantially all of the volume of liquid material is confined to the patterned template of at least one of the surface elements. In some embodiments, having the point of contact between the two surface elements free of liquid material retards slippage between the two surface elements.

### VIII. Solvent-Assisted Micro-Molding (SAMIM)

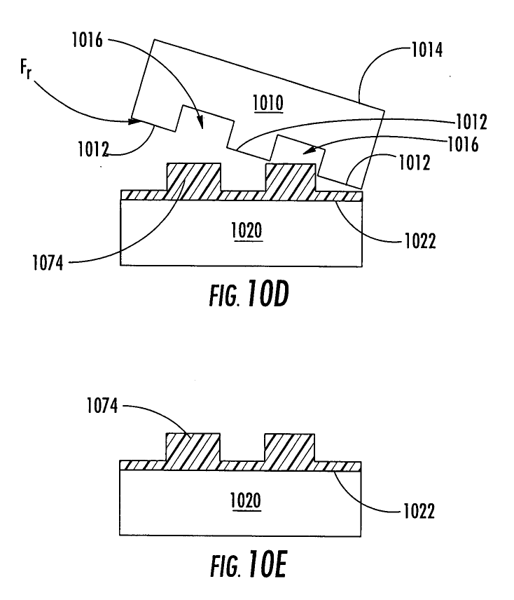

In some embodiments, the presently disclosed subject matter describes a solvent-assisted micro-molding (SAMIM) method for forming a pattern on a substrate. Referring now to FIG. 10A, a patterned template 1010 is provided. Patterned template 1010 further includes a first patterned template surface 1012 and a second template surface 1014. The first patterned template surface 1012 further includes a plurality of recesses 1016.

Referring again to FIG. 10A, a substrate 1020 is provided. Substrate 1020 includes a substrate surface 1022. In some embodiments, a polymeric material 1070 is disposed on substrate surface 1022. In some embodiments, polymeric material 1070 includes a resist polymer.

Referring again to FIG. 10A, patterned template 1010 and substrate 1020 are positioned in a spaced relationship to each other such that first patterned template surface 1012 faces substrate surface 1022 and a gap 1030 is created between first patterned template surface 1012 and substrate surface 1022. As shown in FIG. 10A, a solvent S is disposed within gap 1030, such that solvent S contacts polymeric material 1070 forming a swollen polymeric material 1072.

Referring now to FIGS. 10B and 10C, first patterned template surface 1012 is contacted with swollen polymeric material 1072. A force Fₐ is applied to second template surface 1014 thereby forcing a portion of swollen polymeric material 1072 into the plurality of recesses 1016 and leaving a portion of swollen polymeric material 1072 between first patterned template surface 1012 and substrate surface 1020. The swollen polymeric material 1072 is then treated by a treating process Tᵣ while under pressure.

Referring now to FIG. 10D, a force Fᵣ is applied to patterned template 1010 to remove patterned template 1010 from treated swollen polymeric material 1072 to reveal a polymeric pattern 1074 on substrate 1020 as shown in FIG. 10E.

IX. Removing the Patterned Structure or Taggant from the Patterned Template and/or Substrate

In some embodiments, the patterned structure (e.g., a patterned micro- or nanostructure) is removed from at least one of the patterned template and/or the substrate. This can be accomplished by a number of approaches, including but not limited to applying the surface element containing the patterned structure to a surface that has an affinity for the patterned structure; applying the surface element containing the patterned structure to a material that when hardened has a chemical and/or physical interaction with the patterned structure; deforming the surface element containing the patterned structure such that the patterned structure is released from the surface element; swelling the surface element containing the patterned structure with a first solvent to extrude the patterned structure; and washing the surface element containing the patterned structure with a second solvent that has an affinity for the patterned structure.

In some embodiments, the surface that has an affinity for the particles includes an adhesive or sticky surface (e.g. carbohydrates, epoxies, waxes, polyvinyl alcohol, polyvinyl pyrrolidone, polybutyl acrylate, polycyano acrylates, polymethyl methacrylate). In some embodiments, the liquid is water that is cooled to form ice. In some embodiments, the water is cooled to a temperature below the Tm of water but above the Tg of the particle. In some embodiments the water is cooled to a temperature below the Tg of the particles but above the Tg of the mold or substrate. In some embodiments, the water is cooled to a temperature below the Tg of the mold or substrate.

In some embodiments, the first solvent includes supercritical fluid carbon dioxide. In some embodiments, the first solvent includes water. In some embodiments, the first solvent includes an aqueous solution including water and a detergent. In embodiments, the deforming the surface element is performed by applying a mechanical force to the surface element. In some embodiments, the method of removing the patterned structure further includes a sonication method.

### X. Open Molding Techniques

According to some embodiments, the particles or taggants described herein are formed in an open mold. Open molding can reduce the number of steps and sequences of events required during molding of particles and can improve the evaporation rate of solvent from the particle precursor material, thereby, increasing the efficiency and rate of particle production.

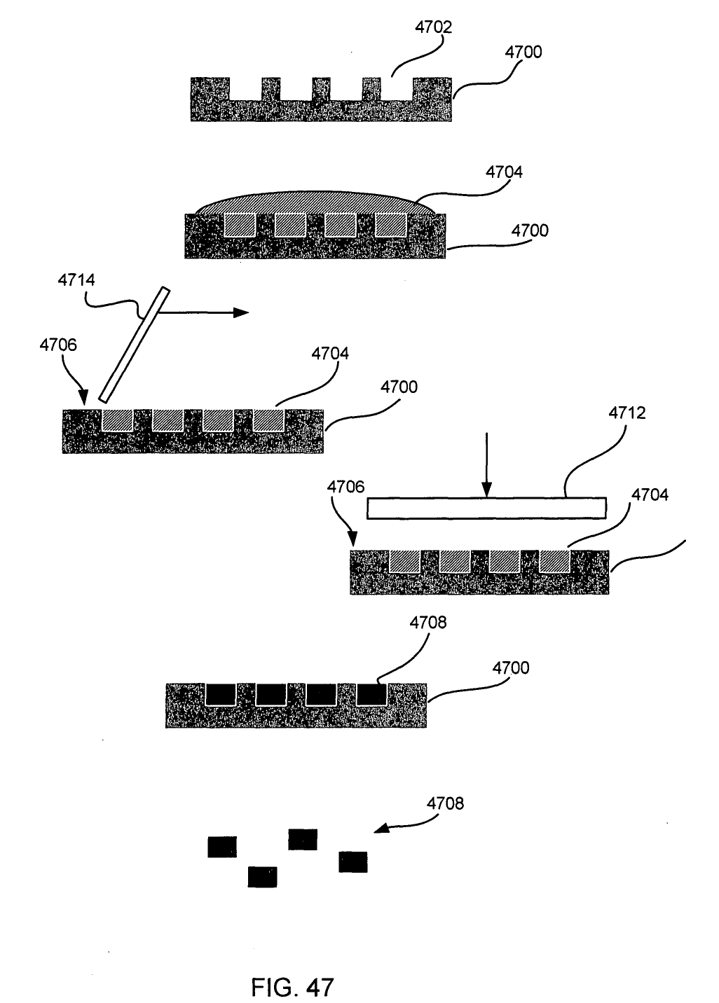

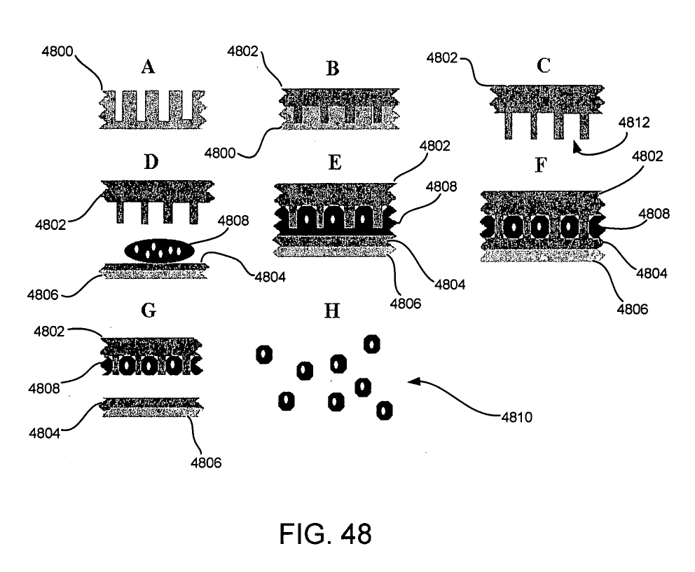

Referring to FIG. 47, surface or template 4700 includes cavities or recesses 4702 formed therein. A substance 4704, which can be, but is not limited to a liquid, a powder, a paste, a gel, a liquified solid, combinations thereof, and the like, is then deposited on surface 4700. The substance 4704 is introduced into recesses 4702 of surface 4700 and excess substance remaining on surface 4700 is removed 4706. Excess substance 4704 can be removed from the surface by, but is not limited to, doctor blading, applying pressure with a substrate, electrostatics, magnetics, gravitational forces, air pressure, combinations thereof, and the like. Next, substance 4704 remaining in recesses 4702 is hardened into particles 4708 by, but is not limited to, photocuring, thermal curing, solvent evaporation, oxidation or reductive polymerization, change of temperature, combinations thereof, and the like. After substance 4704 is hardened, the particles 4708 are harvested from recesses 4702.

According to some embodiments, surface 4700 is configured such that particle fabrication is accomplished in high throughput. In some embodiments, the surface is configured, for example, planer, cylindrical, spherical, curved, linear, a convery belt type arrangement, a gravure printing type arrangement (such as described in U.S. Pat. Nos. 4,557,195 and 4,905,594, all of which are incorporated herein by reference in their entirity), in large sheet arrangements, in multi-layered sheet arrangements, combinations thereof, and the like. According to such embodiments some recesses in the surface can be in a stage of being filled with substance while at another station of the surface excess substance is being removed. Meanwhile, yet another station of the surface can be hardening the substance and still another station being responsible for harvesting the particles from the recesses. In such embodiments, particles are fabricated effeciently and effectively in high throughput. In some embodiments the method and system are continuous, in other embodiments the method and system are batch, and in some embodiments the method and system are a combination of continuous and batch.

The composition of surface 4700 itself can be fabricated from any material that is chemically, physically, and commercially viable for a particular process to be carried out. According to some embodiments, the material for fabrication of surface 4700 is any of the materials described herein. More particularly, the material of surface 4700 is any material that has a low surface energy, is non-wettable, highly chemically inert, a solvent resistant low surface energy polymeric material, a solvent resistant elastomeric material, combinations thereof, and the like. Even more particularly, the material from which surface 4700 is fabricated is a perfluoropolyether material, a silicone material, a fluoroolefin material, an acrylate material, a silicone material, a styrenic material, a fluorinated thermoplastic elastomer (TPE), a triazine fluoropolymer, a perfluorocyclobutyl material, a fluorinated epoxy resin, a fluorinated monomer or fluorinated oligomer that can be polymerized or crosslinked by a metathesis polymerization reaction, combinations thereof, and the like.

According to some embodiments, recesses 4702 in surface 4700 are recesses of particular shapes and sizes. Recesses 4702 can be, but are not limited to, regular shaped, irregular shaped, variable shaped, and the like. In some embodiments, recesses 4702 are, but are not limited to, arched recesses, recesses with right angles, tapered recesses, diamond shaped, spherical, rectangle, triangle, polymorphic, molecular shaped, protein shaped, combinations thereof, and the like. In some embodiments, recesses 4702 can be electrically and/or chemically charged such that functional monomers within substance 4704 are attracted and/or repelled, thereby resulting in a functional particle as described elsewhere herein. According to some embodiments, recess 4704 is less than about 1 mm in a dimension. According to some embodiments, the recess is less than about 1 mm in its largest cross-sectional dimension. In other embodiments the recess includes a dimension that is between about 20 nm and about 1 mm. In other embodiments, the recess is between about 20 nm and about 500 micron in a dimension and/or in a largest dimension. More particularly, the recess is between about 50 nm and about 250 micron in a dimension and/or in a largest dimension.

According to embodiments of the present invention, any of the substances disclosed herein, for example, a drug, DNA, RNA, a biological molecule, a super absorptive material, combinations thereof, and the like can be substance 4704 that is deposited into recesses 4702 and molded into a particle. According to still further embodiments, substance 4704 to be molded is, but is not limited to, a polymer, a solution, a monomer, a plurality of monomers, a polymerization initiator, a polymerization catalyst, an inorganic precursor, a metal precursor, a pharmaceutical agent, a tag, a magnetic material, a paramagnetic material, a ligand, a cell penetrating peptide, a porogen, a surfactant, a plurality of immiscible liquids, a solvent, a charged species, combinations thereof, and the like. In still further embodiments, particle 4708 is, but is not limited to, organic polymers, charged particles, polymer electrets (poly(vinylidene fluoride), Teflon-fluorinated ethylene propylene, polytetrafluoroethylene), therapeutic agents, drugs, non-viral gene vectors, RNAi, viral particles, polymorphs, combinations thereof, and the like.

According to embodiments of the invention, substance 4704 to be molded into particles 4708 is deposited onto template surface 4700. In some embodiments substance 4704 is in a liquid form and therefore flows into recesses 4702 of surface 4700. According to other embodiments, substance 4704 takes on another physical form, such as for example, a powder, a gel, a paste, or the like, such that a force can be required to ensure substance 4704 becomes introduced into recesses 4702. Such a force that can be useful in introducing substance 4704 into recesses 4702 can be, but is not limited to, vibration, centrifugal, electrostatic, magnetic, electromagnetic, gravity, compression, combinations thereof, and the like. The force can also be utilized in embodiments where substance 4704 is a liquid to further ensure substance 4704 enters into recesses 4702.

Following introduction of substance 4704 onto template surface 4700 and recesses 4702 thereof, excess substance is removed from surface 4700 in some embodiments. Removal of excess substance 4704 can be accomplished by engaging surface 4700 with a second surface 4712 such that the excess substance is squeezed out. Second surface 4712 can be, but is not limited to, a flat surface, an arched surface, and the like. In some embodiments second surface 4712 is brought into contact with template surface 4700. According to other embodiments second surface 4712 is brought within a predetermine distance of template surface 4700. According to some embodiments, second surface 4712 is positioned with respect to template surface 4700 normal to the plane of template surface 4700. According to other embodiments second surface 4712 engages template surface 4700 with a predetermined contact angle. According to still further embodiments, second surface 4712 can be an arched surface, such as a cylinder, and can be rolled with respect to template surface 4700 to remove excess substance. According to yet further embodiments, second surface 4712 is composed of a composition that repels or attracts the excess substance, such as for example, a non-wetting substance, a hydrophobic surface repelling a hydrophilic substance, and the like.

According to other embodiments, excess substance 4704 can be removed from template surface 4700 by doctor blading, or otherwise passing a blade across template surface 4700. According to some embodiments, blade 4714 is composed of a metal, rubber, polymer, silicon based material, glass, hydrophobic substance, hydrophilic substance, combinations thereof, and the like. In some embodiments blade 4714 is positioned to contact surface 4700 and wipe away excess substance. In other embodiments, blade 4714 is positioned a predetermined distance from surface 4700 and drawn across surface 4700 to remove excess substance from template surface 4700. The distance blade 4714 is positioned from surface 4700 and the rate at which blade 4714 is drawn across surface 4700 are variable and determined by the material properties of blade 4714, template surface 4700, substance 4704 to be molded, combinations thereof, and the like. Doctor blading and similar techniques are disclosed in Lee et al., Two-Polymer Microtransfer Molding for Highly Layered Microstructures, Adv. Mater. 2005, 17, 2481-2485, which is incorporated herein by reference in its entirity.

Substance 4704 in recesses 4702 is then treated to form particles 4708. The treating of substance 4704 can be achieved by any of the methods described herein, such as curing, solidifying, hardening, evaporation, heating, actinic radiation, combinations thereof, or the like. According to some embodiments the hardening is accomplished by, but is not limited to, solvent evaporation, photo curing, thermal curing, cooling, combinations thereof, and the like.

After substance 4704 has been hardened, particles 4708 are harvested from recesses 4702. According to some embodiments particle 4708 is harvested by contacting particle 4708 with an article that has affinity for particles 4708 that is greater than the affinity between particle 4708 and recess 4702. By way of example, but not limitation, particle 4708 is harvested by contacting particle 4708 with an adhesive substance that adheres to particle 4708 with greater affinity than affinity between particle 4708 and template recess 4702. According to some embodiments, the harvesting substance is, but is not limited to, water, organic solvents, carbohydrates, epoxies, waxes, polyvinyl alcohol, polyvinyl pyrrolidone, polybutyl acrylate, polycyano acrylates, polymethyl methacrylate, combinations thereof, and the like. According to still further embodiments substance 4704 in recesses 4702 forms a porous particle by solvent casting.

According to other embodiments, particles 4708 are harvested by subjecting the particle/recess combination and/or template surface to a physical force or energy such that particles 4708 are released from the recess 4702. In some embodiments the force is, but is not limited to, centrifugation, dissolution, vibration, ultrasonics, megasonics, gravity, flexure of the template, suction, electrostatic attraction, electrostatic repulsion, magnetism, physical template manipulation, combinations thereof, and the like.

According to some embodiments, particles 4708 are purified after being harvested. In some embodiments particles 4708 are purified from the harvesting substance. The harvesting can be, but is not limited to, centrifugation, separation, vibration, gravity, dialysis, filtering, sieving, electrophoresis, gas stream, magnetism, electrostatic separation, combinations thereof, and the like.

### XI. Taggants

In some embodiments the invention relates to formulations comprising a taggant, articles marked with a taggant, and methods for detecting a taggant. Generally, taggants incorporate a unique “mark”, or group of “marks” in or on the article that is invisible to an end user of the article, virtually incapable of being counterfeited, cannot be removed from the article without destroying or altering the taggant and/or the article, harmless to the article or its end-user, identifies an indication of use, designates a source of origin of the article, or the like. In some embodiments, the taggant comprises a plurality of micro- or nanoparticles, fabricated in accord with the materials and methods disclosed herein, and have a defined shape, size, composition, material, or the like. In other embodiments, micro- or nanoparticles disclosed herein can include substances that act as a taggant. In still other embodiments, the taggant can include a bar code or similar code with up to millions of letter, number, shape, or the like, combinations that make identification of the taggant unique and non-replicable.

In some embodiments, particles fabricated by Particle Replication in Nonwetting Templates (PRINT™) (Liquidia Technologies, Inc., North Carolina) are used as taggants. PRINT™ particles, fabricated according to particle fabrication embodiments described herein, can contain one or more unique or identifiable characteristic. The unique characteristic of the particle imparts specific identification information to the particle while rendering the particle non-replicable. In some embodiments the characteristic of the particle can be size(s), shape(s), inorganic materials, polymeric materials, organic molecules, fluorescent moieties, phosphorescent moieties, dye molecules, more dense segments, less dense segments, magnetic materials, ions, chemiluminescent materials, molecules that respond to a stimulus, volatile segments, photochromic materials, thermochromic materials, radio frequency identification, infrared detection, bar-code detection, surface enhanced raman spectroscopy (SERS), and combinations thereof. In other embodiments, the inorganic materials are one or more of the following: iron oxide, rare earths and transitional metals, nuclear materials, semiconducting materials, inorganic nanoparticles, metal nanoparticles, alumina, titania, zirconia, yttria, zirconium phosphate, or yttrium aluminum garnet.

In some embodiments, PRINT™ particles are made in one or more unique shapes and/or sizes and used as a taggant. In another preferred embodiment, PRINT™ particles are made in one or more unique shapes and/or sizes and composed of one or more of the following for use in detection: inorganic materials, polymeric materials, organic molecules, fluorescent moieties, phosphorescent moieties, dye molecules, more dense segments, less dense segments, magnetic materials, ions, chemiluminescent materials, molecules that respond to a stimulus, volatile segments, photochromic materials, thermochromic materials, and combinations thereof. In yet other embodiment, the PRINT™ particles are made with a desired porosity.

In some embodiments, the mark or taggant can be a shape, a chemical signature, a material, a size, a density, and combinations thereof. It is desirable to configure the taggant to supply more information than merely its presence. In some embodiments it is preferred to have the taggant also encode information such as a product date, expiration date, product origin, product destination, identify the source, type, production conditions, composition of the material, or the like. Furthermore, the additional ability to contain randomness or uniqueness is a feature of a preferred taggant. Randomness and/or uniqueness of a taggant based on shape specificity can impart a level of uniqueness not found with any other taggant technology. According to other embodiments, the taggant is configured from materials that can survive harsh manufacturing and/or use processes. In other embodiment, the taggant can be coated with a substance that can withstand harsh manufacturing and/or use processes or conditions. In other embodiments, the PRINT™ particles are distinctly coded with attributes such as shape, size, cargo, and/or chemical functionality that are assigned to a particular meaning, such as the source or identity of goods marked with the particles.

In some embodiments, the particle taggant is configured with a predetermined shape and is between about 20 nm and about 100 micron in a widest dimension. In other embodiments, the particle taggant is molded into a predetermined configuration and is between about 50 nm and about 50 micron in a widest dimension. In some embodiments, the particle taggant is between about 500 nm and about 50 micron in a widest dimension. In some embodiments, the particle taggant is less than 1000 nm in diameter. In other embodiments, the particle taggant is less than 500 nm in its widest diameter. In some embodiments, the particle taggant is between about 250 nm and about 500 nm in a widest dimension. In some embodiments, the particle taggant is between about 100 nm and about 250 nm in a widest dimension. In yet other embodiments, the particle taggant is between about 20 nm and about 100 nm in its widest diameter.

In some embodiments, the particle taggant is configured with a predetermined volume that is less than about 125,000 μm³. In some embodiments, the particle taggant is configured with a predetermined volume that is less than about 50,000 μm³. In some embodiments, the particle taggant is configured with a predetermined volume that is less than about 20,000 μm³. In some embodiments, the particle taggant is configured with a predetermined volume that is less than about 10,000 μm³. In some embodiments, the particle taggant is configured with a predetermined volume that is less than about 1,000 μm³. In some embodiments, the particle taggant is configured with a predetermined volume that is less than about 1 μm³. In some embodiments, the particle taggant is configured with a predetermined volume that is less than about 0.5 μm³. In some embodiments, the particle taggant is configured with a predetermined volume that is less than about 0.125 μm³. In some embodiments, the particle taggant is configured with a predetermined volume that is less than about 0.015 μm³. In some embodiments, the particle taggant is configured with a predetermined volume that is less than about 0.001 μm³. In some embodiments, the particle taggant is configured with a predetermined volume that is less than about 125,000 nm³. In some embodiments, the particle taggant is configured with a predetermined volume that is less than about 50,000 nm³. In some embodiments, the particle taggant is configured with a predetermined volume that is less than about 20,000 nm³. In some embodiments, the particle taggant is configured with a predetermined volume that is less than about 10,000 nm³. In some embodiments, the particle taggant is configured with a predetermined volume that is less than about 5,000 nm³. In some embodiments, the particle taggant is configured with a predetermined volume that is less than about 1,000 nm³. In some embodiments, the particle taggant is configured with a predetermined volume that is less than about 500 nm³. In some embodiments, the particle taggant is configured with a predetermined volume that is less than about 100 nm³. In some embodiments, the particle taggant is configured with a predetermined volume that is less than about 10 nm³. In some embodiments, the particle taggant is configured with a predetermined volume that is less than about 1 nm³.

U.S. published application no. 2005/0218540, incorporated herein by reference in its entirety, discloses inorganic size and shape specific particles that can be used in combination with the present disclosure.

In some embodiments, the particle taggant can be incorporated into paper pulp or woven fibers, printing inks, copier and printer toners, varnishes, sprays, powders, paints, glass, building materials, molded or extruded plastics, molten metals, fuels, fertilizers, explosives, ceramics, raw materials, finished consumer goods, historic artifacts, pharmaceuticals, biological specimens, biological organisms, laboratory equipment, and the like.

According to some embodiments, a combination of molecules is incorporated into the PRINT particles to yield a unique spectral signature upon detection. In other embodiments, a master, mold, or particle fabrication methodology, such as the particle fabrication methodology disclosed herein, can be rationally designed to produce features or patterns on individual elements of the master, mold, or particles, and these features or patterns can then be incorporated into some or all of the particles either through master and mold replication or by direct structuring of the particle. Methods to produce these additional features or patterns can include chemical or physical etching, photolithography, electron beam lithography, scanning probe lithography, ion beam lithography, indentation, mechanical deformation, dissolution, deposition of material, chemical modification, chemical transformation, or other methods to control addition, removal, processing, modification, or structuring of material. These features can be used to assign a particular meaning, such as, for example, the source or identity of goods marked with the particle taggants.

Particle taggants, such as described herein, enable a variety of methods of “interrogating” the particles to confirm the authenticity of an article or item. Some of the embodiments include labels that can be viewed and compared with the naked eye. Other embodiments include features that can be viewed with optical microscopy, electron microscopy, or scanning probe microscopy. Other embodiments require exposure of the mark to an energy stimulus, such as temperature changes, radiation of a particular frequency, x-ray, IR, radio, UV, infrared, visible, Raman spectroscopy, or the like. Other embodiments involve accessing a database and comparing information. Still further embodiments can be viewed using fluorescence or phosphorescence methods. Other embodiments include features that can be detected using particle counting instruments, such as flow cytometry. Other embodiments include features that can be detected with atomic spectroscopy, including atomic absorption, atomic emission, mass spectrometry, and x-ray spectrometry. Still further embodiments include features that can be detected by Raman spectroscopy, and nuclear magnetic resonance spectroscopy. Other embodiments require electroanalytical methods for detection. Still further embodiments require chromatographic separation. Other embodiments include features that can be detected with thermal or radiochemical methods such as thermogravimetry, differential thermal analysis, differential scanning calorimetry, scintillation counters, and isotope dilution methods.

According to some embodiments, the particle taggant is configured in the form of a radio frequency identification (RFID) tag. The object of any RFID system is to carry data and make the data accessible as machine-readable. RFID systems are typically categorized as either “active” or “passive”. In an active RFID system, tags are powered by an internal battery, and data written into active tags may be rewritten and modified. In a passive RFID system, tags operate without an internal power source and are usually programmed, encoded, or imprinted with a unique set of data that cannot be modified, is invisible to the human senses, is virtually indestructible, virtually not reproducible, and machine readable. A typical passive RFID system comprises two components: a reader and a passive tag. The main component of every passive RFID system is information carried on the tags that respond to a coded RF signals that are typically sent from the reader. Active RFID systems typically include a memory that stores data, an RF transceiver that supports long range RF communications with a long range reader, and an interface that supports short range communications with a short range reader over a secure link.

In some embodiments, the micro- or nanoparticle taggant can be encoded or imprinted with RFID information. According to such embodiments, a RFID reader can be used to read the encoded data. In other embodiments of the present invention, the methods and materials disclosed here can be utilized to imprint RFID data and signals into an RFID tag.

According to other embodiments, authentication and identification of articles is enabled. Some of the embodiments can be used in the fields of regulated materials such as narcotics, pollutants, and explosives. Other embodiments can be used for security in papers and inks. Still further embodiments can be utilized as anti-counterfeiting measures. Other embodiments can be used in pharmaceutical products, including formulations and packaging. Further embodiments can be used in bulk materials, including plastic resins, films, petroleum materials, paint, textiles, adhesives, coatings, and sealants, to name a few. Other embodiments can be used in consumer goods. Still further embodiments can be used in labels and holograms. Other embodiments can be used to prevent counterfeit in collectables and sporting goods. Still further embodiments can be used in tracking and point of source measurements.

According to an example, a particle taggant of the present invention can be used to detect biological specimens. According to such an example, a magnetoelectronic sensor can detect magnetically tagged biological specimens. For example, magnetic particles can be used for biological tagging by coating the particles with a suitable antibody that will only bind to specific analyte (virus, bacteria, etc.). One can then test for the presence of that analyte, by mixing the test solution with the taggant. The prepared solution can then be applied over an integrated circuit chip containing an array of giant magneto-resistance (GMR) sensor elements. The sensor elements are individually coated with the specific antibody of interest. Any of the analyte in the solution will bind to the sensor and carry with it the magnetic tag whose magnetic fringing field will act upon the GMR sensor and alter its resistance. By electrically monitoring an array of these chemically coated GMR sensors, a statistical assay of the concentration of the analyte in the test solution is generated.

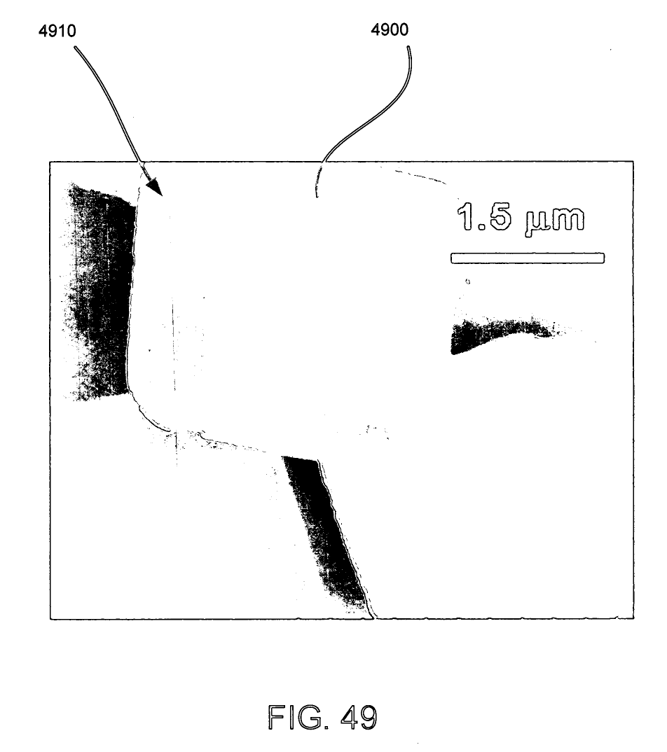

According to another example as shown in FIG. 49, a structural identity of a particle 4900 can be a “Bar-code” type identification 4910. According to this example, “Bar-code” identification elements 4910 are fabricated on particles 4900 by producing structural features on a master or template that are transferred to the mold and the particles 4900 during PRINT fabrication. In FIG. 49, for example, a bosch-type etch is used to process a master which introduces a recognizable pattern (“bosch etch lines”) on the sidewalls of individual particles 4900. The number, morphology and/or pattern of features on the particle sidewalls can be defined by controlling the specific Bosch etching conditions, time, or number of Bosch etch iterations used to process the master from which the particles are derived. FIG. 49 shows two distinct particles derived from the same master that show a similar sidewall pattern resulting from the specific Bosch-type etch process used on the master. In this case, this pattern can be recognized using SEM imaging and identifies these particles as originating from the same master.

According to other embodiments, the taggant particles fabricated from the materials and methods of the present invention can be configured such as the bar-code particles described in Nicewarner-Pena, S. R., et. al., Submicrometer Metallic Barcodes, Science v.294, pg. 137-141, 5 Oct. 2001, attached hereto in Appendix A, which is incorporated herein by reference in their entirety.

Further disclosure and use of taggants and associated systems useful with the present invention can be found in U.S. Pat. Nos. 6,946,671; 6,893,489; 6,936,828; and U.S. Published Application no's. 2005/0205846; 2005/0171701; 2004/0120857; 2004/0046644; 2004/0046642; 2003/0194578; 2005/0258240; 2004/0101469; 2004/0142106; 2005/0009206; 2005/0272885; 2006/0014001, each of which is incorporated herein by reference in their entirety.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Representative Procedure for Synthesis and Curing Photocurable Perfluoropolyethers

In some embodiments, the synthesis and curing of PFPE materials of the presently disclosed subject matter is performed by using the method described by Rolland, J. P., et al., J. Am. Chem. Soc., 2004, 126, 2322-2323. Briefly, this method involves the methacrylate-functionalization of a commercially available PFPE diol (Mₙ=3800 g/mol) with isocyanatoethyl methacrylate. Subsequent photocuring of the material is accomplished through blending with 1 wt % of 2,2-dimethoxy-2-phenylacetophenone and exposure to UV radiation (λ=365 nm).

More particularly, in a typical preparation of perfluoropolyether dimethacrylate (PFPE DMA), poly(tetrafluoroethylene oxide-co-difluoromethylene oxide)α,ω diol (ZDOL, average Mₙ ca. 3,800 g/mol, 95%, Aldrich Chemical Company, Milwaukee, Wis., United States of America) (5.7227 g, 1.5 mmol) was added to a dry 50 mL round bottom flask and purged with argon for 15 minutes. 2-isocyanatoethyl methacrylate (EIM, 99%, Aldrich) (0.43 mL, 3.0 mmol) was then added via syringe along with 1,1,2-trichlorotrifluoroethane (Freon 113 99%, Aldrich) (2 mL), and dibutyltin diacetate (DBTDA, 99%, Aldrich) (50 μL). The solution was immersed in an oil bath and allowed to stir at 50° C. for 24 h. The solution was then passed through a chromatographic column (alumina, Freon 113, 2×5 cm). Evaporation of the solvent yielded a clear, colorless, viscous oil, which was further purified by passage through a 0.22-μm polyethersulfone filter.

In a representative curing procedure for PFPE DMA, 1 wt % of 2,2-dimethoxy-2-phenyl acetophenone (DMPA, 99% Aldrich), (0.05 g, 2.0 mmol) was added to PFPE DMA (5 g, 1.2 mmol) along with 2 mL Freon 113 until a clear solution was formed. After removal of the solvent, the cloudy viscous oil was passed through a 0.22-μm polyethersulfone filter to remove any DMPA that did not disperse into the PFPE DMA. The filtered PFPE DMA was then irradiated with a UV source (Electro-Lite Corporation, Danbury, Conn., United States of America, UV curing chamber model no. 81432-ELC-500, λ=365 nm) while under a nitrogen purge for 10 min. This resulted in a clear, slightly yellow, rubbery material.

### Example 2

### Representative Fabrication of a PFPE DMA Device

In some embodiments, a PFPE DMA device, such as a stamp, was fabricated according to the method described by Rolland, J. P., et al., J. Am. Chem. Soc., 2004, 126, 2322-2323. Briefly, the PFPE DMA containing a photoinitiator, such as DMPA, was spin coated (800 rpm) to a thickness of 20 μm onto a Si wafer containing the desired photoresist pattern. This coated wafer was then placed into the UV curing chamber and irradiated for 6 seconds. Separately, a thick layer (about 5 mm) of the material was produced by pouring the PFPE DMA containing photoinitiator into a mold surrounding the Si wafer containing the desired photoresist pattern. This wafer was irradiated with UV light for one minute. Following this, the thick layer was removed. The thick layer was then placed on top of the thin layer such that the patterns in the two layers were precisely aligned, and then the entire device was irradiated for 10 minutes. Once complete, the entire device was peeled from the Si wafer with both layers adhered together.

### Example 3

### Fabrication of Isolated Particles Using Non-Wetting Imprint Lithography

### 3.1 Fabrication of 200-nm Trapezoidal PEG Particles

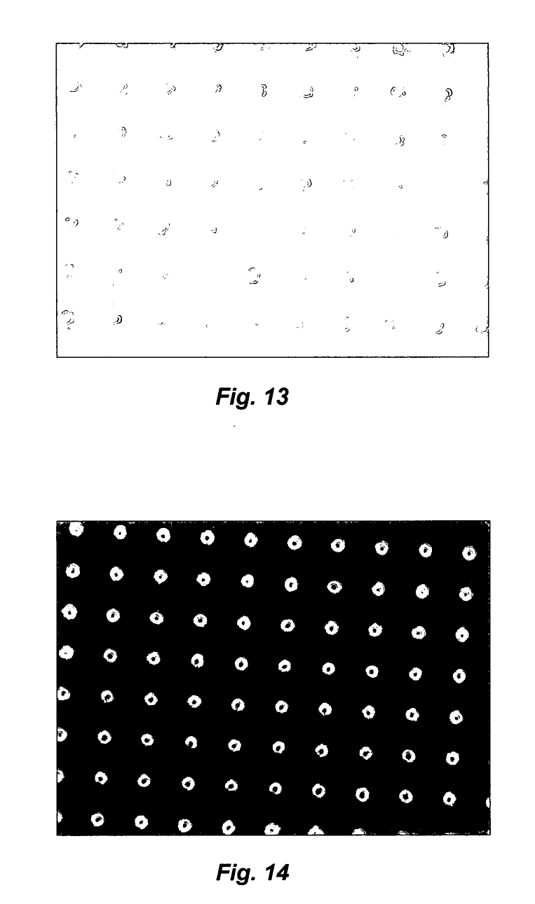

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (See FIG. 13). A poly(dimethylsiloxane) mold is used to confine the liquid PFPE-DMA to the desired area. The apparatus was then subjected to UV light (λ=365 nm) for 10 minutes while under a nitrogen purge. The fully cured PFPE-DMA mold was then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of PEG diacrylate is then placed on the treated silicon wafer and the patterned PFPE mold placed on top of it. The substrate is then placed in a molding apparatus and a small pressure is applied to push out excess PEG-diacrylate. The pressure used was at least about 100 N/cm². The entire apparatus was then subjected to UV light (λ=365 nm) for ten minutes while under a nitrogen purge. Particles are observed after separation of the PFPE mold and the treated silicon wafer using scanning electron microscopy (SEM) (see FIG. 14).

### 3.2 Fabrication of 500-nm Conical PEG Particles

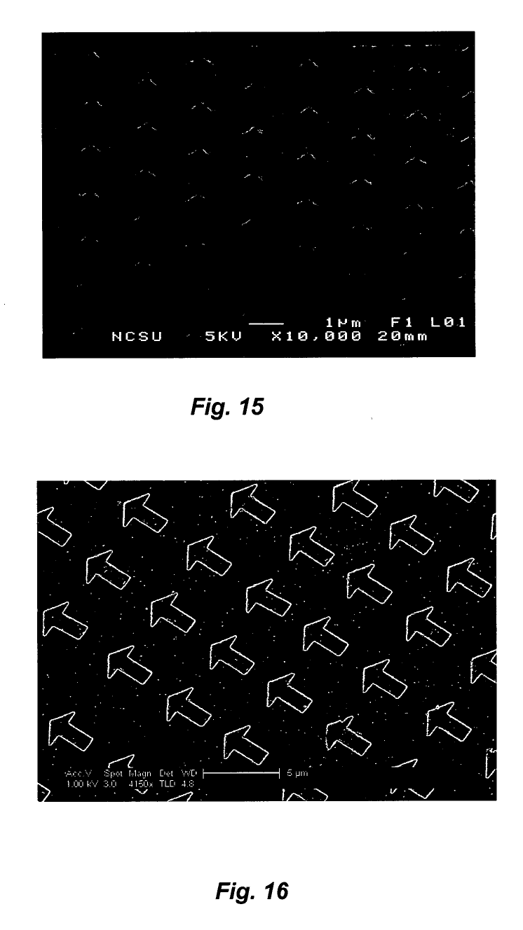

A patterned perfluoropolyether (PFPE) mold is generated by pouring a PFPE-dimethacrylate (PFPE-DMA) containing 1-hydroxycyclohexyl phenyl ketone over a silicon substrate patterned with 500-nm conical shapes (see FIG. 12). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of PEG diacrylate is then placed on the treated silicon wafer and the patterned PFPE mold placed on top of it. The substrate is then placed in a molding apparatus and a small pressure is applied to push out excess PEG-diacrylate. The entire apparatus is then subjected to UV light (λ=365 nm) for ten minutes while under a nitrogen purge. Particles are observed after separation of the PFPE mold and the treated silicon wafer using scanning electron microscopy (SEM) (see FIG. 15).

### 3.3 Fabrication of 3-μm Arrow-Shaped PEG Particles

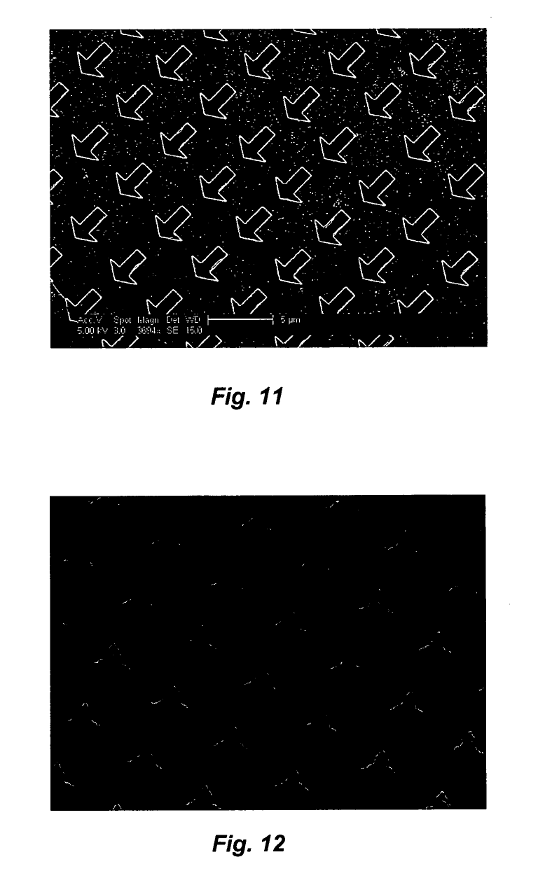

A patterned perfluoropolyether (PFPE) mold is generated by pouring a PFPE-dimethacrylate (PFPE-DMA) containing 1-hydroxycyclohexyl phenyl ketone over a silicon substrate patterned with 3-μm arrow shapes (see FIG. 11). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of PEG diacrylate is then placed on the treated silicon wafer and the patterned PFPE mold placed on top of it. The substrate is then placed in a molding apparatus and a small pressure is applied to push out excess PEG-diacrylate. The entire apparatus is then subjected to UV light (λ=365 nm) for ten minutes while under a nitrogen purge. Particles are observed after separation of the PFPE mold and the treated silicon wafer using scanning electron microscopy (SEM) (see FIG. 16).

3.4 Fabrication of 200-nm×750-nm×250-nm Rectangular PEG Particles

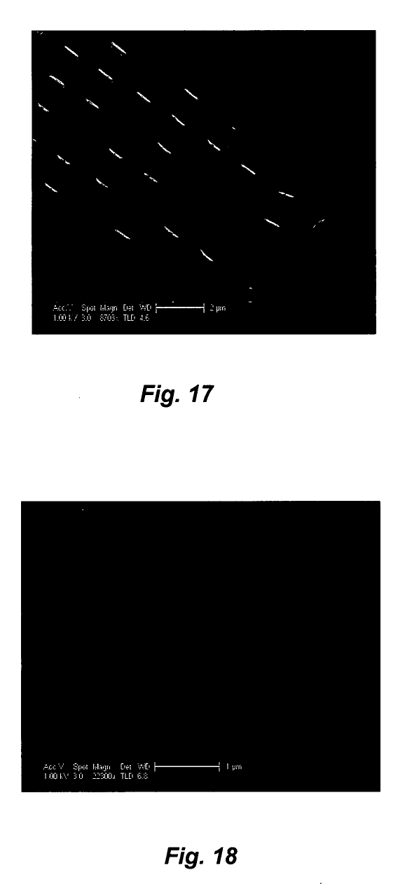

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm×750-nm×250-nm rectangular shapes. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of PEG diacrylate is then placed on the treated silicon wafer and the patterned PFPE mold placed on top of it. The substrate is then placed in a molding apparatus and a small pressure is applied to push out excess PEG-diacrylate. The entire apparatus is then subjected to UV light (λ=365 nm) for ten minutes while under a nitrogen purge. Particles are observed after separation of the PFPE mold and the treated silicon wafer using scanning electron microscopy (SEM) (see FIG. 17).

### 3.5 Fabrication of 200-nm Trapezoidal Trimethylopropane Triacrylate (TMPTA) Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, TMPTA is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of TMPTA is then placed on the treated silicon wafer and the patterned PFPE mold placed on top of it. The substrate is then placed in a molding apparatus and a small pressure is applied to push out excess TMPTA. The entire apparatus is then subjected to UV light (λ=365 nm) for ten minutes while under a nitrogen purge. Particles are observed after separation of the PFPE mold and the treated silicon wafer using scanning electron microscopy (SEM) (see FIG. 18).

### 3.6 Fabrication of 500-nm Conical Trimethylopropane Triacrylate (TMPTA) Particles

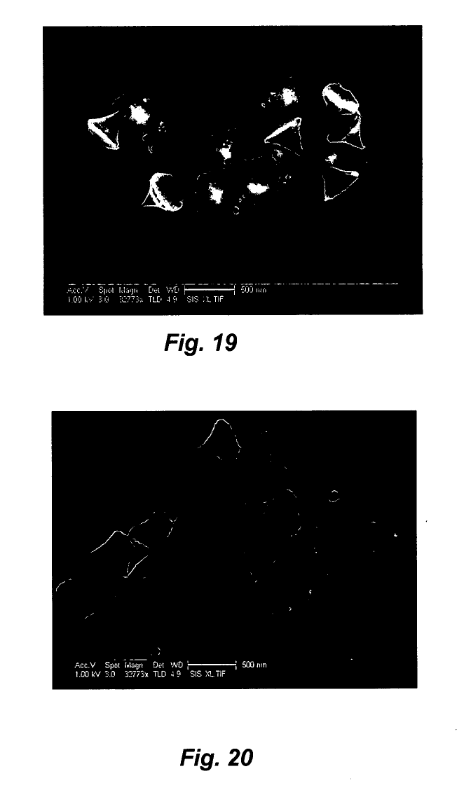

A patterned perfluoropolyether (PFPE) mold is generated by pouring a PFPE-dimethacrylate (PFPE-DMA) containing 1-hydroxycyclohexyl phenyl ketone over a silicon substrate patterned with 500-nm conical shapes (see FIG. 12). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, TMPTA is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of TMPTA is then placed on the treated silicon wafer and the patterned PFPE mold placed on top of it. The substrate is then placed in a molding apparatus and a small pressure is applied to push out excess TMPTA. The entire apparatus is then subjected to UV light (λ=365 nm) for ten minutes while under a nitrogen purge. Particles are observed after separation of the PFPE mold and the treated silicon wafer using scanning electron microscopy (SEM) (see FIG. 19). Further, FIG. 20 shows a scanning electron micrograph of 500-nm isolated conical particles of TMPTA, which have been printed using an embodiment of the presently described non-wetting imprint lithography method and harvested mechanically using a doctor blade. The ability to harvest particles in such a way offers conclusive evidence for the absence of a “scum layer.”

### 3.7 Fabrication of 3-μm Arrow-Shaped TMPTA Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 3-μm arrow shapes (see FIG. 11). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, TMPTA is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of TMPTA is then placed on the treated silicon wafer and the patterned PFPE mold placed on top of it. The substrate is then placed in a molding apparatus and a small pressure is applied to push out excess TMPTA. The entire apparatus is then subjected to UV light (λ=365 nm) for ten minutes while under a nitrogen purge. Particles are observed after separation of the PFPE mold and the treated silicon wafer using scanning electron microscopy (SEM).

### 3.8 Fabrication of 200-nm Trapezoidal Poly(Lactic Acid) (PLA) Particles

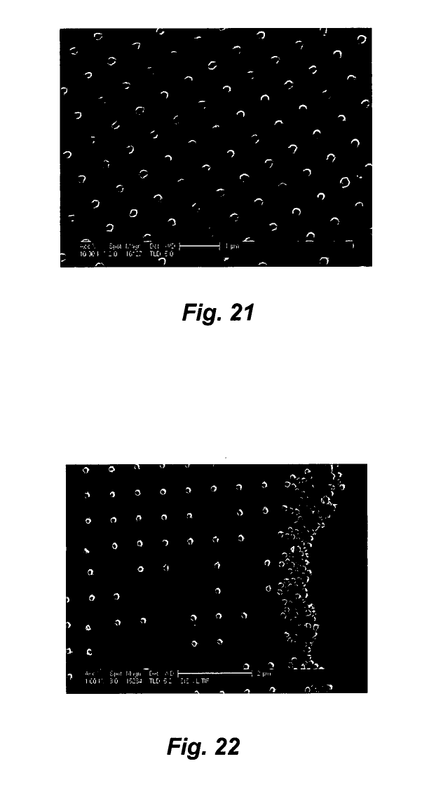

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, one gram of (3S)-cis-3,6-dimethyl-1,4-dioxane-2,5-dione (LA) is heated above its melting temperature (92° C.) to 110° C. and approximately 20 μL of stannous octoate catalyst/initiator is added to the liquid monomer. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of molten LA containing catalyst is then placed on the treated silicon wafer preheated to 110° C. and the patterned PFPE mold is placed on top of it. The substrate is then placed in a molding apparatus and a small pressure is applied to push out excess monomer. The entire apparatus is then placed in an oven at 110° C. for 15 hours. Particles are observed after cooling to room temperature and separation of the PFPE mold and the treated silicon wafer using scanning electron microscopy (SEM) (see FIG. 21). Further, FIG. 22 is a scanning electron micrograph of 200-nm isolated trapezoidal particles of poly(lactic acid) (PLA), which have been printed using an embodiment of the presently described non-wetting imprint lithography method and harvested mechanically using a doctor blade. The ability to harvest particles in such a way offers conclusive evidence for the absence of a “scum layer.”

### 3.9 Fabrication of 3-μm Arrow-Shaped (PLA) Particles

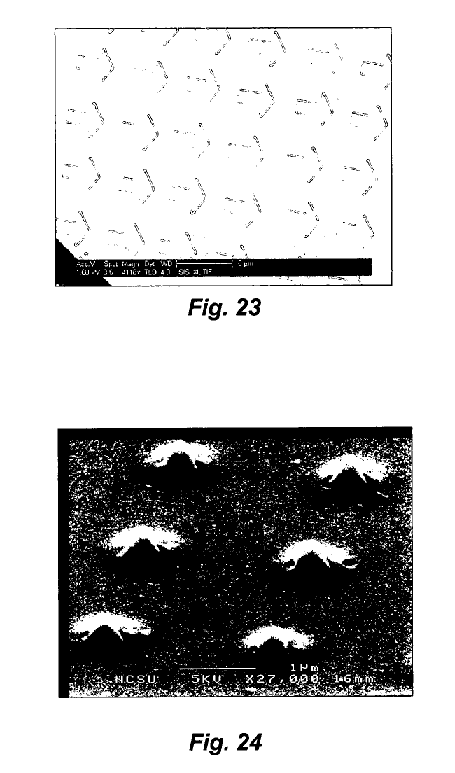

A patterned perfluoropolyether (PFPE) mold is generated by pouring a PFPE-dimethacrylate (PFPE-DMA) containing 1-hydroxycyclohexyl phenyl ketone over a silicon substrate patterned with 3-μm arrow shapes (see FIG. 11). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, one gram of (3S)-cis-3,6-dimethyl-1,4-dioxane-2,5-dione (LA) is heated above its melting temperature (92° C.) to 110° C. and approximately 20 μL of stannous octoate catalyst/initiator is added to the liquid monomer. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of molten LA containing catalyst is then placed on the treated silicon wafer preheated to 110° C. and the patterned PFPE mold is placed on top of it. The substrate is then placed in a molding apparatus and a small pressure is applied to push out excess monomer. The entire apparatus is then placed in an oven at 110° C. for 15 hours. Particles are observed after cooling to room temperature and separation of the PFPE mold and the treated silicon wafer using scanning electron microscopy (SEM) (see FIG. 23).

### 3.10 Fabrication of 500-nm Conical Shaped (PLA) Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 500-nm conical shapes (see FIG. 12). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, one gram of (3S)-cis-3,6-dimethyl-1,4-dioxane-2,5-dione (LA) is heated above its melting temperature (92° C.) to 110° C. and approximately 20 μL of stannous octoate catalyst/initiator is added to the liquid monomer. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of molten LA containing catalyst is then placed on the treated silicon wafer preheated to 110° C. and the patterned PFPE mold is placed on top of it. The substrate is then placed in a molding apparatus and a small pressure is applied to push out excess monomer. The entire apparatus is then placed in an oven at 110° C. for 15 hours. Particles are observed after cooling to room temperature and separation of the PFPE mold and the treated silicon wafer using scanning electron microscopy (SEM) (see FIG. 24).

### 3.11 Fabrication of 200-nm Trapezoidal Poly(Pyrrole) (Ppy) Particles

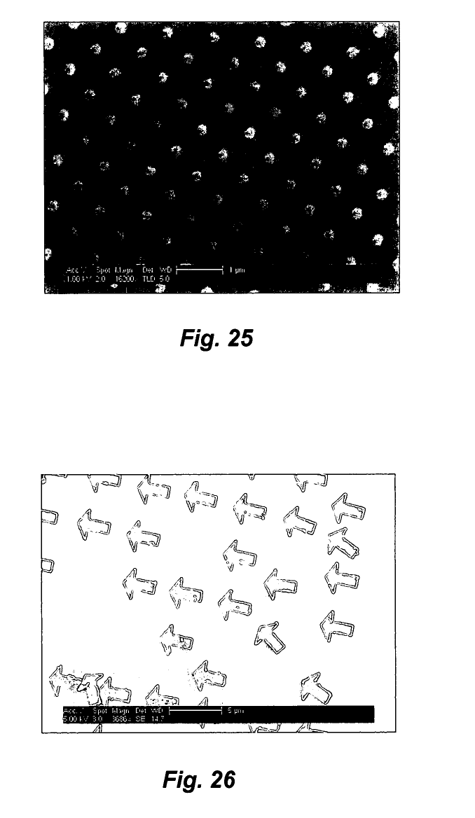

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, 50 μL of a 1:1 v:v solution of tetrahydrofuran:pyrrole is added to 50 μL of 70% perchloric acid (aq). A clear, homogenous, brown solution quickly forms and develops into black, solid, polypyrrole in 15 minutes. A drop of this clear, brown solution (prior to complete polymerization) is placed onto a treated silicon wafer and into a stamping apparatus and a pressure is applied to remove excess solution. The apparatus is then placed into a vacuum oven for 15 h to remove the THF and water. Particles are observed using scanning electron microscopy (SEM) (see FIG. 25) after release of the vacuum and separation of the PFPE mold and the treated silicon wafer.

### 3.12 Fabrication of 3-μm Arrow-Shaped (Ppy) Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 3-μm arrow shapes (see FIG. 11). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, 50 μL of a 1:1 v:v solution of tetrahydrofuran:pyrrole is added to 50 μL of 70% perchloric acid (aq). A clear, homogenous, brown solution quickly forms and develops into black, solid, polypyrrole in 15 minutes. A drop of this clear, brown solution (prior to complete polymerization) is placed onto a treated silicon wafer and into a stamping apparatus and a pressure is applied to remove excess solution. The apparatus is then placed into a vacuum oven for 15 h to remove the THF and water. Particles are observed using scanning electron microscopy (SEM) (see FIG. 26) after release of the vacuum and separation of the PFPE mold and the treated silicon wafer.

### 3.13 Fabrication of 500-nm Conical (Ppy) Particles

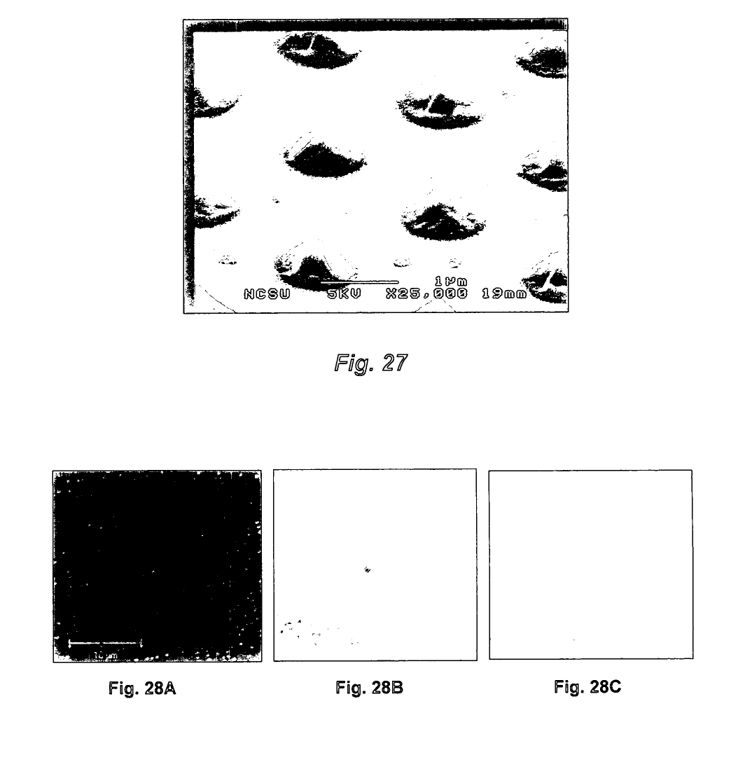

A patterned perfluoropolyether (PFPE) mold is generated by pouring a PFPE-dimethacrylate (PFPE-DMA) containing 1-hydroxycyclohexyl phenyl ketone over a silicon substrate patterned with 500-nm conical shapes (see FIG. 12). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, 50 μL of a 1:1 v:v solution of tetrahydrofuran:pyrrole is added to 50 μL of 70% perchloric acid (aq). A clear, homogenous, brown solution quickly forms and develops into black, solid, polypyrrole in 15 minutes. A drop of this clear, brown solution (prior to complete polymerization) is placed onto a treated silicon wafer and into a stamping apparatus and a pressure is applied to remove excess solution. The apparatus is then placed into a vacuum oven for 15 h to remove the THF and water. Particles are observed using scanning electron microscopy (SEM) (see FIG. 27) after release of the vacuum and separation of the PFPE mold and the treated silicon wafer.

### 3.14 Encapsulation of Fluorescently Tagged DNA Inside 200-nm Trapezoidal PEG Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. 20 μL of water and 20 μL of PEG diacrylate monomer are added to 8 nanomoles of 24 bp DNA oligonucleotide that has been tagged with a fluorescent dye, CY-3. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of the PEG diacrylate solution is then placed on the treated silicon wafer and the patterned PFPE mold placed on top of it. The substrate is then placed in a molding apparatus and a small pressure is applied to push out excess PEG-diacrylate solution. The entire apparatus is then subjected to UV light (λ=365 nm) for ten minutes while under a nitrogen purge. Particles are observed after separation of the PFPE mold and the treated silicon wafer using confocal fluorescence microscopy (see FIG. 28). Further, FIG. 28A shows a fluorescent confocal micrograph of 200-nm trapezoidal PEG nanoparticles which contain 24-mer DNA strands that are tagged with CY-3. FIG. 28B is optical micrograph of the 200-nm isolated trapezoidal particles of PEG diacrylate that contain fluorescently tagged DNA. FIG. 28C is the overlay of the images provided in FIGS. 28A and 28B, showing that every particle contains DNA.

### 3.15 Encapsulation of Magnetite Nanoparticles Inside 500-nm Conical PEG Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 500-nm conical shapes (see FIG. 12). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, citrate capped magnetite nanoparticles were synthesized by reaction of ferric chloride (40 mL of a 1 M aqueous solution) and ferrous chloride (10 mL of a 2 M aqueous hydrochloric acid solution) which is added to ammonia (500 mL of a 0.7 M aqueous solution). The resulting precipitate is collected by centrifugation and then stirred in 2 M perchloric acid. The final solids are collected by centrifugation. 0.290 g of these perchlorate-stabilized nanoparticles are suspended in 50 mL of water and heated to 90° C. while stirring. Next, 0.106 g of sodium citrate is added. The solution is stirred at 90° C. for 30 min to yield an aqueous solution of citrate-stabilized iron oxide nanoparticles. 50 μL of this solution is added to 50 μL of a PEG diacrylate solution in a microtube. This microtube is vortexed for ten seconds. Following this, 50 μL of this PEG diacrylate/particle solution is then placed on the treated silicon wafer and the patterned PFPE mold placed on top of it. The substrate is then placed in a molding apparatus and a small pressure is applied to push out excess PEG-diacrylate/particle solution. The entire apparatus is then subjected to UV light (λ=365 nm) for ten minutes while under a nitrogen purge. Nanoparticle-containing PEG-diacrylate particles are observed after separation of the PFPE mold and the treated silicon wafer using optical microscopy.

### 3.16 Fabrication of Isolated Particles on Glass Surfaces Using “Double Stamping”

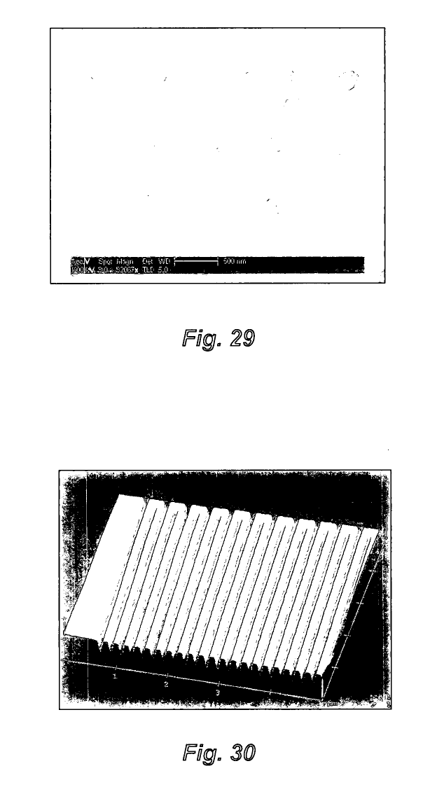

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. A flat, non-wetting surface is generated by photocuring a film of PFPE-DMA onto a glass slide, according to the procedure outlined for generating a patterned PFPE-DMA mold. 5 μL of the PEG-diacrylate/photoinitiator solution is pressed between the PFPE-DMA mold and the flat PFPE-DMA surface, and pressure is applied to squeeze out excess PEG-diacrylate monomer. The PFPE-DMA mold is then removed from the flat PFPE-DMA surface and pressed against a clean glass microscope slide and photocured using UV radiation (λ=365 nm) for 10 minutes while under a nitrogen purge. Particles are observed after cooling to room temperature and separation of the PFPE mold and the glass microscope slide, using scanning electron microscopy (SEM) (see FIG. 29).

### 3.17. Encapsulation of Viruses in PEG-Diacrylate Nanoparticles.

A patterned perfluoropolyether (PFPE) mold is generated by pouring PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Fluorescently-labeled or unlabeled Adenovirus or Adeno-Associated Virus suspensions are added to this PEG-diacrylate monomer solution and mixed thoroughly. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of the PEG diacrylate/virus solution is then placed on the treated silicon wafer and the patterned PFPE mold placed on top of it. The substrate is then placed in a molding apparatus and a small pressure is applied to push out excess PEG-diacrylate solution. The entire apparatus is then subjected to UV light (λ=365 nm) for ten minutes while under a nitrogen purge. Virus-containing particles are observed after separation of the PFPE mold and the treated silicon wafer using transmission electron microscopy or, in the case of fluorescently-labeled viruses, confocal fluorescence microscopy.

### 3.18 Encapsulation of Proteins in PEG-Diacrylate Nanoparticles.

A patterned perfluoropolyether (PFPE) mold is generated by pouring PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Fluorescently-labeled or unlabeled protein solutions are added to this PEG-diacrylate monomer solution and mixed thoroughly. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of the PEG diacrylate/virus solution is then placed on the treated silicon wafer and the patterned PFPE mold placed on top of it. The substrate is then placed in a molding apparatus and a small pressure is applied to push out excess PEG-diacrylate solution. The entire apparatus is then subjected to UV light (λ=365 nm) for ten minutes while under a nitrogen purge. Protein-containing particles are observed after separation of the PFPE mold and the treated silicon wafer using traditional assay methods or, in the case of fluorescently-labeled proteins, confocal fluorescence microscopy.

### 3.19 Fabrication of 200-nm Titania Particles

A patterned perfluoropolyether (PFPE) mold can be generated by pouring a PFPE-dimethacrylate (PFPE-DMA) containing 1-hydroxycyclohexyl phenyl ketone over a silicon substrate patterned with 200-nm trapezoidal shapes, such as shown in FIG. 13. A poly(dimethylsiloxane) mold can be used to confine the liquid PFPE-DMA to the desired area. The apparatus can then be subjected to UV light (λ=365 nm) for 10 minutes while under a nitrogen purge. The fully cured PFPE-DMA mold is then released from the silicon master. Separately, 1 g of Pluronic P123 is dissolved in 12 g of absolute ethanol. This solution was added to a solution of 2.7 mL of concentrated hydrochloric acid and 3.88 mL titanium (IV) ethoxide. Flat, uniform, non-wetting surfaces can be generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of the sol-gel solution can then be placed on the treated silicon wafer and the patterned PFPE mold placed on top of it. The substrate is then placed in a molding apparatus and a small pressure is applied to push out excess sol-gel precursor. The entire apparatus is then set aside until the sol-gel precursor has solidified. After solidification of the sol-gel precursor, the silicon wafer can be removed from the patterned PFPE and particles will be present.

### 3.20 Fabrication of 200-nm Silica Particles

A patterned perfluoropolyether (PFPE) mold can be generated by pouring a PFPE-dimethacrylate (PFPE-DMA) containing 1-hydroxycyclohexyl phenyl ketone over a silicon substrate patterned with 200-nm trapezoidal shapes, such as shown in FIG. 13. A poly(dimethylsiloxane) mold can then be used to confine the liquid PFPE-DMA to the desired area. The apparatus can then be subjected to UV light (λ=365 nm) for 10 minutes while under a nitrogen purge. The fully cured PFPE-DMA mold is then released from the silicon master. Separately, 2 g of Pluronic P123 is dissolved in 30 g of water and 120 g of 2 M HCl is added while stirring at 35° C. To this solution, add 8.50 g of TEOS with stirring at 35° C. for 20 h. Flat, uniform, non-wetting surfaces can then be generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of the sol-gel solution is then placed on the treated silicon wafer and the patterned PFPE mold placed on top of it. The substrate is then placed in a molding apparatus and a small pressure is applied to push out excess sol-gel precursor. The entire apparatus is then set aside until the sol-gel precursor has solidified. Particles should be observed after separation of the PFPE mold and the treated silicon wafer using scanning electron microscopy (SEM).

### 3.21 Fabrication of 200-nm Europium-Doped Titania Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, 1 g of Pluronic P123 and 0.51 g of EuCl₃.6H₂O are dissolved in 12 g of absolute ethanol. This solution is added to a solution of 2.7 mL of concentrated hydrochloric acid and 3.88 mL titanium (IV) ethoxide. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of the sol-gel solution is then placed on the treated silicon wafer and the patterned PFPE mold placed on top of it. The substrate is then placed in a molding apparatus and a small pressure is applied to push out excess sol-gel precursor. The entire apparatus is then set aside until the sol-gel precursor has solidified. Next, after the sol-gel precursor has solidified, the PFPE mold and the treated silicon wafer are separated and particles should be observed using scanning electron microscopy (SEM).

### 3.22 Encapsulation of CdSe Nanoparticles Inside 200-nm PEG Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, 0.5 g of sodium citrate and 2 mL of 0.04 M cadmium perchlorate are dissolved in 45 mL of water, and the pH is adjusted to of the solution to 9 with 0.1 M NaOH. The solution is bubbled with nitrogen for 15 minutes. 2 mL of 1 M N,N-dimethylselenourea is added to the solution and heated in a microwave oven for 60 seconds. 50 μL of this solution is added to 50 μL of a PEG diacrylate solution in a microtube. This microtube is vortexed for ten seconds. 50 μL of this PEG diacrylate/CdSe particle solution is placed on the treated silicon wafer and the patterned PFPE mold placed on top of it. The substrate is then placed in a molding apparatus and a small pressure is applied to push out excess PEG-diacrylate solution. The entire apparatus is then subjected to UV light (λ=365 nm) for ten minutes while under a nitrogen purge. PEG-diacrylate particles with encapsulated CdSe nanoparticles will be observed after separation of the PFPE mold and the treated silicon wafer using TEM or fluorescence microscopy.

### 3.23 Synthetic Replication of Adenovirus Particles Using Non-Wetting Imprint Lithography

A template, or “master,” for perfluoropolyether-dimethacrylate (PFPE-DMA) mold fabrication is generated by dispersing adenovirus particles on a silicon wafer. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. Separately, TMPTA is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of TMPTA is then placed on the treated silicon wafer and the patterned PFPE mold placed on top of it. The substrate is then placed in a molding apparatus and a small pressure is applied to push out excess TMPTA. The entire apparatus is then subjected to UV light (λ=365 nm) for ten minutes while under a nitrogen purge. Synthetic virus replicates are observed after separation of the PFPE mold and the treated silicon wafer using scanning electron microscopy (SEM) or transmission electron microscopy (TEM).

### 3.24 Synthetic Replication of Earthworm Hemoglobin Protein Using Non-Wetting Imprint Lithography

A template, or “master,” for perfluoropolyether-dimethacrylate (PFPE-DMA) mold fabrication is generated by dispersing earthworm hemoglobin protein on a silicon wafer. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. Separately, TMPTA is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of TMPTA is then placed on the treated silicon wafer and the patterned PFPE mold placed on top of it. The substrate is then placed in a molding apparatus and a small pressure is applied to push out excess TMPTA. The entire apparatus is then subjected to UV light (λ=365 nm) for ten minutes while under a nitrogen purge. Synthetic protein replicates are observed after separation of the PFPE mold and the treated silicon wafer using scanning electron microscopy (SEM) or transmission electron microscopy (TEM).

### 3.25. Combinatorial Engineering of 100-nm Nanoparticle Therapeutics

A patterned perfluoropolyether (PFPE) mold is generated by pouring a PFPE-dimethacrylate (PFPE-DMA) containing 1-hydroxycyclohexyl phenyl ketone over a silicon substrate patterned with 100-nm cubic shapes. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Other therapeutic agents (i.e., small molecule drugs, proteins, polysaccharides, DNA, etc.), tissue targeting agents (cell penetrating peptides and ligands, hormones, antibodies, etc.), therapeutic release/transfection agents (other controlled-release monomer formulations, cationic lipids, etc.), and miscibility enhancing agents (cosolvents, charged monomers, etc.) are added to the polymer precursor solution in a combinatorial manner. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of the combinatorially-generated particle precursor solution is then placed on the treated silicon wafer and the patterned PFPE mold placed on top of it. The substrate is then placed in a molding apparatus and a small pressure is applied to push out excess solution. The entire apparatus is then subjected to UV light (λ=365 nm) for ten minutes while under a nitrogen purge. The PFPE-DMA mold is then separated from the treated wafer, particles can be harvested, and the therapeutic efficacy of each combinatorially generated nanoparticle is established. By repeating this methodology with different particle formulations, many combinations of therapeutic agents, tissue targeting agents, release agents, and other important compounds can be rapidly screened to determine the optimal combination for a desired therapeutic application.

### 3.26 Fabrication of a Shape-Specific PEG Membrane

A patterned perfluoropolyether (PFPE) mold is generated by pouring a PFPE-dimethacrylate (PFPE-DMA) containing 1-hydroxycyclohexyl phenyl ketone over a silicon substrate patterned with 3-μm cylindrical holes that are 5 μm deep. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of PEG diacrylate is then placed on the treated silicon wafer and the patterned PFPE mold placed on top of it. The substrate is then placed in a molding apparatus and a small pressure is applied to push out excess PEG-diacrylate. The entire apparatus is then subjected to UV light (λ=365 nm) for ten minutes while under a nitrogen purge. An interconnected membrane will be observed after separation of the PFPE mold and the treated silicon wafer using scanning electron microscopy (SEM). The membrane will release from the surface by soaking in water and allowing it to lift off the surface.

### 3.27 Harvesting of PEG Particles by Ice Formation

A patterned perfluoropolyether (PFPE) mold is generated by pouring a PFPE-dimethacrylate (PFPE-DMA) containing 1-hydroxycyclohexyl phenyl ketone over a silicon substrate patterned with 5-μm cylinder shapes. The substrate is then subjected to a nitrogen purge for 10 minutes, then UV light (λ=365 nm) is applied for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by coating a glass slide with PFPE-DMA containing 1-hydroxycyclohexyl phenyl ketone. The slide is then subjected to a nitrogen purge for 10 minutes, then UV light (λ=365 nm) is applied for 10 minutes while under a nitrogen purge. The flat, fully cured PFPE-DMA substrate is released from the slide. Following this, 0.1 mL of PEG diacrylate is then placed on the flat PFPE-DMA substrate and the patterned PFPE mold placed on top of it. The substrate is then placed in a molding apparatus and a small pressure is applied to push out excess PEG-diacrylate. The entire apparatus is then purged with nitrogen for 10 minutes, then subjected to UV light (λ=365 nm) for 10 minutes while under a nitrogen purge. PEG particles are observed after separation of the PFPE-DMA mold and substrate using optical microscopy. Water is applied to the surface of the substrate and mold containing particles. A gasket is used to confine the water to the desired location. The apparatus is then placed in the freezer at a temperature of −10° C. for 30 minutes. The ice containing PEG particles is peeled off the PFPE-DMA mold and substrate and allowed to melt, yielding an aqueous solution containing PEG particles.

3.28 Harvesting of PEG Particles with Vinyl Pyrrolidone

A patterned perfluoropolyether (PFPE) mold is generated by pouring a PFPE-dimethacrylate (PFPE-DMA) containing 1-hydroxycyclohexyl phenyl ketone over a silicon substrate patterned with 5-μm cylinder shapes. The substrate is then subjected to a nitrogen purge for 10 minutes, then UV light (λ=365 nm) is applied for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by coating a glass slide with PFPE-DMA containing 1-hydroxycyclohexyl phenyl ketone. The slide is then subjected to a nitrogen purge for 10 minutes, then UV light (λ=365 nm) is applied for 10 minutes while under a nitrogen purge. The flat, fully cured PFPE-DMA substrate is released from the slide. Following this, 0.1 mL of PEG diacrylate is then placed on the flat PFPE-DMA substrate and the patterned PFPE mold placed on top of it. The substrate is then placed in a molding apparatus and a small pressure is applied to push out excess PEG-diacrylate. The entire apparatus is then purged with nitrogen for 10 minutes, then subjected to UV light (λ=365 nm) for 10 minutes while under a nitrogen purge. PEG particles are observed after separation of the PFPE-DMA mold and substrate using optical microscopy. In some embodiments, the material includes an adhesive or sticky surface. In some embodiments, the material includes carbohydrates, epoxies, waxes, polyvinyl alcohol, polyvinyl pyrrolidone, polybutyl acrylate, polycyano acrylates, polymethyl methacrylate. In some embodiments, the harvesting or collecting of the particles includes cooling water to form ice (e.g., in contact with the particles) drop of n-vinyl-2-pyrrolidone containing 5% photoinitiator, 1-hydroxycyclohexyl phenyl ketone, is placed on a clean glass slide. The PFPE-DMA mold containing particles is placed patterned side down on the n-vinyl-2-pyrrolidone drop. The slide is subjected to a nitrogen purge for 5 minutes, then UV light (λ=365 nm) is applied for 5 minutes while under a nitrogen purge. The slide is removed, and the mold is peeled away from the polyvinyl pyrrolidone and particles. Particles on the polyvinyl pyrrolidone were observed with optical microscopy. The polyvinyl pyrrolidone film containing particles was dissolved in water. Dialysis was used to remove the polyvinyl pyrrolidone, leaving an aqueous solution containing 5 μm PEG particles.

3.29. Harvesting of PEG Particles with Polyvinyl Alcohol

A patterned perfluoropolyether (PFPE) mold is generated by pouring a PFPE-dimethacrylate (PFPE-DMA) containing 1-hydroxycyclohexyl phenyl ketone over a silicon substrate patterned with 5-μm cylinder shapes. The substrate is then subjected to a nitrogen purge for 10 minutes, then UV light (λ=365 nm) is applied for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by coating a glass slide with PFPE-DMA containing 1-hydroxycyclohexyl phenyl ketone. The slide is then subjected to a nitrogen purge for 10 minutes, then UV light (λ=365 nm) is applied for 10 minutes while under a nitrogen purge. The flat, fully cured PFPE-DMA substrate is released from the slide. Following this, 0.1 mL of PEG diacrylate is then placed on the flat PFPE-DMA substrate and the patterned PFPE mold placed on top of it. The substrate is then placed in a molding apparatus and a small pressure is applied to push out excess PEG-diacrylate. The entire apparatus is then purged with nitrogen for 10 minutes, then subjected to UV light (λ=365 nm) for 10 minutes while under a nitrogen purge. PEG particles are observed after separation of the PFPE-DMA mold and substrate using optical microscopy. Separately, a solution of 5 weight percent polyvinyl alcohol (PVOH) in ethanol (EtOH) is prepared. The solution is spin coated on a glass slide and allowed to dry. The PFPE-DMA mold containing particles is placed patterned side down on the glass slide and pressure is applied. The mold is then peeled away from the PVOH and particles. Particles on the PVOH were observed with optical microscopy. The PVOH film containing particles was dissolved in water. Dialysis was used to remove the PVOH, leaving an aqueous solution containing 5 μm PEG particles.

### 3.30. Fabrication of 200 nm Phosphatidylcholine Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 13). A poly(dimethylsiloxane) mold is used to confine the liquid PFPE-DMA to the desired area. The apparatus is then subjected to a nitrogen purge for 10 minutes followed by UV light (λ=365 nm) for 10 minutes while under a nitrogen purge. The fully cured PFPE-DMA mold is then released from the silicon master. Separately, flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 20 mg of the phosphatidylcholine was placed on the treated silicon wafer and heated to 60 degrees C. The substrate is then placed in a molding apparatus and a small pressure is applied to push out excess phosphatidylcholine. The entire apparatus is then set aside until the phosphatidylcholine has solidified. Particles are observed after separation of the PFPE mold and the treated silicon wafer using scanning electron microscopy (SEM).

3.31 Functionalizing PEG Particles with FITC

Poly(ethylene glycol) (PEG) particles with 5 weight percent aminoethyl methacrylate were created. Particles are observed in the PFPE mold after separation of the PFPE mold and the PFPE substrate using optical microscopy. Separately, a solution containing 10 weight percent fluorescein isothiocyanate (FITC) in dimethylsulfoxide (DMSO) was created. Following this, the mold containing the particles was exposed to the FITC solution for one hour. Excess FITC was rinsed off the mold surface with DMSO followed by deionized (DI) water. The tagged particles were observed with fluorescence microscopy, with an excitation wavelength of 492 nm and an emission wavelength of 529 nm.

### 3.32 Encapsulation of Doxorubicin Inside 500 nm Conical PEG Particles

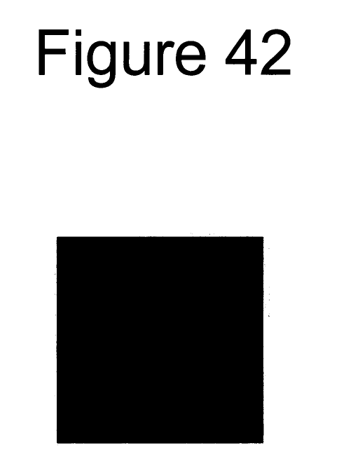

A patterned perfluoropolyether (PFPE) mold was generated by pouring a PFPE-dimethacrylate (PFPE-DMA) containing 1-hydroxycyclohexyl phenyl ketone over a silicon substrate patterned with 500-nm conical shapes (see FIG. 12). A poly(dimethylsiloxane) mold was used to confine the liquid PFPE-DMA to the desired area. The apparatus was then subjected to UV light (λ=365 nm) for 10 minutes while under a nitrogen purge. The fully cured PFPE-DMA mold was then released from the silicon master. Flat, uniform, non-wetting surfaces were generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 1 wt % doxorubicin in PEG diacrylate was formulated with 1 wt % photoinitiator. Following this, 50 μL of this PEG diacrylate/doxorubicin solution was then placed on the treated silicon wafer and the patterned PFPE mold placed on top of it. The substrate was then placed in a molding apparatus and a small pressure was applied to push out excess PEG-diacrylate/doxorubicin solution. The small pressure in this example was at least about 100 N/cm². The entire apparatus was then subjected to UV light (λ=365 nm) for ten minutes while under a nitrogen purge. Doxorubicin-containing PEG-diacrylate particles were observed after separation of the PFPE mold and the treated silicon wafer using fluorescent microscopy (FIG. 42).

3.33 Encapsulation of Avidin (66 kDa) in 160 nm PEG Particles

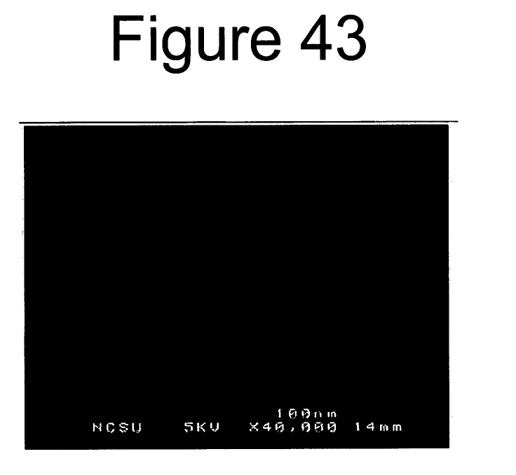

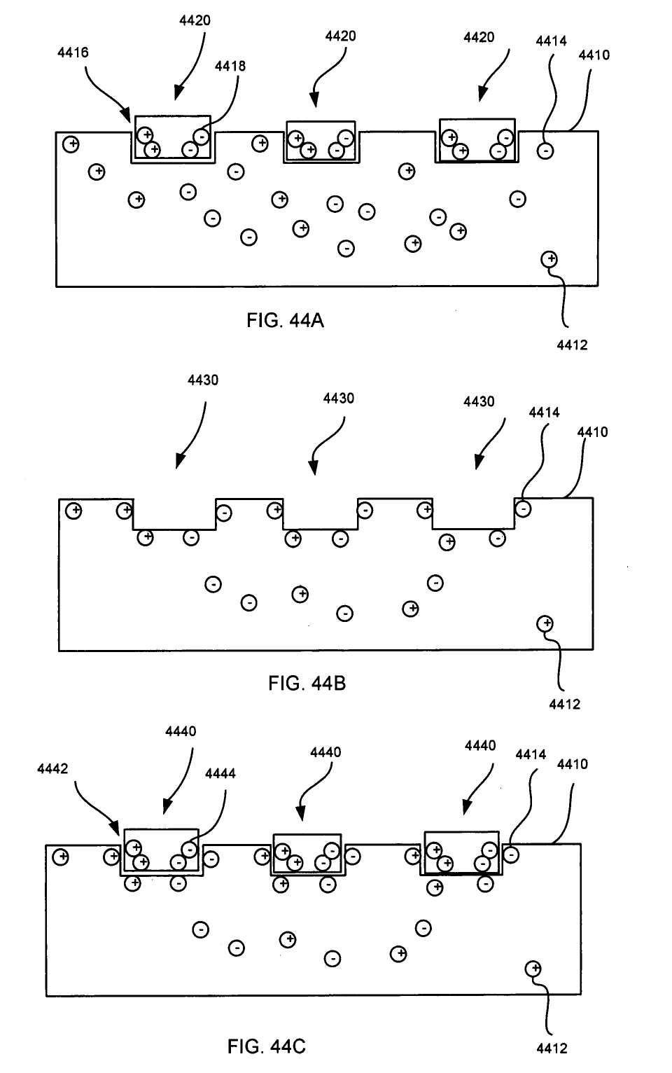

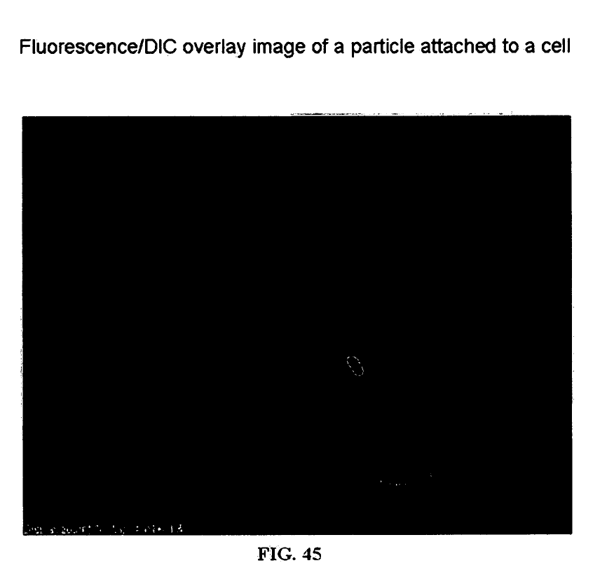

A patterned perfluoropolyether (PFPE) mold was generated by pouring a PFPE-dimethacrylate (PFPE-DMA) containing 1-hydroxycyclohexyl phenyl ketone over a silicon substrate patterned with 160-nm cylindrical shapes (see FIG. 43). A poly(dimethylsiloxane) mold was used to confine the liquid PFPE-DMA to the desired area. The apparatus was then subjected to UV light (λ=365 nm) for 10 minutes while under a nitrogen purge. The fully cured PFPE-DMA mold was then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 1 wt % avidin in 30:70 PEG monomethacrylate:PEG diacrylate was formulated with 1 wt % photoinitiator. Following this, 50 μL of this PEG/avidin solution was then placed on the treated silicon wafer and the patterned PFPE mold placed on top of it. The substrate was then placed in a molding apparatus and a small pressure is applied to push out excess PEG-diacrylate/avidin solution. The small pressure in this example was at least about 100 N/cm². The entire apparatus was then subjected to UV light (λ=365 nm) for ten minutes while under a nitrogen purge. Avidin-containing PEG particles were observed after separation of the PFPE mold and the treated silicon wafer using fluorescent microscopy.

3.34 Encapsulation of 2-fluoro-2-deoxy-d-glucose in 80 nm PEG Particles

A patterned perfluoropolyether (PFPE) mold is generated by pouring a PFPE-dimethacrylate (PFPE-DMA) containing 1-hydroxycyclohexyl phenyl ketone over a 6 inch silicon substrate patterned with 80-nm cylindrical shapes. The substrate is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 0.5 wt % 2-fluoro-2-deoxy-d-glucose (FDG) in 30:70 PEG monomethacrylate:PEG diacrylate is formulated with 1 wt % photoinitiator. Following this, 200 μL of this PEG/FDG solution is then placed on the treated silicon wafer and the patterned PFPE mold placed on top of it. The substrate is then placed in a molding apparatus and a small pressure is applied to push out excess PEG/FDG solution. The small pressure should be at least about 100 N/cm². The entire apparatus is then subjected to UV light (λ=365 nm) for ten minutes while under a nitrogen purge. FDG-containing PEG particles will be observed after separation of the PFPE mold and the treated silicon wafer using scanning electron microscopy.

3.35 Encapsulated DNA in 200 nm×200 nm×1 μm Bar-Shaped Poly(Lactic Acid) Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 200 nm×200 nm×1 μm bar shapes. The substrate is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 0.01 wt % 24 base pair DNA and 5 wt % poly(lactic acid) in ethanol is formulated. 200 μL of this ethanol solution is then placed on the treated silicon wafer and the patterned PFPE mold placed on top of it. The substrate is then placed in a molding apparatus and a small pressure is applied to push out excess PEG/FDG solution. The small pressure should be at least about 100 N/cm². The entire apparatus is then placed under vacuum for 2 hours. DNA-containing poly(lactic acid) particles will be observed after separation of the PFPE mold and the treated silicon wafer using optical microscopy.

### 3.36 100 nm Paclitaxel Particles

A patterned perfluoropolyether (PFPE) mold is generated by pouring a PFPE-dimethacrylate (PFPE-DMA) containing 1-hydroxycyclohexyl phenyl ketone over a silicon substrate patterned with 500-nm conical shapes (see FIG. 12). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 5 wt % paclitaxel in ethanol was formulated. Following this, 100 μL of this paclitaxel solution is then placed on the treated silicon wafer and the patterned PFPE mold placed on top of it. The substrate is then placed in a molding apparatus and a small pressure is applied to push out excess solution. The pressure applied was at least about 100 N/cm². The entire apparatus is then placed under vacuum for 2 hours. Separation of the mold and surface yielded approximately 100 nm spherical paclitaxel particles, which were observed with scanning electron microscopy.

### 3.37 Triangular Particles Functionalized on One Side

A patterned perfluoropolyether (PFPE) mold is generated by pouring a PFPE-dimethacrylate (PFPE-DMA) containing 1-hydroxycyclohexyl phenyl ketone over a 6 inch silicon substrate patterned with 0.6 μm×0.8 μm×1 μm right triangles. The substrate is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 5 wt % aminoethyl methacrylate in 30:70 PEG monomethacrylate:PEG diacrylate is formulated with 1 wt % photoinitiator. Following this, 200 μL of this monomer solution is then placed on the treated silicon wafer and the patterned PFPE mold placed on top of it. The substrate is then placed in a molding apparatus and a small pressure is applied to push out excess solution. The small pressure should be at least about 100 N/cm². The entire apparatus is then subjected to UV light (λ=365 nm) for ten minutes while under a nitrogen purge. Aminoethyl methacrylate-containing PEG particles are observed in the mold after separation of the PFPE mold and the treated silicon wafer using optical microscopy. Separately, a solution containing 10 weight percent fluorescein isothiocyanate (FITC) in dimethylsulfoxide (DMSO) is created. Following this, the mold containing the particles is exposed to the FITC solution for one hour. Excess FITC is rinsed off the mold surface with DMSO followed by deionized (DI) water. Particles, tagged only on one face, will be observed with fluorescence microscopy, with an excitation wavelength of 492 nm and an emission wavelength of 529 nm.

### 3.38 Formation of an Imprinted Protein Binding Cavity and an Artificial Protein

The desired protein molecules are adsorbed onto a mica substrate to create a master template. A mixture of PFPE-dimethacrylate (PFPE-DMA) containing a monomer with a covalently attached disaccharide, and 1-hydroxycyclohexyl phenyl ketone as a photoinitiator was poured over the substrate. The substrate is then subjected to UV light (λ=365 nm) for 10 minutes while under a nitrogen purge. The fully cured PFPE-DMA mold is then released from the mica master, creating polysaccharide-like cavities that exhibit selective recognition for the protein molecule that was imprinted. The polymeric mold was soaked in NaOH/NaClO solution to remove the template proteins.

Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 25% (w/w) methacrylic acid (MAA), 25% diethyl aminoethylmethacrylate (DEAEM), and 48% PEG diacrylate was formulated with 2 wt % photoinitiator. Following this, 200 μL of this monomer solution is then placed on the treated silicon wafer and the patterned PFPE/disaccharide mold placed on top of it. The substrate is then placed in a molding apparatus and a small pressure is applied to push out excess solution. The entire apparatus is then subjected to UV light (λ=365 nm) for ten minutes while under a nitrogen purge. Removal of the mold yields artificial protein molecules which have similar size, shape, and chemical functionality as the original template protein molecule.

### Example 4

### Molding of Features for Semiconductor Applications

### 4.1 Fabrication of 140-nm Lines Separated by 70 nm in TMPTA

A patterned perfluoropolyether (PFPE) mold is generated by pouring a PFPE-dimethacrylate (PFPE-DMA) containing 1-hydroxycyclohexyl phenyl ketone over a silicon substrate patterned with 140-nm lines separated by 70 nm. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, TMPTA is blended with 1 wt % of a photoinitiator, 1-hydroxycyclohexyl phenyl ketone. Flat, uniform, surfaces are generated by treating a silicon wafer cleaned with “piranha” solution (1:1 concentrated sulfuric acid: 30% hydrogen peroxide (aq) solution) and treating the wafer with an adhesion promoter, (trimethoxysilyl propyl methacryalte). Following this, 50 μL of TMPTA is then placed on the treated silicon wafer and the patterned PFPE mold placed on top of it. The substrate is then placed in a molding apparatus and a small pressure is applied to ensure a conformal contact. The entire apparatus is then subjected to UV light (λ=365 nm) for ten minutes while under a nitrogen purge. Features are observed after separation of the PFPE mold and the treated silicon wafer using atomic force microscopy (AFM) (see FIG. 30).

### 4.2 Molding of a Polystyrene Solution

A patterned perfluoropolyether (PFPE) mold is generated by pouring a PFPE-dimethacrylate (PFPE-DMA) containing 1-hydroxycyclohexyl phenyl ketone over a silicon substrate patterned with 140-nm lines separated by 70 nm. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, polystyrene is dissolved in 1 to 99 wt % of toluene. Flat, uniform, surfaces are generated by treating a silicon wafer cleaned with “piranha” solution (1:1 concentrated sulfuric acid: 30% hydrogen peroxide (aq) solution) and treating the wafer with an adhesion promoter. Following this, 50 mL of polystyrene solution is then placed on the treated silicon wafer and the patterned PFPE mold is placed on top of it. The substrate is then placed in a molding apparatus and a small pressure is applied to ensure a conformal contact. The entire apparatus is then subjected to vacuum for a period of time to remove the solvent. Features are observed after separation of the PFPE mold and the treated silicon wafer using atomic force microscopy (AFM) and scanning electron microscopy (SEM).

### 4.3 Molding of Isolated Features on Microelectronics-Compatible Surfaces Using “Double Stamping”

A patterned perfluoropolyether (PFPE) mold is generated by pouring a PFPE-dimethacrylate (PFPE-DMA) containing 1-hydroxycyclohexyl phenyl ketone over a silicon substrate patterned with 140-nm lines separated by 70 nm. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, TMPTA is blended with 1 wt % of a photoinitiator, 1-hydroxycyclohexyl phenyl ketone. A flat, non-wetting surface is generated by photocuring a film of PFPE-DMA onto a glass slide, according to the procedure outlined for generating a patterned PFPE-DMA mold. 50 μL of the TMPTA/photoinitiator solution is pressed between the PFPE-DMA mold and the flat PFPE-DMA surface, and pressure is applied to squeeze out excess TMPTA monomer. The PFPE-DMA mold is then removed from the flat PFPE-DMA surface and pressed against a clean, flat silicon/silicon oxide wafer and photocured using UV radiation (λ=365 nm) for 10 minutes while under a nitrogen purge. Isolated, poly(TMPTA) features are observed after separation of the PFPE mold and the silicon/silicon oxide wafer, using scanning electron microscopy (SEM).

### 4.4 Fabrication of Isolated “Scum Free” Features for Microelectronics

A patterned perfluoropolyether (PFPE) mold is generated by pouring a PFPE-dimethacrylate (PFPE-DMA) containing 1-hydroxycyclohexyl phenyl ketone over a silicon substrate patterned with 140-nm lines separated by 70 nm. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, TMPTA is blended with 1 wt % of a photoinitiator, 1-hydroxycyclohexyl phenyl ketone. Flat, uniform, non-wetting surfaces capable of adhering to the resist material are generated by treating a silicon wafer cleaned with “piranha” solution (1:1 concentrated sulfuric acid: 30% hydrogen peroxide (aq) solution) and treating the wafer with a mixture of an adhesion promoter, (trimethoxysilyl propyl methacrylate) and a non-wetting silane agent (1H,1H,2H,2H-perfluorooctyl trimethoxysilane). The mixture can range from 100% of the adhesion promoter to 100% of the non-wetting silane. Following this, 50 μL of TMPTA is then placed on the treated silicon wafer and the patterned PFPE mold placed on top of it. The substrate is then placed in a molding apparatus and a small pressure is applied to ensure a conformal contact and to push out excess TMPTA. The entire apparatus is then subjected to UV light (λ=365 nm) for ten minutes while under a nitrogen purge. Features are observed after separation of the PFPE mold and the treated silicon wafer using atomic force microscopy (AFM) and scanning electron microscopy (SEM).

### Example 5

### Molding of Natural and Engineered Templates

5.1. Fabrication of a Perfluoropolyether-Dimethacrylate (PFPE-DMA) Mold from a Template Generated Using Electron-Beam Lithography

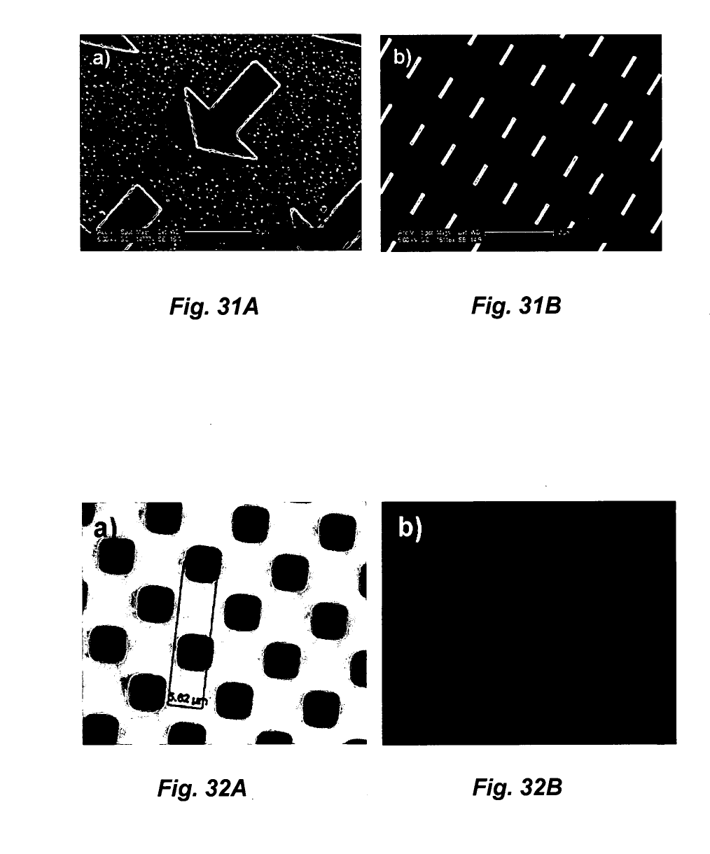

A template, or “master,” for perfluoropolyether-dimethacrylate (PFPE-DMA) mold fabrication is generated using electron beam lithography by spin coating a bilayer resist of 200,000 MW PMMA and 900,000 MW PMMA onto a silicon wafer with 500-nm thermal oxide, and exposing this resist layer to an electron beam that is translating in a pre-programmed pattern. The resist is developed in 3:1 isopropanol:methyl isobutyl ketone solution to remove exposed regions of the resist. A corresponding metal pattern is formed on the silicon oxide surface by evaporating 5 nm Cr and 15 nm Au onto the resist covered surface and lifting off the residual PMMA/Cr/Au film in refluxing acetone. This pattern is transferred to the underlying silicon oxide surface by reactive ion etching with CF₄/O₂ plasma and removal of the Cr/Au film in aqua regia. (FIG. 31). This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. This mold can be used for the fabrication of particles using non-wetting imprint lithography as specified in Particle Fabrication Examples 3.3 and 3.4.

5.2 Fabrication of a Perfluoropolyether-Dimethacrylate (PFPE-DMA) Mold from a Template Generated Using Photolithography

A template, or “master,” for perfluoropolyether-dimethacrylate (PFPE-DMA) mold fabrication is generated using photolithography by spin coating a film of SU-8 photoresist onto a silicon wafer. This resist is baked on a hotplate at 95° C. and exposed through a pre-patterned photomask. The wafer is baked again at 95° C. and developed using a commercial developer solution to remove unexposed SU-8 resist. The resulting patterned surface is fully cured at 175° C. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master, and can be imaged by optical microscopy to reveal the patterned PFPE-DMA mold (see FIG. 32).

5.3 Fabrication of a Perfluoropolyether-Dimethacrylate (PFPE-DMA) Mold from a Template Generated from Dispersed Tobacco Mosaic Virus Particles

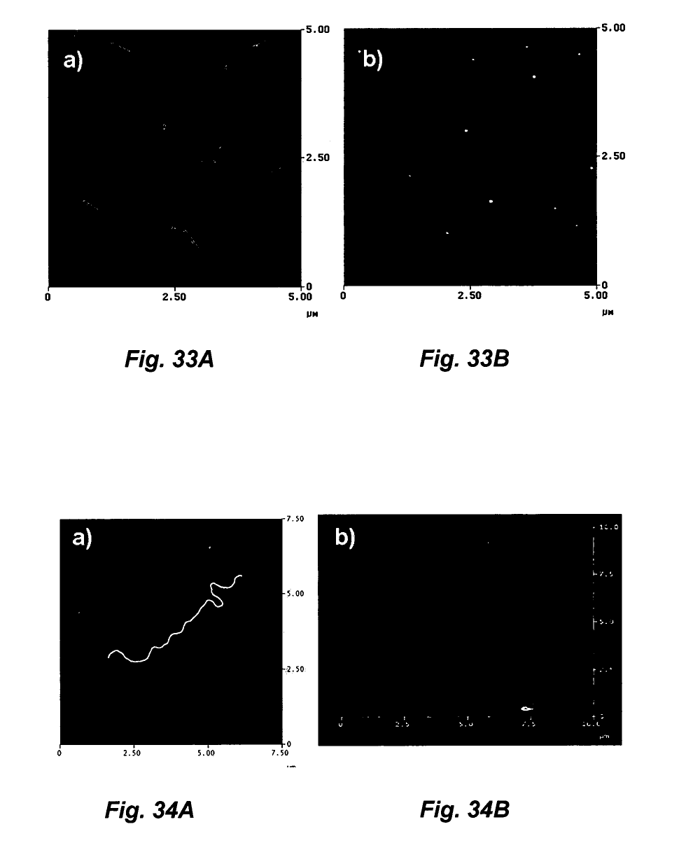

A template, or “master,” for perfluoropolyether-dimethacrylate (PFPE-DMA) mold fabrication is generated by dispersing tobacco mosaic virus (TMV) particles on a silicon wafer (FIG. 33a). This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. The morphology of the mold can then be confirmed using Atomic Force Microscopy (FIG. 33b).

5.4 Fabrication of a Perfluoropolyether-Dimethacrylate (PFPE-DMA) Mold from a Template Generated from Block-Copolymer Micelles

A template, or “master,” for perfluoropolyether-dimethacrylate (PFPE-DMA) mold fabrication is generated by dispersing polystyrene-polyisoprene block copolymer micelles on a freshly-cleaved mica surface. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. The morphology of the mold can then be confirmed using Atomic Force Microscopy (see FIG. 34).

5.5 Fabrication of a Perfluoropolyether-Dimethacrylate (PFPE-DMA) Mold from a Template Generated from Brush Polymers

A template, or “master,” for perfluoropolyether-dimethacrylate (PFPE-DMA) mold fabrication is generated by dispersing poly(butyl acrylate) brush polymers on a freshly-cleaved mica surface. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. The morphology of the mold can then be confirmed using Atomic Force Microscopy (FIG. 35).

5.6 Fabrication of a Perfluoropolyether-Dimethacrylate (PFPE-DMA) Mold from a Template Generated from Earthworm Hemoglobin Protein

A template, or “master,” for perfluoropolyether-dimethacrylate (PFPE-DMA) mold fabrication is generated by dispersing earthworm hemoglobin proteins on a freshly-cleaved mica surface. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. The morphology of the mold can then be confirmed using Atomic Force Microscopy.

5.7 Fabrication of a Perfluoropolyether-Dimethacrylate (PFPE-DMA) Mold from a Template Generated from Patterned DNA Nanostructures.

A template, or “master,” for perfluoropolyether-dimethacrylate (PFPE-DMA) mold fabrication is generated by dispersing DNA nanostructures on a freshly-cleaved mica surface. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. The morphology of the mold can then be confirmed using Atomic Force Microscopy.

5.8 Fabrication of a Perfluoropolyether-Dimethacrylate (PFPE-DMA) Mold from a Template Generated from Carbon Nanotubes

A template, or “master,” for perfluoropolyether-dimethacrylate (PFPE-DMA) mold fabrication is generated by dispersing or growing carbon nanotubes on a silicon oxide wafer. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master. The morphology of the mold can then be confirmed using Atomic Force Microscopy.

### Example 6

### Method of Making Monodisperse Nanostructures Having a Plurality of Shapes and Sizes

In some embodiments, the presently disclosed subject matter describes a novel “top down” soft lithographic technique; non-wetting imprint lithography (NoWIL) which allows completely isolated nanostructures to be generated by taking advantage of the inherent low surface energy and swelling resistance of cured PFPE-based materials.

The presently described subject matter provides a novel “top down” soft lithographic technique; non-wetting imprint lithography (NoWIL) which allows completely isolated nanostructures to be generated by taking advantage of the inherent low surface energy and swelling resistance of cured PFPE-based materials. Without being bound to any one particular theory, a key aspect of NoWIL is that both the elastomeric mold and the surface underneath the drop of monomer or resin are non-wetting to this droplet. If the droplet wets this surface, a thin scum layer will inevitably be present even if high pressures are exerted upon the mold. When both the elastomeric mold and the surface are non-wetting (i.e. a PFPE mold and fluorinated surface) the liquid is confined only to the features of the mold and the scum layer is eliminated as a seal forms between the elastomeric mold and the surface under a slight pressure. Thus, the presently disclosed subject matter provides for the first time a simple, general, soft lithographic method to produce nanoparticles of nearly any material, size, and shape that are limited only by the original master used to generate the mold.

Using NoWIL, nanoparticles composed of 3 different polymers were generated from a variety of engineered silicon masters. Representative patterns include, but are not limited to, 3-μm arrows (see FIG. 11), conical shapes that are 500 nm at the base and converge to <50 nm at the tip (see FIG. 12), and 200-nm trapezoidal structures (see FIG. 13). Definitive proof that all particles were indeed “scum-free” was demonstrated by the ability to mechanically harvest these particles by simply pushing a doctor's blade across the surface. See FIGS. 20 and 22.

Polyethylene glycol (PEG) is a material of interest for drug delivery applications because it is readily available, non-toxic, and biocompatible. The use of PEG nanoparticles generated by inverse microemulsions to be used as gene delivery vectors has previously been reported. K. McAllister et al., Journal of the American Chemical Society 124, 15198-15207 (Dec. 25, 2002). In the presently disclosed subject matter, NoWIL was performed using a commercially available PEG-diacrylate and blending it with 1 wt % of a photoinitiator, 1-hydroxycyclohexyl phenyl ketone. PFPE molds were generated from a variety of patterned silicon substrates using a dimethacrylate functionalized PFPE oligomer (PFPE DMA) as described previously. See J. P. Rolland, E. C. Hagberg, G. M. Denison, K. R. Carter, J. M. DeSimone, Angewandte Chemie-International Edition 43, 5796-5799 (2004). In one embodiment, flat, uniform, non-wetting surfaces were generated by using a silicon wafer treated with a fluoroalkyl trichlorosilane or by casting a film of PFPE-DMA on a flat surface and photocuring. A small drop of PEG diacrylate was then placed on the non-wetting surface and the patterned PFPE mold placed on top of it. The substrate was then placed in a molding apparatus and a small pressure was applied to push out the excess PEG-diacrylate. The entire apparatus was then subjected to UV light (λ=365 nm) for ten minutes while under a nitrogen purge. Particles were observed after separation of the PFPE mold and flat, non-wetting substrate using optical microscopy, scanning electron microscopy (SEM), and atomic force microscopy (AFM).

Poly(lactic acid) (PLA) and derivatives thereof, such as poly(lactide-co-glycolide) (PLGA), have had a considerable impact on the drug delivery and medical device communities because it is biodegradable. See K. E. Uhrich, S. M. Cannizzaro, R. S. Langer, K. M. Shakesheff, Chemical Reviews 99, 3181-3198 (November, 1999); A. C. Albertsson, I. K. Varma, Biomacromolecules 4, 1466-1486 (November-December, 2003). As with PEG-based systems, progress has been made toward the fabrication of PLGA particles through various dispersion techniques that result in size distributions and are strictly limited to spherical shapes. See C. Cui, S. P. Schwendeman, Langmuir 34, 8426 (2001).

The presently disclosed subject matter demonstrates the use of NoWIL to generate discrete PLA particles with total control over shape and size distribution. For example, in one embodiment, one gram of (3S)-cis-3,6-dimethyl-1,4-dioxane-2,5-dione was heated above its melting temperature to 110° C. and ˜20 μL of stannous octoate catalyst/initiator was added to the liquid monomer. A drop of the PLA monomer solution was then placed into a preheated molding apparatus which contained a non-wetting flat substrate and mold. A small pressure was applied as previously described to push out excess PLA monomer. The apparatus was allowed to heat at 110° C. for 15 h until the polymerization was complete. The PFPE-DMA mold and the flat, non-wetting substrate were then separated to reveal the PLA particles.

To further demonstrate the versatility of NoWIL, particles composed of a conducting polymer polypyrrole (PPy) were generated. PPy particles have been formed using dispersion methods, see M. R. Simmons, P. A. Chaloner, S. P. Armes, Langmuir 11, 4222 (1995), as well as “lost-wax” techniques, see P. Jiang, J. F. Bertone, V. L. Colvin, Science 291, 453 (2001).

The presently disclosed subject matter demonstrates for the first time, complete control over shape and size distribution of PPy particles. Pyrrole is known to polymerize instantaneously when in contact with oxidants such as perchloric acid. Dravid et al. has shown that this polymerization can be retarded by the addition of tetrahydrofuran (THF) to the pyrrole. See M. Su, M. Aslam, L. Fu, N. Q. Wu, V. P. Dravid, Applied Physics Letters 84, 4200-4202 (May 24, 2004).

The presently disclosed subject matter takes advantage of this property in the formation of PPy particles by NoWIL. For example, 50 μL of a 1:1 v/v solution of THF:pyrrole was added to 50 μL of 70% perchloric acid. A drop of this clear, brown solution (prior to complete polymerization) into the molding apparatus and applied pressure to remove excess solution. The apparatus was then placed into the vacuum oven overnight to remove the THF and water. PPy particles were fabricated with good fidelity using the same masters as previously described.

Importantly, the materials properties and polymerization mechanisms of PLA, PEG, and PPy are completely different. For example, while PLA is a high-modulus, semicrystalline polymer formed using a metal-catalyzed ring opening polymerization at high temperature, PEG is a malleable, waxy solid that is photocured free radically, and PPy is a conducting polymer polymerized using harsh oxidants. The fact that NoWIL can be used to fabricate particles from these diverse classes of polymeric materials that require very different reaction conditions underscores its generality and importance.

In addition to its ability to precisely control the size and shape of particles, NoWIL offers tremendous opportunities for the facile encapsulation of agents into nanoparticles. As described in Example 3-14, NoWIL can be used to encapsulate a 24-mer DNA strand fluorescently tagged with CY-3 inside the previously described 200 nm trapezoidal PEG particles. This was accomplished by simply adding the DNA to the monomer/water solution and molding them as described. We were able to confirm the encapsulation by observing the particles using confocal fluorescence microscopy (see FIG. 28). The presently described approach offers a distinct advantage over other encapsulation methods in that no surfactants, condensation agents, and the like are required. Furthermore, the fabrication of monodisperse, 200 nm particles containing DNA represents a breakthrough step towards artificial viruses. Accordingly, a host of biologically important agents, such as gene fragments, pharmaceuticals, oligonucleotides, and viruses, can be encapsulated by this method.

The method also is amenable to non-biologically oriented agents, such as metal nanoparticles, crystals, or catalysts. Further, the simplicity of this system allows for straightforward adjustment of particle properties, such as crosslink density, charge, and composition by the addition of other comonomers, and combinatorial generation of particle formulations that can be tailored for specific applications.

Accordingly, NoWIL is a highly versatile method for the production of isolated, discrete nanostructures of nearly any size and shape. The shapes presented herein were engineered non-arbitrary shapes. NoWIL can easily be used to mold and replicate non-engineered shapes found in nature, such as viruses, crystals, proteins, and the like. Furthermore, the technique can generate particles from a wide variety of organic and inorganic materials containing nearly any cargo. The method is simplistically elegant in that it does not involve complex surfactants or reaction conditions to generate nanoparticles. Finally, the process can be amplified to an industrial scale by using existing soft lithography roller technology, see Y. N. Xia, D. Qin, G. M. Whitesides, Advanced Materials 8, 1015-1017 (December, 1996), or silk screen printing methods.

### Example 7

### Fabrication of Boomerang Shaped Particles with a Fluorescein Tag

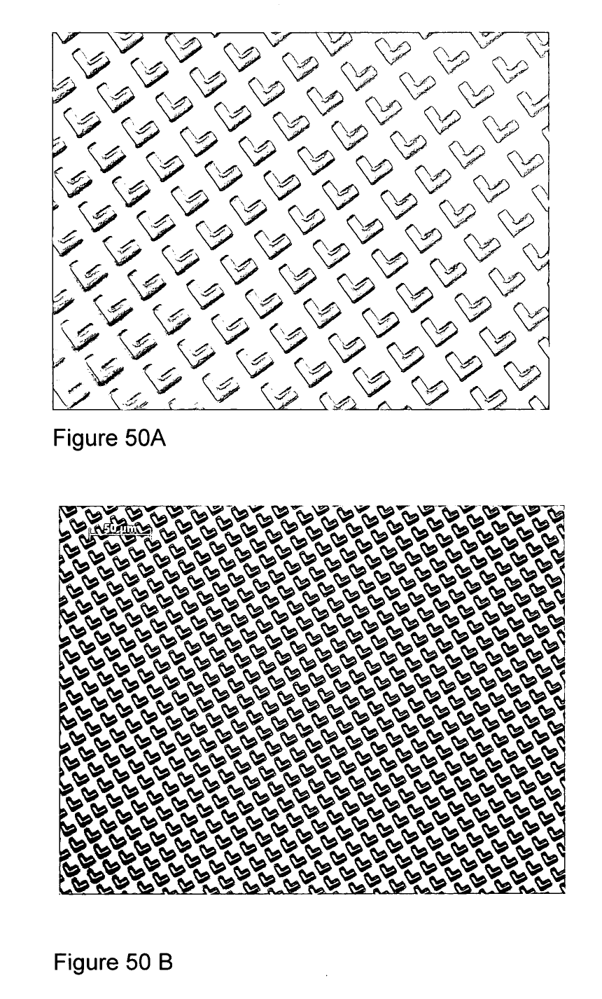

A silicon master having 10 μm wide boomerang-shaped particles is cleaned with isopropyl alcohol and dried with compressed air. Elastomeric PFPE replica molds of the silicon master templates were generated by casting a PFPE-dimethacrylate (PFPE-DMA) containing 2% w/w 1-hydroxycyclohexyl phenyl ketone over the 6 inch silicon substrate, and allowing it to completely wet the wafer, waiting for 3 minutes under nitrogen purge. The PFPE was cured under 365 nm light for 4 minutes with a nitrogen purge. The mold was slowly lifted from the wafer. Separately, PEG triacrylate was mixed with 1% 2,2-diethoxyacetophenone and 1% fluorescein, and sonicated until the mixture was homogenous. The PEG solution was dispersed over the PFPE mold with a pipettor, and a polyethylene sheet was placed over to mold and rolled flat such that a thin film of PEG solution was created. The polyethylene sheet was then slowly peeled back, allowing the PEG solution to dewet the PFPE surface and filling the mold cavities. The mold was placed in an air-tight curing station, purged for 4 minutes, then cured under 365 nm light for 4 minutes. The mold containing cured particles was cut into strips and examined with optical microscopy (see FIG. 50). A filter cube on the microscope was used to confirm the presence of fluorescein.

### Example 8

### Boomerang-Shaped PEG Particles in an Array on a Thin PEG Film and on a Thin Cyanoacrylate Film

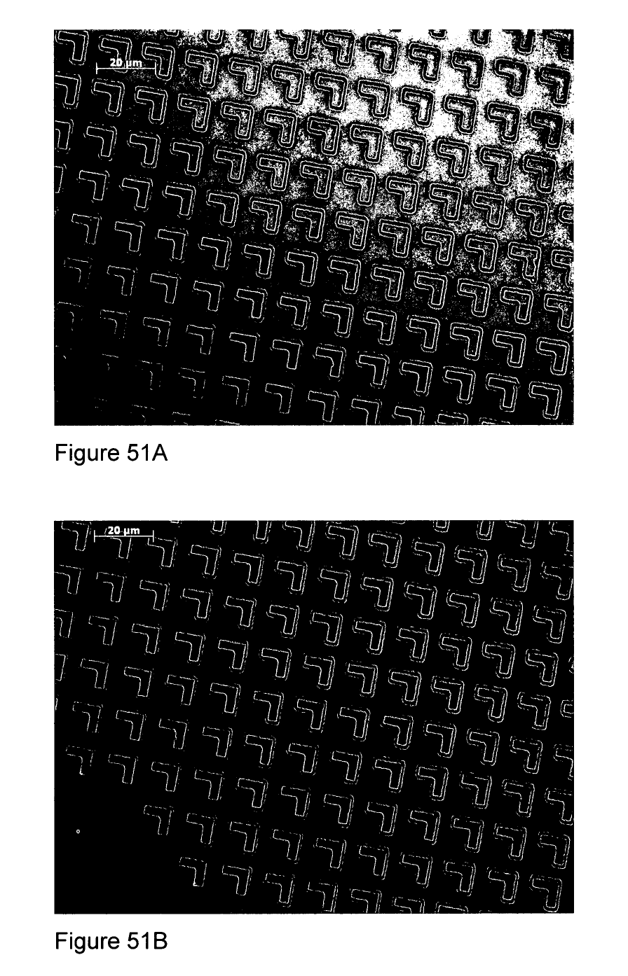

The PFPE mold containing PEG/fluorescein particles was cut into 2″×1″ sections. PEG triacrylate formulated with 1% 2,2-diethoxyacetophenone was cast on a thin film on a glass substrate. The mold containing particles was placed on the film and pressed to achieve a conformal seal. The apparatus was degassed under a nitrogen purge for 5 minutes, and the film was cured under UV light (365 nm) for 5 minutes. The mold was peeled from the film, leaving the boomerang-shaped PEG particles on the thin film, shown with optical microscopy in FIG. 51A.

Separately, a thin film of cyanoacrylate was cast over a glass substrate and placed in a clean hood. A section of PFPE mold containing PEG/fluorescein particles was laminated on the cyanoacrylate film and left to cure in the hood for 15 minutes. The mold was peeled from the surface, leaving PEG particles in an array on the poly(cyanoacrylate) film, shown with optical microscopy in FIG. 51B.

### Example 9

### PEG Resin Containing Boomerang-Shaped PEG Particles and Rectangular Shaped Triacrylate Particles

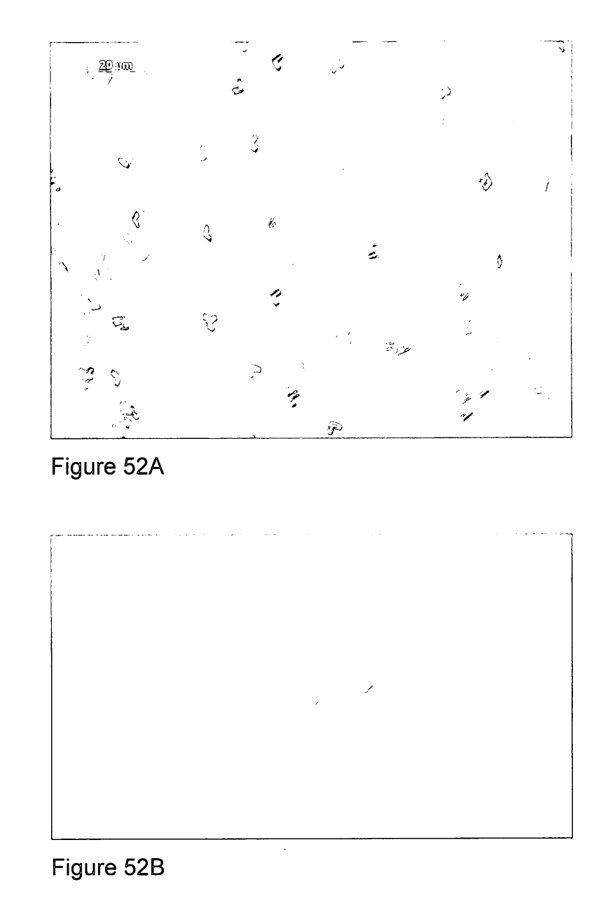

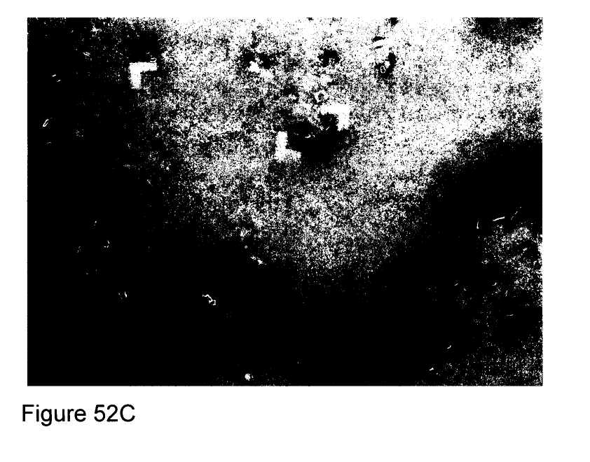

10 μm boomerang shaped PEG particles and 5×10 μm rectangular triacrylate particles were dispersed in a small amount of water with mechanical shaking. Three samples were made by taking aliquots of each solution (one with boomerangs, one with rectangles, and one with both types of particles) and adding to PEG triacrylate mixed with 1% 2,2-diethoxyacetophenone, then mixed at high speed to disperse the particles. Optical microscopy images were taken of the uncured resin. A representative image is shown in FIG. 52A. The PEG films were dispersed on a glass substrate and placed in an air-tight curing chamber. The films were purged for 4 minutes and cured for 4 minutes under 365 nm UV light. The cured films were investigated with optical microscopy. Representative images are shown in FIG. 52B.

### Example 10

### Fabrication of 200 nm Trapezoidal Particles from Various Matrix Materials

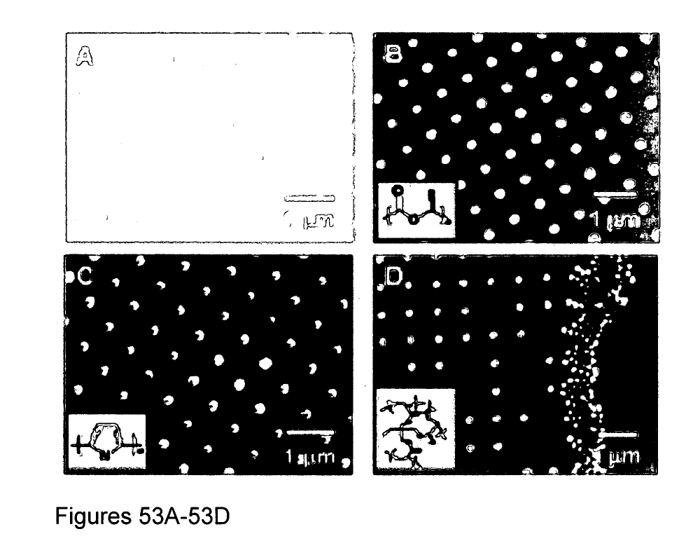

To demonstrate the utility and flexibility of PRINT, shape specific organic particles composed of three different materials were generated from a commercially available silicon template (FIG. 53A) that is composed of a 2 dimensional array of 200 nm trapezoids. Elastomeric PFPE replica molds of the silicon master templates were generated by pouring a PFPE-dimethacrylate (PFPE-DMA) containing 1-hydroxycyclohexyl phenyl ketone over the silicon substrate patterned with 200-nm trapezoidal shapes. A poly(dimethylsiloxane) perimeter mold is used to confine the liquid PFPE-DMA to a desired area. The apparatus was then subjected to UV light (λ=365 nm) for 10 minutes while under a nitrogen purge. The fully cured PFPE-DMA mold was then released from the silicon master. This process was repeated to obtain several molds of the same master.

To fabricate monodisperse PLA particles using the PRINT™ process, one gram of (3S)-cis-3,6-dimethyl-1,4-dioxane-2,5-dione (melting point 92° C.) was heated to 110° C. and approximately 20 μL of stannous octoate catalyst/initiator is added to the liquid monomer. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this, 50 μL of molten Lactic acid containing catalyst is then placed on the treated silicon wafer preheated to 110° C. and the patterned PFPE mold is placed on top of it. A small pressure is applied to the top of the mold with a planar surface to push out excess monomer. The entire apparatus is then placed in an oven at 110° C. for 15 hours. After polymerization was achieved, the PFPE mold and the flat, nonwetting substrate were separated to reveal monodisperse 200 nm trapezoidal particles (FIG. 53B).

To further demonstrate the versatility and breadth of the PRINT technique, we chose to generate specifically shaped particles of 200 nm trapezoids from poly(pyrrole) (PPy). PPy has been used in a variety of applications, ranging from electronic devices and sensors to cell scaffolds. We fabricated PPy particles via one-step polymerization using the following method: flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, 50 μL of a 1:1 v:v solution of tetrahydrofuran:pyrrole is added to 50 μL of 70% perchloric acid (aq). A clear, homogenous, brown solution quickly forms and develops into black, solid, polypyrrole in 15 minutes. A drop of this clear, brown solution (prior to complete polymerization) is placed onto a treated silicon wafer, the PFPE mold is placed on top, and pressure is applied with a planar surface to remove excess solution. The apparatus is then placed into a vacuum oven for 15 h to remove the THF and water. Particles are observed using scanning electron microscopy (SEM) (see FIG. 53C) after release of the vacuum and separation of the PFPE mold and the treated silicon wafer.

Trapezoidal trimethylopropane triacrylate (TMPTA) particles were also generated using a photopolymerization technique. TMPTA is blended with 1 wt % of a photoinitiator, 1-hydroxycyclohexyl phenyl ketone. Uniform, non-wetting surfaces are generated by pouring a PFPE-dimethacrylate (PFPE-DMA) containing 1-hydroxycyclohexyl phenyl ketone over a silicon wafer. The wafer was then subjected to UV light (λ=365 nm) for 10 minutes while under a nitrogen purge. The fully cured PFPE-DMA substrate was then released from the silicon master. Following this, 50 μL of TMPTA is then placed on the PFPE substrate and the patterned PFPE mold placed on top of it. The substrate is then placed on a flat surface and a small pressure is applied to push out excess TMPTA. The entire apparatus is then subjected to UV light (λ=365 nm) for ten minutes while under a nitrogen purge. Particles are observed after separation of the PFPE mold and the treated silicon wafer using scanning electron microscopy (SEM). A flat blade was pushed along the surface to gather the fabricated 200 nm particles (see FIG. 53D).

Particles of the same unique dimensions made using these three different polymerization methods were evaluated using scanning electron microscopy and atomic force microscopy. The NIH Image program was used to measure the particle dimensions on the micrographs and compare them to images of the master template.

### Example 11

### Fabrication of PEG Particles of Different Shapes and Sizes

Poly(ethylene glycol) (PEG) is a material of tremendous interest to the biotechnology community due to its commercial availability, nontoxic nature, and biocompatibility. Here, the PRINT was utilized to produce monodisperse, micro- and nanometer scale PEG particles in a variety of shapes by molding a PEG-diacrylate liquid monomer followed by room temperature photopolymerization. Because the morphology of the particles is controlled by the master, it is possible to generate complex particles on a variety of length scales.

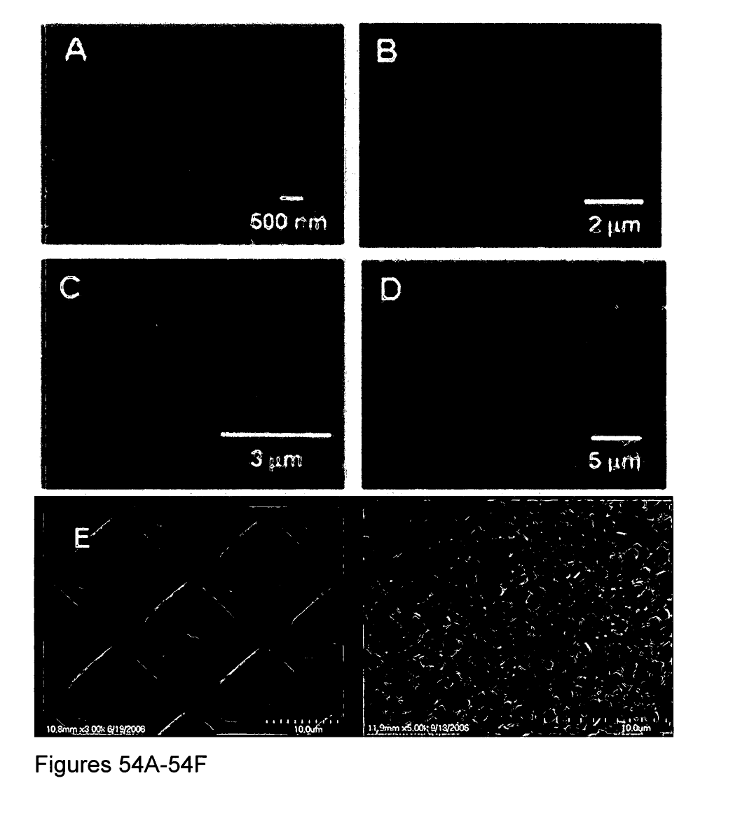

A patterned perfluoropolyether (PFPE) molds are generated by pouring a PFPE-dimethacrylate (PFPE-DMA) containing 1-hydroxycyclohexyl phenyl ketone over a silicon substrate patterned with the desired shape. The silicon masters used include: 200 nm trapezoidal features (FIG. 54A); 200 nm×800 nm bars (FIG. 54B); 500 nm conical features that are <50 nm at the tip (FIG. 54C); 3 μm arrows (FIG. 54D); 10 μm boomerangs (FIG. 54E); and 600 nm cylinders (FIG. 54F). The master coated with uncured PFPE was then subjected to UV light (λ=365 nm) for 10 minutes while under a nitrogen purge. The fully cured PFPE-DMA mold was then easily released from the silicon master by peeling. Separately, a poly(ethylene glycol) (PEG) diacrylate (n=9) is blended with 1 wt % of a photoinitiator, 1-hydroxycyclohexyl phenyl ketone. Uniform, non-wetting surfaces are generated by pouring a PFPE-dimethacrylate (PFPE-DMA) containing 1-hydroxycyclohexyl phenyl ketone over a silicon wafer. The wafer was then subjected to UV light (λ=365 nm) for 10 minutes while under a nitrogen purge. The fully cured PFPE-DMA substrate was then released from the silicon master. Following this, 50 μL of PEG diacrylate is then placed on the PFPE film and the patterned PFPE mold placed on top of it. The substrate is then placed on a flat surface and a small pressure is applied to push out excess PEG-diacrylate. The pressure used was at least about 100 N/cm². The entire apparatus was then subjected to UV light (λ=365 nm) for ten minutes while under a nitrogen purge. Arrays of particles of different shapes and sizes are observed after separation of the PFPE mold and the treated silicon wafer using scanning electron microscopy (SEM). (See FIGS. 54a-54f)

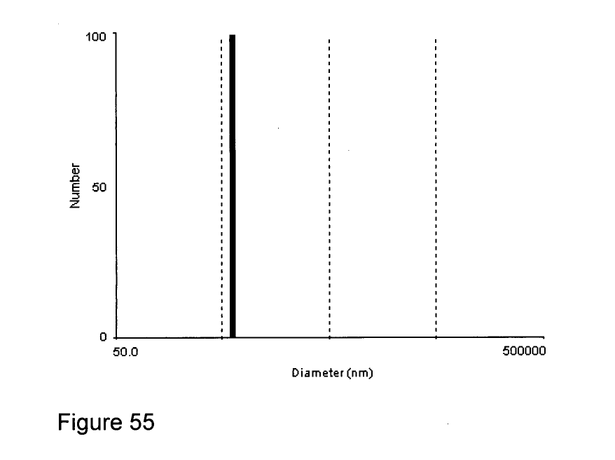

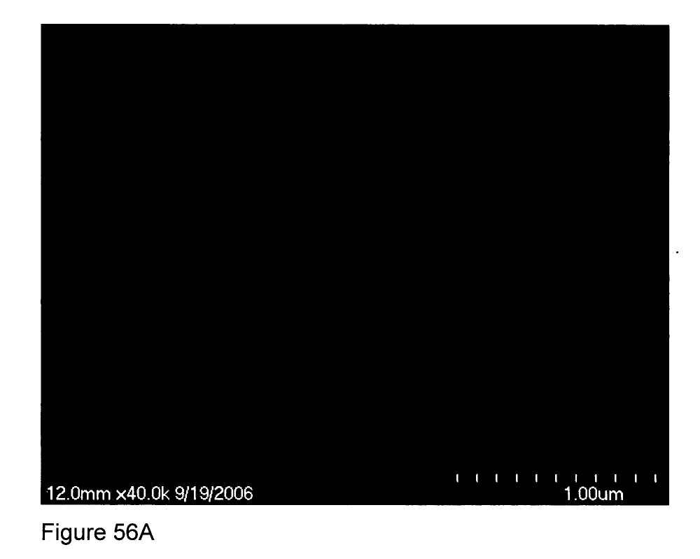

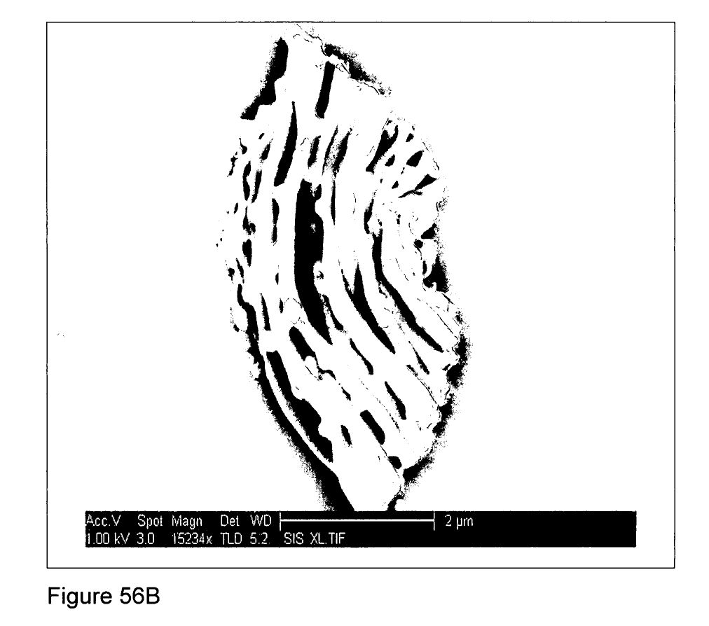

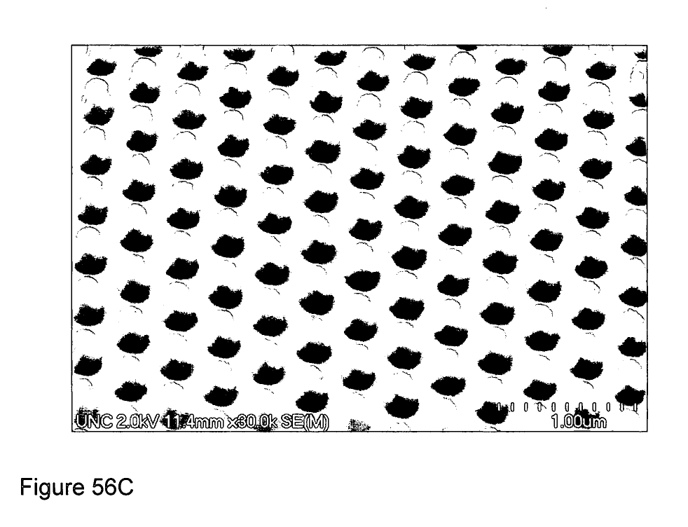

Confirmation of the structural similarity between the silicon master and replicate PEG particles was confirmed via atomic force microscopy (AFM) and scanning electron microscopy (SEM). Atomic Force Microscopy was performed on a Nanoscope IIIa/Multimode AFM in tapping mode. Dynamic light scattering (DLS) is performed on particles suspended in phosphate buffered saline solution (PBS) to look for aggregation. This technique is designed for spherical particles; however, we can use the values empirically to look for large aggregates (some non-uniformity in size will be seen at a scale smaller than that of the particle diameter due to the non-spherical shapes of the particles). An example DLS trace is given in FIG. 55, with the value measured for the particle size as 0.62±0.2 μm. The line indicates monodispersity of the particles, with no aggregation occurring.

### Example 12

### Utilizing PRINT Technology to Create Free-Flowing Particles, Particles on a Scum Layer, and Particles on a Film

The PRINT technology can be used to generate a variety of products having varying forms, including free flowing particles and particles in an array on a film. The following example shows our ability to make poly(ethylene glycol) (PEG) based particles free flowing, as an array on a PEG film, and as an array on a different polymer film.

Free-flowing Particles: A patterned perfluoropolyether (PFPE) mold was generated by pouring a PFPE-dimethacrylate (PFPE-DMA) containing 1-hydroxycyclohexyl phenyl ketone over a silicon substrate patterned with 200 nm tall×200 nm diameter cylinders. The PFPE-DMA covered master was then subjected to UV light (λ=365 nm) for 3 minutes while under a nitrogen purge. The fully cured PFPE-DMA mold was then released from the silicon master. Separately, a mixture of 790 mg trimethylolpropane ethoxylate triacrylate, 200 mg polyethylene glycol carbonylimidizole monomethacrylate, and 10 mg α-α-diethoxyacetophenone was prepared. This mixture was spotted directly onto the patterned PFPE-DMA mold and covered with an unpatterned polyethylene (PE) film. The monomer mixture was pressed between the two polymer sheets, and then the PE sheet was slowly peeled from the patterned PFPE-DMA to remove any excess monomer solution from the surface of the PFPE-DMA mold. The mold was then subjected to UV light (λ=365 nm) for 2 minutes while maintaining a nitrogen purge. The particles were harvested by placing 2 mL of DMSO on the mold and scrapping the surface with a glass slide. The particle suspension was transferred to a scintillation vial. One drop of the suspension was placed on a SEM stub and the solvent was allowed to evaporate.

Particles on a PEG film: A patterned perfluoropolyether (PFPE) mold is generated by pouring a PFPE-dimethacrylate (PFPE-DMA) containing 1-hydroxycyclohexyl phenyl ketone over a 6 inch silicon substrate patterned with 200-nm cylindrical shapes. The substrate is then subjected to UV light (λ=365 nm) for 10 minutes while under a nitrogen purge. The fully cured PFPE-DMA mold is then released from the silicon master. Separately, a solution of 30:70 PEG monomethacrylate:PEG diacrylate is formulated with 1 wt % photoinitiator. Following this, 200 μL of this PEG solution is then placed on an untreated silicon wafer and the patterned PFPE mold placed on top of it. The substrate is then placed on a flat substrate and a small pressure is applied to push out excess PEG solution. The entire apparatus is then subjected to UV light (λ=365 nm) for ten minutes while under a nitrogen purge. PEG particles connected by a PEG film will be observed after separation of the PFPE mold and the silicon wafer using scanning electron microscopy.

Particles on a cyanoacrylate film: A patterned perfluoropolyether (PFPE) mold is generated by pouring a PFPE-dimethacrylate (PFPE-DMA) containing 2,2-diethoxyacetophenone over a silicon substrate patterned with 200 nm cylindrical shapes. The apparatus is then subjected to a nitrogen purge for 10 minutes before the application of UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 28 wt % PEG methacrylate (n=9), 2 wt % azobisisobutyronitrile (AIBN), and 0.25 wt % rhodamine methacrylate. Flat, uniform, non-wetting surfaces are generated by coating a glass slide with PFPE-dimethacrylate (PFPE-DMA) containing 2,2-diethoxyacetophenone. The slide is then subjected to a nitrogen purge for 10 minutes, then UV light is applied (λ=365 nm) while under a nitrogen purge. The flat, fully cured PFPE-DMA substrate is released from the slide. Following this, 0.1 mL of the monomer blend is evenly spotted onto the flat PFPE-DMA surface and then the patterned PFPE-DMA mold placed on top of it. The surface and mold are then placed in a molding apparatus and a small amount of pressure is applied to remove any excess monomer solution. The entire apparatus is purged with nitrogen for 10 minutes, then subjected to UV light (λ=365 nm) for 10 minutes while under a nitrogen purge. Neutral PEG nanoparticles are observed after separation of the PFPE-DMA mold and substrate using scanning electron microscopy (SEM). A thin layer of cyanoacrylate monomer is sprayed onto the PFPE-DMA mold filled with particles. The PFPE-DMA mold is immediately placed onto a glass slide and the cyanoacrylate is allowed to polymerize in an anionic fashion for one minute.

### Example 13

### Identification of PRINT Particles Using Nano-Scale “Defects”

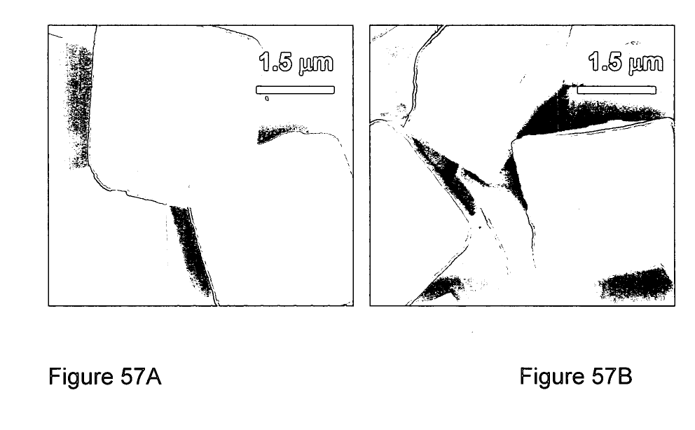

The PRINT process inherently introduces structural features from the silicon masters that are transferred to the mold and subsequently to the particles during PRINT fabrication. Here, a Bosch-type etch is used to process a master which introduces a recognizable pattern (“Bosch etch lines”) on the sidewalls of individual particles. Bosch etching is one of many techniques used to fabricate wafers, most of which leave residual “defects” on the sidewalls of the features or surface. FIGS. 57A and 57B shows distinct particles derived from the masters that show a similar sidewall pattern resulting from the specific Bosch-type etch process used on the master. In this case, this pattern can be recognized using SEM imaging and identifies these particles as originating from the same master.

A patterned perfluoropolyether (PFPE) mold is generated by pouring a PFPE-dimethacrylate (PFPE-DMA) containing 1-hydroxycyclohexyl phenyl ketone over a silicon substrate patterned with 3-μm cubical shapes at a 1 μm depth. The substrate is then subjected to a nitrogen purge for 10 minutes, then UV light (λ=365 nm) is applied for 10 minutes while under a nitrogen purge. The fully cured PFPE-DMA mold is then released from the silicon master. A PFPE-DMA mold is made from a master patterned with 2 μm deep cubical shapes Separately, TMPTA is blended with 1 wt % of a photoinitiator, 1-hydroxycyclohexyl phenyl ketone. Flat, uniform, non-wetting surfaces are generated by coating a glass slide with PFPE-DMA containing 1-hydroxycyclohexyl phenyl ketone. The slide is then subjected to a nitrogen purge for 10 minutes, then UV light (λ=365 nm) is applied for 10 minutes while under a nitrogen purge. The flat, fully cured PFPE-DMA substrate is released from the slide. Following this, 0.1 mL of TMPTA is then placed on the flat PFPE-DMA substrate and the patterned PFPE mold placed on top of it. The substrate is then placed in a molding apparatus and a small pressure is applied to push out excess TMPTA. The entire apparatus is then purged with nitrogen for 10 minutes, then subjected to UV light (λ=365 nm) for 10 minutes while under a nitrogen purge. TMPTA particles are observed after separation of the PFPE-DMA mold and substrate using optical microscopy. A drop of n-vinyl-2-pyrrolidone containing 5% photoinitiator, 1-hydroxycyclohexyl phenyl ketone, is placed on a clean glass slide. The PFPE-DMA mold containing particles is placed patterned side down on the n-vinyl-2-pyrrolidone drop. The slide is subjected to a nitrogen purge for 5 minutes, then UV light (λ=365 nm) is applied for 5 minutes while under a nitrogen purge. The slide is removed, and the mold is peeled away from the polyvinyl pyrrolidone and particles. Particles on the polyvinyl pyrrolidone were observed with optical microscopy. The polyvinyl pyrrolidone film containing particles was dissolved in water. Dialysis was used to remove the polyvinyl pyrrolidone, leaving an aqueous solution containing TMPTA particles. Samples dispersions from the 1 μm and 2 μm deep master are dropped on an SEM stub and the water allowed to evaporate in a vacuum oven.

1. A taggant, comprising:
a taggant particle having a predetermined shape, wherein the taggant particle is less than about 50 microns in a broadest dimension and wherein the taggant particle includes a unique characteristic.

2. The taggant of claim 1, further comprising a plurality of taggant particles, wherein each taggant particle of the plurality of the taggant particles is substantially uniform in geometric shape.

3. The taggant of claim 1, further comprising a plurality of taggant particles, wherein taggant particles of the plurality of taggant particles have a plurality of predetermined shapes.

4-19. (canceled)

20. The taggant of claim 1, wherein the unique characteristic includes features on a surface of the taggant particle.

21. The taggant of claim 20, wherein the features include grooves patterned such that the grooves include information.

22. The taggant of claim 1, wherein the taggant particle comprises a degradable material.

23. The taggant of claim 1, wherein the unique characteristic comprises a predetermined three dimensional geometric shape.

24. (canceled)

25. The taggant of claim 23, wherein the geometric shape protrudes from the taggant particle.

26. The taggant of claim 23, further comprising a plurality of geometric shapes configured on each taggant particle.

27-28. (canceled)

29. The taggant of claim 26, wherein the plurality of geometric shapes are arranged to form a pattern.

30. The taggant of claim 1, wherein the unique characteristic includes a radio frequency identification.

31. The taggant of claim 30, wherein the radio frequency identification is passive.

32. The taggant of claim 30, wherein the radio frequency identification is active.

33. (canceled)

34. The taggant of claim 1, wherein the taggant particle defines a recess and the recess is configured and dimensioned to receive the unique characteristic.

35-36. (canceled)

37. The taggant of claim 1, wherein the unique characteristic includes a composition configured to give the taggant particle a chemical, physical, or optical signature.

38. (canceled)

39. The taggant of claim 1, wherein the taggant particle is not visible to the human eye.

40-63. (canceled)

64. A method of making a taggant, comprising:
placing material into a cavity formed in a fluoropolymer material, wherein the cavity is less than about 50 microns in a broadest dimension;
treating the material in the cavity to form a taggant, wherein a characteristic of the cavity imparts a unique characteristic to the taggant; and
removing the taggant from the cavity.

65. The method of claim 64, wherein the fluoropolymer material comprises perfluoropolyether.

66. (canceled)

67. The method of claim 64, wherein the unique characteristic includes a geometric shape of the taggant, a chemical signature, a spectral signature, an active radio frequency identification, a passive radio frequency identification, or surface features.

68-74. (canceled)

75. A taggant, comprising: a plurality of taggant particles having a broadest dimension of less than about 5 micrometers, wherein each taggant particle of the plurality of taggant particles has a substantially similar geometric shape and wherein each of the taggant particles includes a unique characteristic selected from the group consisting of the geometric shape, a chemical signature, a spectral signature, an active radio frequency identification, a passive radio frequency identification, or surface features.
